(19) United States
(12) Patent Application Publication
(10) Pub. No.: US 2013/0115519 A1
(43) Pub. Date: May 9, 2013

(54) SEPARATOR FOR LITHIUM SECONDARY BATTERY AND METHOD FOR MANUFACTURING SAME

(71) Applicants: Young Moo Lee, Seoul (KR); So Young Lee, Seoul (KR); Na Rae Kang, Gyeonggi-do (KR); Jung Hoon Kim, Gyeonggi-do (KR); Nurasyikin Misdan, Seoul (KR); Yang-Kook Sun, Seoul (KR); Hun-Gi Jung, Busan (KR)

(72) Inventors: Young Moo Lee, Seoul (KR); So Young Lee, Seoul (KR); Na Rae Kang, Gyeonggi-do (KR); Jung Hoon Kim, Gyeonggi-do (KR); Nurasyikin Misdan, Seoul (KR); Yang-Kook Sun, Seoul (KR); Hun-Gi Jung, Busan (KR)

(73) Assignee: ICUF-HYU (Industry-University Cooperation Foundati Hanyang Unversity, Seoul (KR)

(21) Appl. No.: 13/704,296

(22) PCT Filed: Jun. 14, 2011
(86) PCT No.: PCT/KR2011/004347

§ 371 Date: Jan. 25, 2013

(30) Foreign Application Priority Data
Jun. 14, 2010 (KR) 1020100056074

(51) Int. Cl. H01M 2/16

(52) U.S. Cl. CPC H01M 2/162; H01M 2/1613
USPC 429/252; 429/249; 429/251; 264/414; 524/104

(57) ABSTRACT

Provided is a separator for a rechargeable lithium battery including a porous support including a polymer derived from polyamic acid or a polymer derived from polyimide, wherein the polyamic acid and the polyimide include a repeating unit prepared from aromatic diamine including at least one ortho-positioned functional group relative to an amine group and dianhydride.

### TECHNICAL FIELD

This disclosure relates to a separator for a rechargeable lithium battery and a method of manufacturing the same.

### BACKGROUND ART

In general, a rechargeable lithium battery includes a positive electrode including a positive active material, a negative electrode including a negative active material, a separator separating the positive and negative electrodes, and a non-aqueous electrolyte.

The rechargeable lithium battery is widely used as a power source for an electronic device such as a mobile phone, a digital still camera, a digital video camera, a laptop, and the like. In addition, the rechargeable lithium battery has recently been researched as a power source for next generation electric and hybrid vehicles.

A commercially available separator including polyethylene, polypropylene, and the like has excellent mechanical strength and a low cost. However, the separator has a low melting point and may be deteriorated and contract during overheating of a rechargeable lithium battery, and thus may cause a short circuit of the rechargeable lithium battery and explode it. In addition, the separator has low wettability for a non-aqueous electrolyte.

Accordingly, development of a separator for a rechargeable lithium battery having excellent thermal stability and wettability for a non-aqueous electrolyte is required.

### DISCLOSURE

### Technical Problem

A separator for a rechargeable lithium battery having excellent thermal stability and wettability for a non-aqueous electrolyte and a method of manufacturing the same are provided.

A rechargeable lithium battery including the separator for a rechargeable lithium battery is provided.

### Technical Solution

According to one embodiment, a separator for a rechargeable lithium battery including a porous support including a polymer derived from polyamic acid or a polymer derived from polyimide is provided. The polyamic acid and polyimide may include a repeating unit prepared from an aromatic diamine including at least one ortho-positioned functional group relative to an amine group, and dianhydride.

The functional group may include OH, SH, or NH₂.

The polymer may be derived from thermal rearrangement of the polyamic acid or the polyimide, and may have a ratio of thermally rearranged repeating units (thermal rearrangement rate) of about 10 mol % to about 100 mol %, based on the total amount of a repeating unit in the polyamic acid or polyimide.

The polymer derived from polyamic acid and polymer derived from polyimide may have a fractional free volume (FFV) of about 0.18 to about 0.40.

The polymer derived from polyamic acid and polymer derived from polyimide may have an interplanar distance of about 550 pm to about 800 pm measured by X-ray diffraction (XRD).

The polyamic acid may be selected from the group consisting of polyamic acid including a repeating unit represented by the following Chemical Formulae 1 to 4, a polyamic acid copolymer including a repeating unit the following Chemical Formulae 5 to 8, a copolymer thereof, and a blend thereof.

The polyimide may be selected from the group consisting of polyimide including a repeating unit represented by the following Chemical Formulae 19 to 22, a polyimide copolymer including a repeating unit the following Chemical Formulae 23 to 26, a copolymer thereof, and a blend thereof.

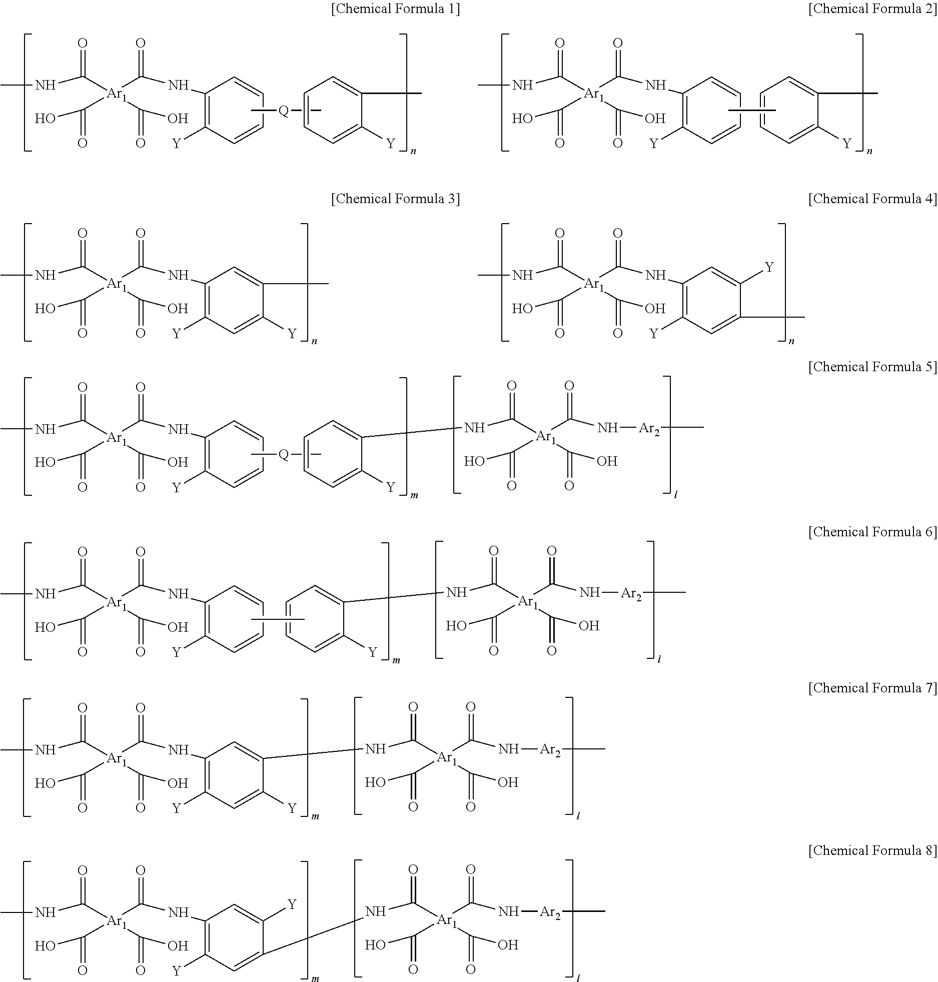

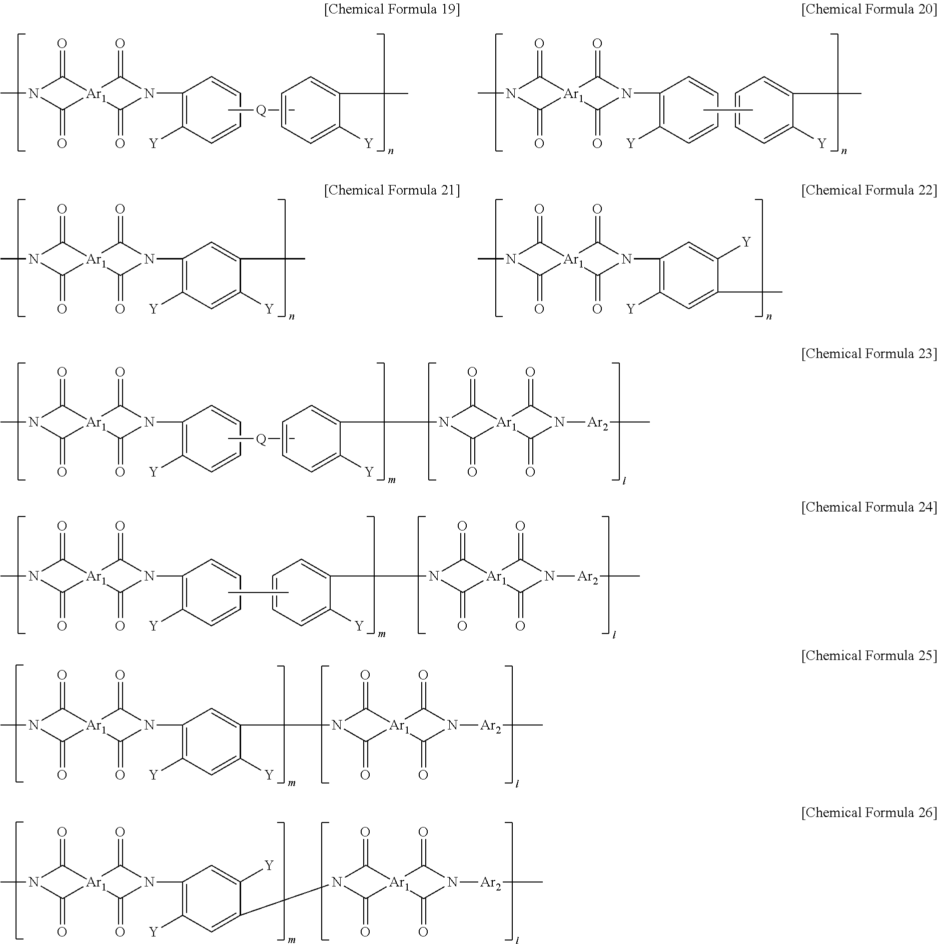

In the above Chemical Formulae 1 to 8 and Chemical Formulae 19 to 26,

Ar₁ is an aromatic ring group selected from a substituted or unsubstituted tetravalent C6 to C24 arylene group and a substituted or unsubstituted tetravalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different in each repeating unit and is independently OH, SH, or NH₂,

n is an integer satisfying 20≦n≦1200,

m is an integer satisfying 10≦m≦1400, and

l is an integer satisfying 10≦l≦400.

A mole ratio between each repeating unit in a copolymer of polyamic acid including the repeating unit represented by the above Chemical Formulae 1 to 4, a mole ratio m:l of in the above Chemical Formulae 5 to 8, a mole ratio between each repeating unit in a copolymer of polyimide including the repeating unit represented by the above Chemical Formulae 19 to 22, or a mole ratio m:l of in the above Chemical Formula 23 to 26 may ranges from about 0.1:9.9 to about 9.9:0.1.

The polymer derived from polyamic acid and polymer derived from polyimide may be a polymer including a repeating unit represented by one of the following Chemical Formulae 37 to 50, or a copolymer thereof.

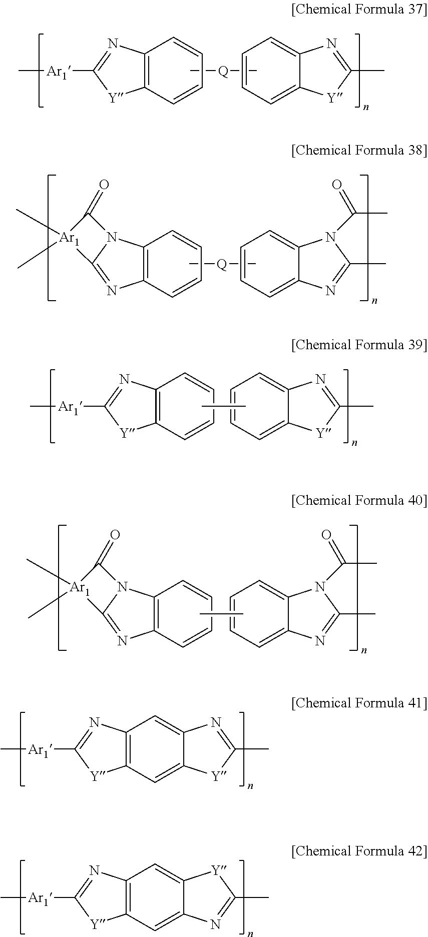

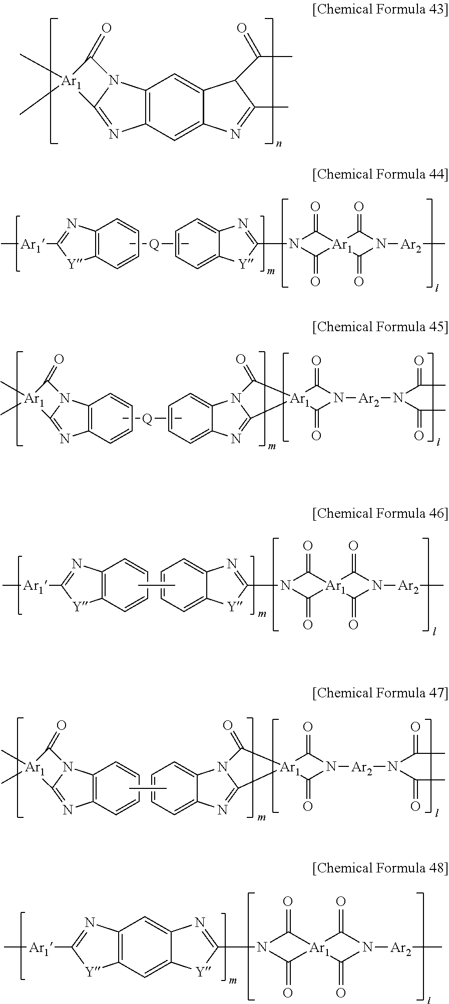

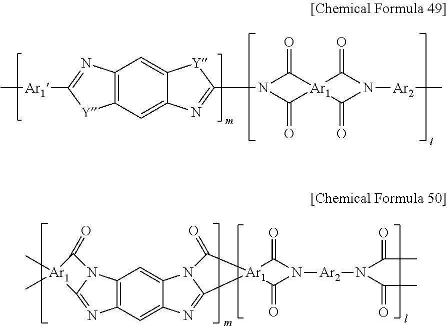

In the above Chemical Formulae 37 to 50,

Ar₁, Ar₂, Q, n, m, and l are the same as defined in the above Chemical Formulae 1 to 8 and Chemical Formulae 19 to 26,

Ar₁′ is an aromatic group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH, and

Y″ is O or S.

In the above Chemical Formulae 1 to 8, Chemical Formulae 19 to 26, and Chemical Formulae 37 to 50, examples of Ar₁ may be selected from the following chemical formulae.

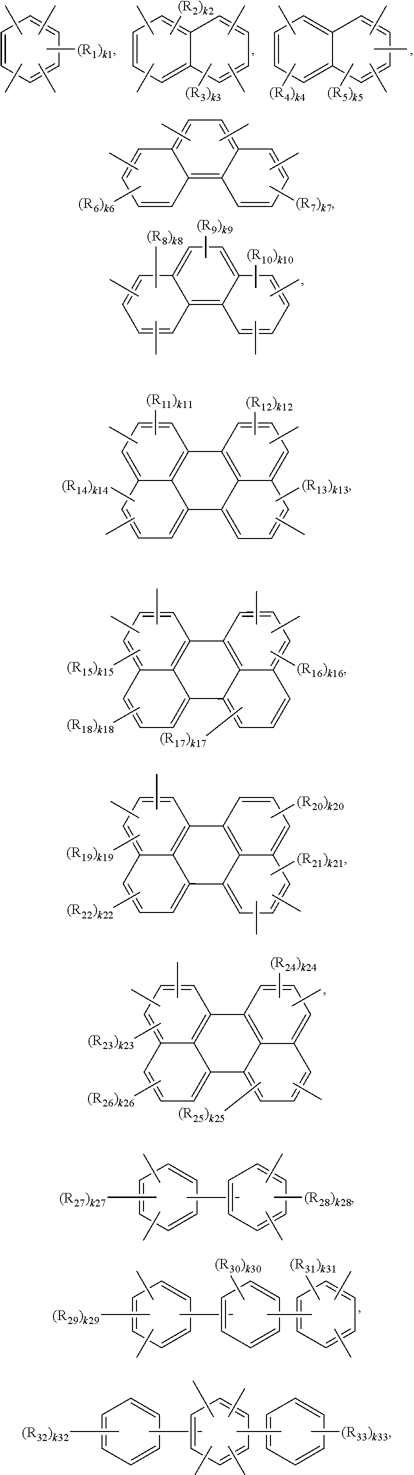

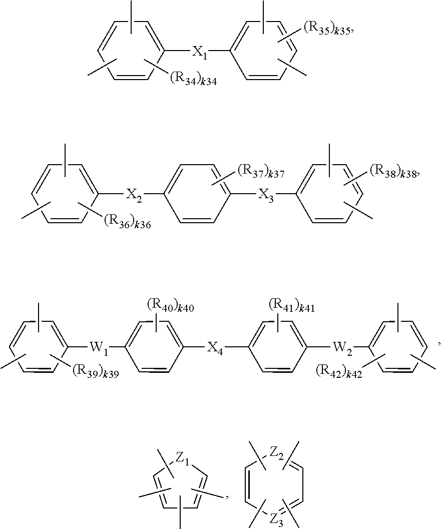

In the above chemical formulae,

X₁, X₂, X₃, and X₄ are the same or different and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C(═O),

Z₁ is O, S, CR₁₀₀R₁₀₁, or NR₁₀₂, where R₁₀₀, R₁₀₁, and R₁₀₂ are the same or different from each other and are independently hydrogen or a C1 to C5 alkyl group,

Z₂ and Z₃ are the same or different and are independently N or CR₁₀₃ (where R₁₀₃ is hydrogen or a C1 to C5 alkyl group) provided that both Z₂ and Z₃ are not CR₁₀₃,

R₁ to R₄₂ are the same or different and are independently hydrogen, or a substituted or unsubstituted C1 to C10 aliphatic organic group,

k1 to k3, k8 to k14, k24, and k25 are integers ranging from 0 to 2,

k5, k15, k16, k19, k21, and k23 are integers of 0 or 1,

k4, k6, k7, k17, k18, k20, k22, k26 to k29, k31, k34 to k36, k38, k39, and k42 are integers ranging from 0 to 3,

k30, k37, k40, and k41 are integers ranging from 0 to 4, and

k32 and k33 are integers ranging from 0 to 5.

In the above Chemical Formulae 1 to 8, Chemical Formulae 19 to 26, and Chemical Formulae 37 to 50, specific examples of Ar₁ may be selected from one of the following chemical formulae.

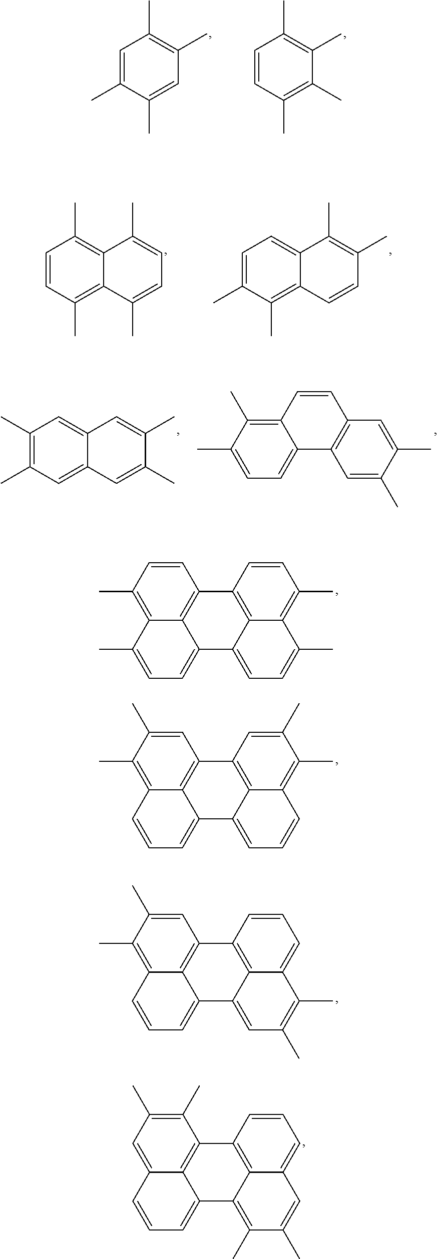

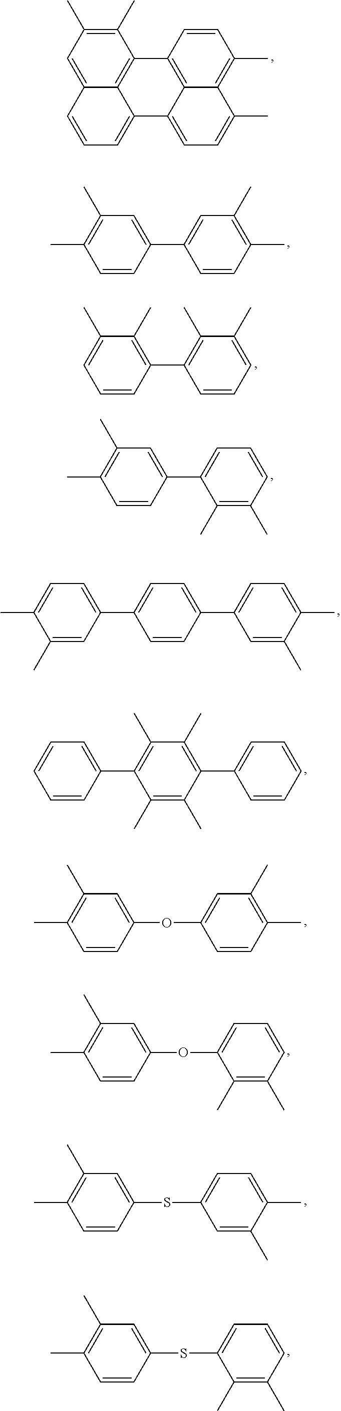

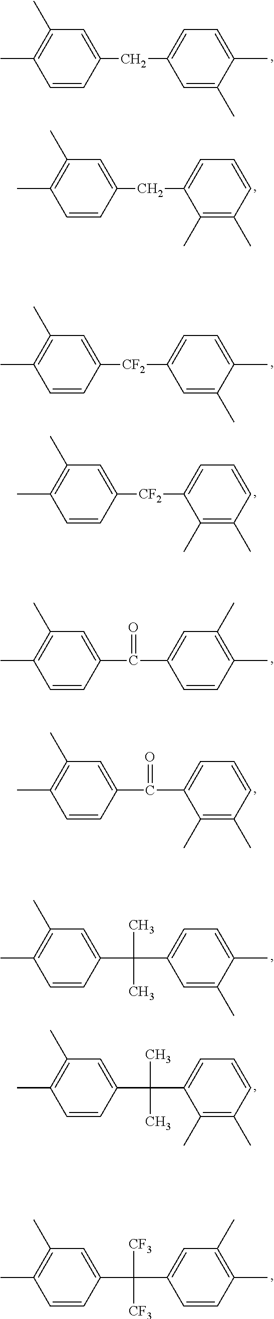

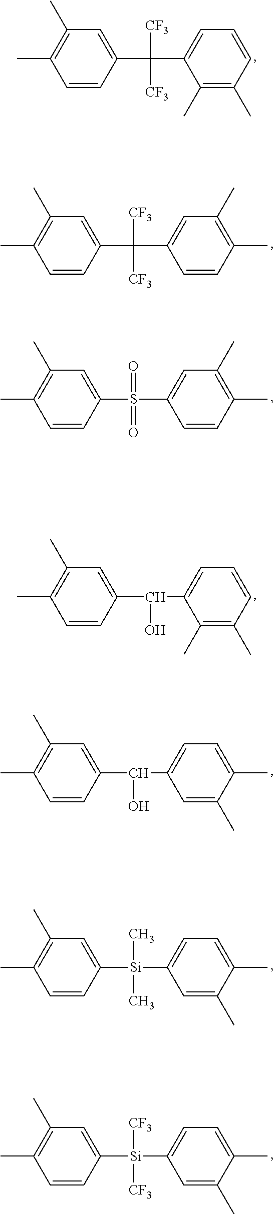

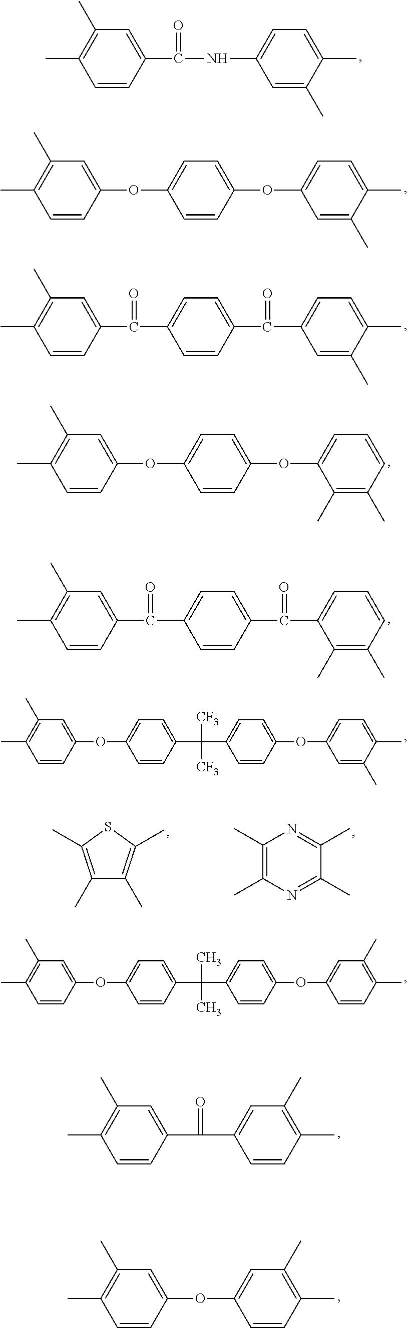

In the above Chemical Formulae 1 to 8, Chemical Formulae 19 to 26, and Chemical Formulae 37 to 50, examples of Ar₂ may be selected from one of the following chemical formulae.

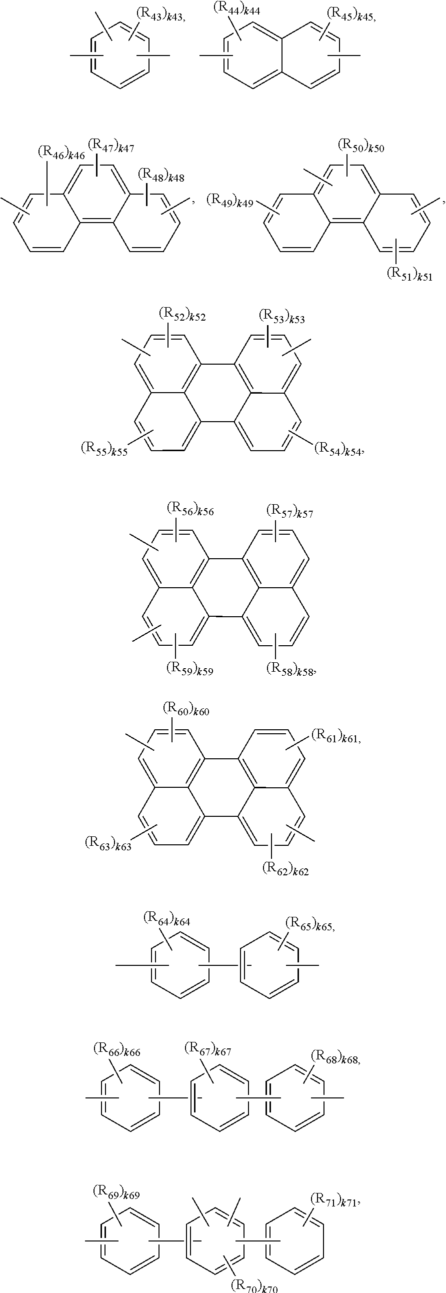

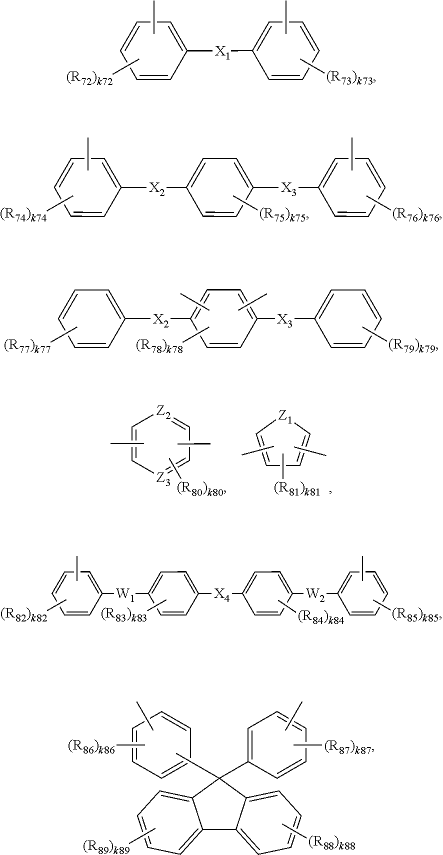

In the above chemical formulae,

X₁, X₂, X₃, and X₄ are the same or different, and independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C(═O),

Z₁ is O, S, CR₁₀₀R₁₀₁, or NR₁₀₂, where R₁₀₀, R₁₀₁, and R₁₀₂ are the same or different from each other and are independently hydrogen or a C1 to C5 alkyl group,

Z₂ and Z₃ are the same or different from each other and are independently N or CR₁₀₃ (where R₁₀₃ is hydrogen or a C1 to C5 alkyl group), provided that both Z₂ and Z₃ are not CR₁₀₃,

R₄₃ to R₈₉ are the same or different and are independently hydrogen, a substituted or unsubstituted C1 to C10 aliphatic organic group, or a metal sulfonate group,

k43, k49, k64 to k68, k72 to k76, and k82 to k89 are integers ranging from 0 to 4,

k44 to k46, k48, k51, k54, k55, k57, k58, k61, and k63 are integers ranging from 0 to 3,

k47, k52, k53, k56, k59, k60, k62, k70, k78, k80, and k81 are integers ranging from 0 to 2,

k50 is an integer of 0 or 1, and

k69, k71, k77, and k79 are integers ranging from 0 to 5.

In the above Chemical Formulae 1 to 8, Chemical Formulae 19 to 26, and Chemical Formulae 37 to 50, specific examples of Ar₂ may be selected from one of the following chemical formulae.

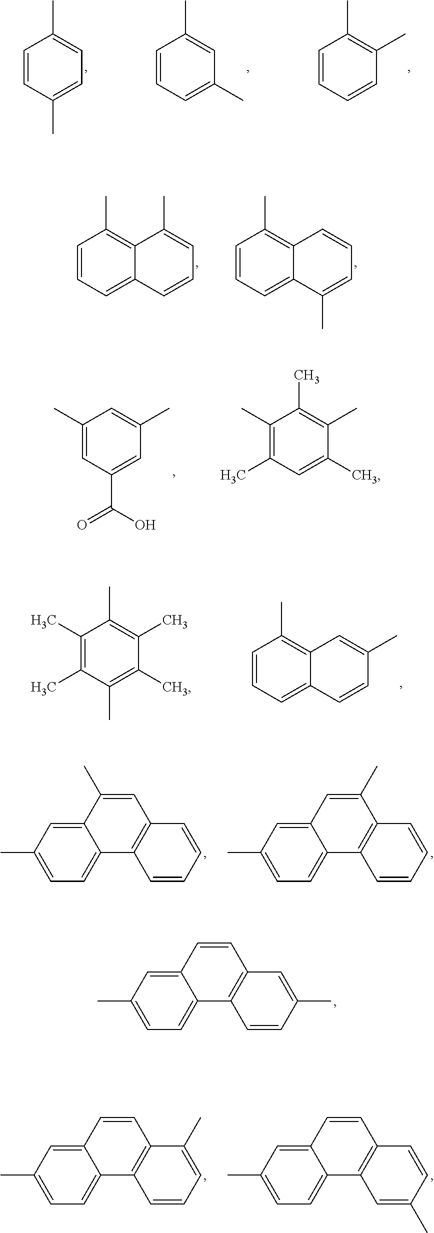

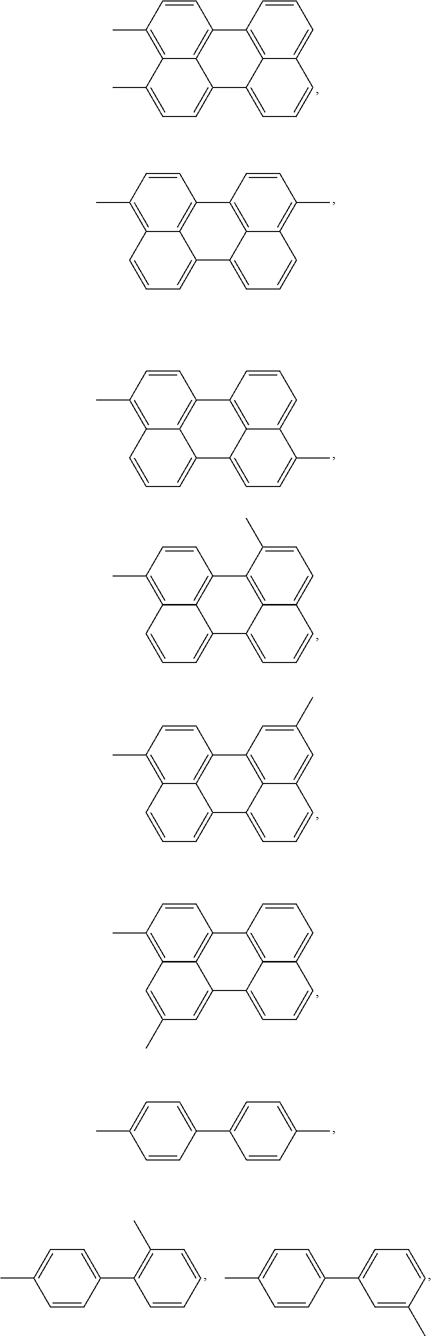

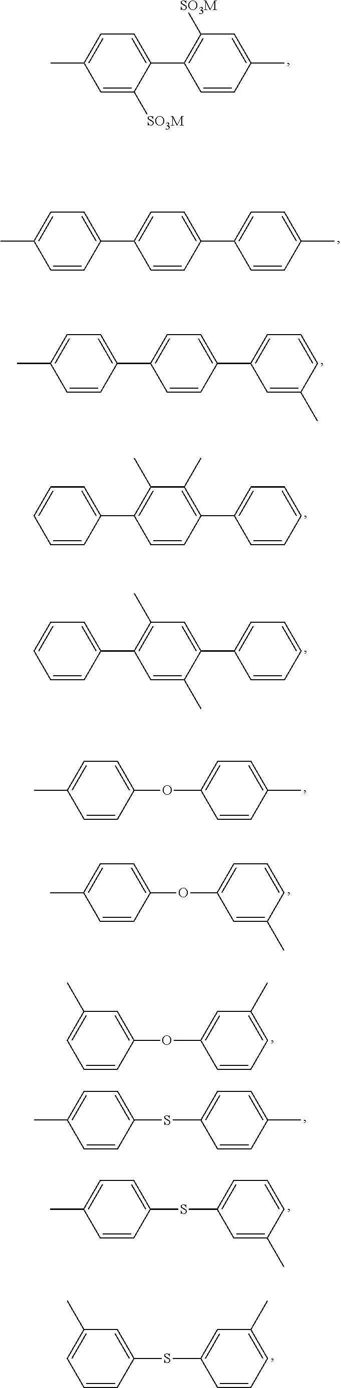

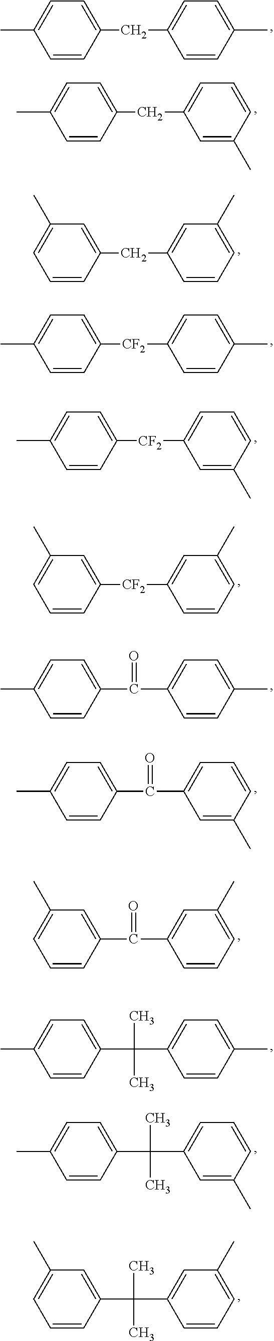

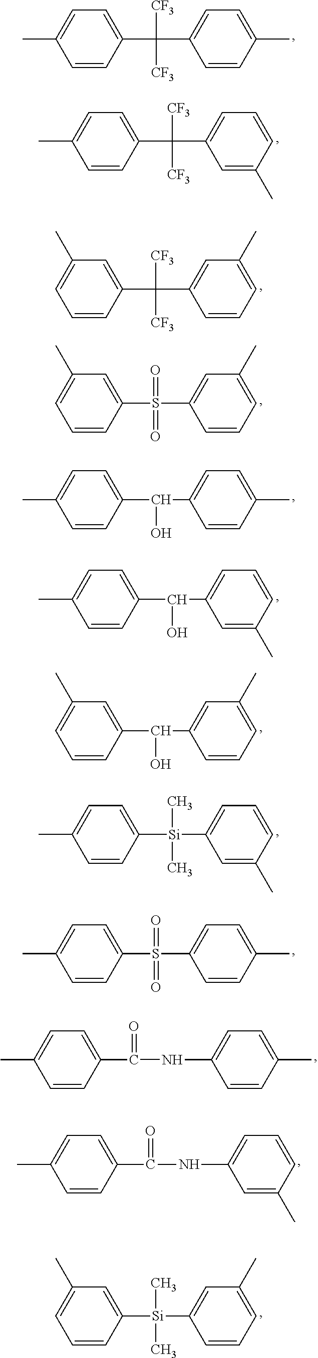

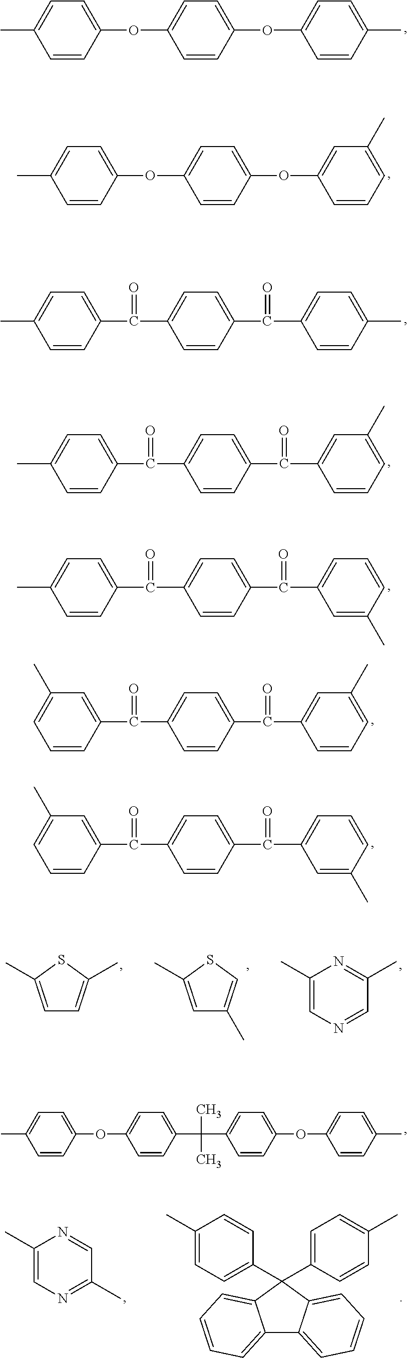

In the above chemical formulae, M is a metal, wherein the metal is sodium, potassium, lithium, an alloy thereof, or a combination thereof.

In the above Chemical Formulae 1 to 8, Chemical Formulae 19 to 26, and Chemical Formulae 37 to 50, examples of Q may be selected from C(CH₃)₂, C(CF₃)₂, O, S, S(═O)₂, or C(═O).

In the above Chemical Formula 37 to 50, examples and specific examples of Ar₁′ are the same as examples and specific examples of Ar₂ in Chemical Formulae 1 to 8 and Chemical Formulae 19 to 26.

In the above Chemical Formulae 1 to 8 and Chemical Formulae 19 to 26, Ar₁ may be a functional group represented by the following Chemical Formulae A1 to A8, Ar₂ may be a functional group represented by the following Chemical Formulae B1 to B11, and Q may be C(CF₃)₂.

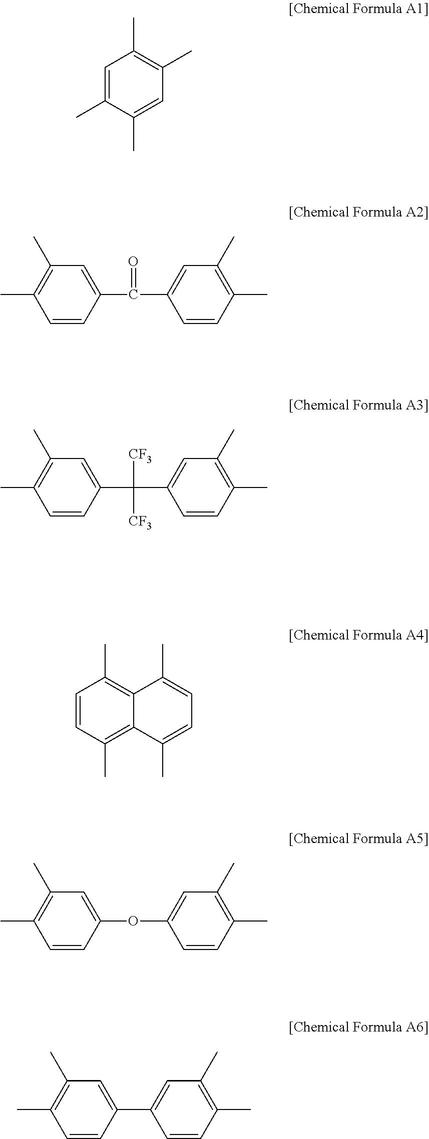

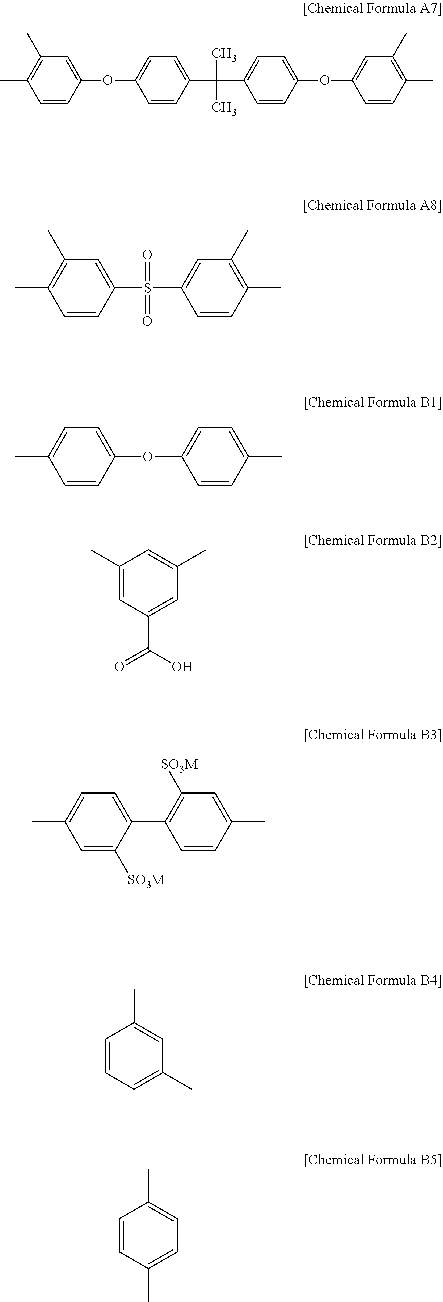

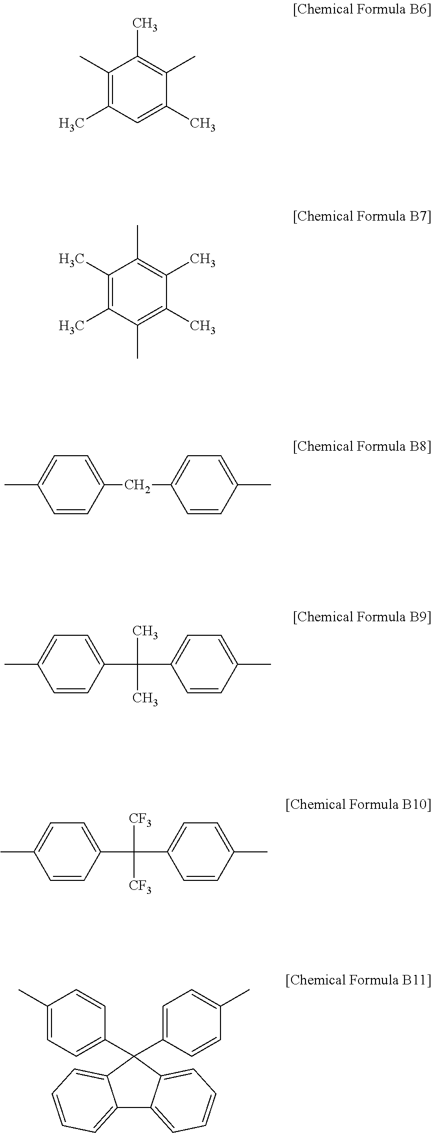

In the above chemical formulae,

M is sodium, potassium, lithium, an alloy thereof, or a combination thereof.

In the above Chemical Formulae 37 to 50, Ar₁ may be a functional group represented by the following Chemical Formulae A1 to A8, Ar₁′ may be a functional group represented by the following Chemical Formulae C1 to C8, Ar₂ may be a functional group represented by the following Chemical Formulae B1 to B11, and Q may be C(CF₃)₂.

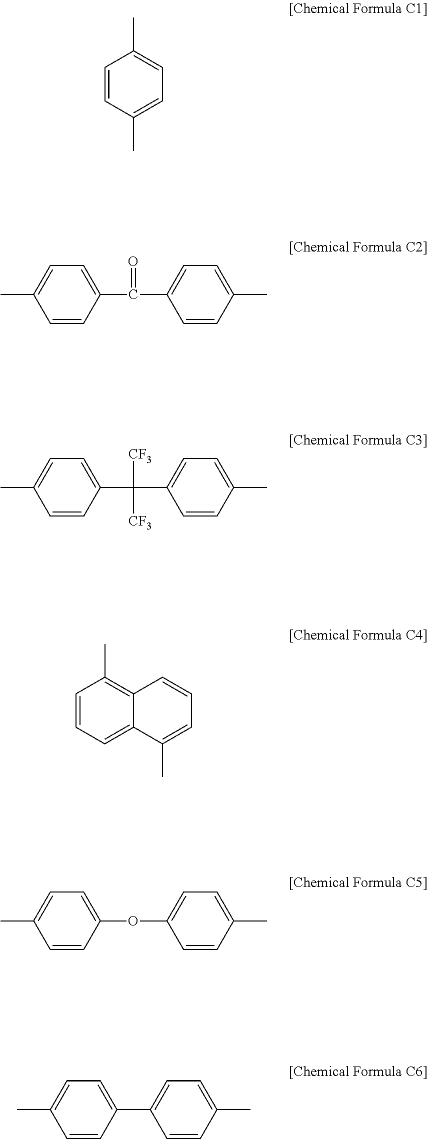

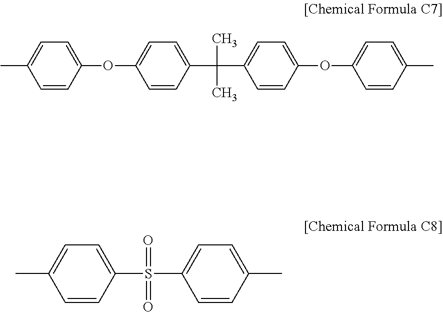

The porous support of the separator for a rechargeable lithium battery may include a micropore, and a picopore present in a polymer derived from the polyamic acid or a picopore present in a polymer derived from the polyimide. Specifically, the micropore may have a diameter of about 0.01 μm to about 50 μm, and the picopore may have a diameter of about 100 pm to about 1000 pm.

At least two of the picopores may be connected to each other to form an hourglass-shaped structure.

The picopore may have a full width at half maximum (FWHM) ranging from about 10 pm to about 40 pm measured by positron annihilation lifetime spectroscopy (PALS).

The porous support may include a fiber including the polymer, and the fiber may be arranged randomly.

The porous support may include a fiber including the polymer, and the fiber may be arranged unidirectionally.

The separator for a rechargeable lithium battery may have porosity of about 10 volume % to about 95 volume % based on the total volume of a separator for a rechargeable lithium battery.

The separator for a rechargeable lithium battery may have a thickness of about 10 μm to about 200 μm.

The separator for a rechargeable lithium battery may have a thermal decomposition temperature of about 350° C. to about 1000° C.

The separator for a rechargeable lithium battery may further include an inorganic particle. The inorganic particle may include an inorganic particle having a dielectric constant of 3 or more, an inorganic particle having a lithium ion transport capability, or a combination thereof.

Specifically, the inorganic particle having a dielectric constant of 3 or more may include BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof. The inorganic particle having lithium ion transport capability may include lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, and 0<z<3), (LiAlTiP)ₓO_{y} based glass (0<x<4, 0<y<13), lithium lanthanum titanate (LiₓLa_{y}TiO₃, 0<x<2, and 0<y<3), lithium germanium thiophosphate (LiₓGe_{y}P_{z}S_{w}, 0<x<4, 0<y<1, 0<z<1, and 0<w<5), lithium nitride (LiₓN_{y}, 0<x<4, and 0<y<2), SiS₂ based glass (LiₓSi_{y}S_{z}, 0<x<3, 0<y<2, and 0<z<4), P₂S₅ based glass (LiₓP_{y}S_{z}, 0<x<3, 0<y<3, and 0<z<7), Li₂O, LiF, LiOH, Li₂CO₃, LiAlO₂, or a combination thereof.

The inorganic particle may have a diameter of about 0.001 μm to about 10 μm. The inorganic particle may be included in an amount of about 0.1 parts by weight to about 50 parts by weight based on 100 parts by weight of a polymer derived from the polyamic acid or a polymer derived from the polyimide.

According to another embodiment, provided is a composition for forming a separator for a rechargeable lithium battery that includes polyamic acid or polyimide including a repeating unit prepared from aromatic diamine including at least one ortho-positioned functional group relative to an amine group and dianhydride; and an organic solvent. The organic solvent may be selected from the group consisting of dimethylsulfoxide; N-methyl-2-pyrrolidone; N-methylpyrrolidone; N,N-dimethyl formamide; N,N-dimethyl acetamide; a ketone selected from the group consisting of γ-butyrolactone, cyclohexanone, 3-hexanone, 3-heptanone and 3-octanone; and a combination thereof.

The polyamic acid and the polyimide may have a weight average molecular weight (Mw) of 10,000 g/mol to 500,000 g/mol, respectively.

The composition for forming a separator for a rechargeable lithium battery may include about 1 wt % to about 40 wt % of the polyamic acid or the polyimide, and about 60 wt % to about 99 wt % of the organic solvent based on the total amount of the composition for forming a separator for a rechargeable lithium battery.

The composition for forming a separator for a rechargeable lithium battery may further include an auxiliary agent selected from the group consisting of water; alcohols selected from the group consisting of methanol, ethanol, 2-methyl-1-butanol, 2-methyl-2-butanol, glycerol, ethylene glycol, diethylene glycol, and propylene glycol; ketones selected from the group consisting of acetone and methylethyl ketone; a polymer compound selected from the group consisting of polyvinyl alcohol, polyacrylic acid, polyacrylamide, polyethylene glycol, polypropylene glycol, chitosan, chitin, dextran, and polyvinylpyrrolidone; tetrahydrofuran; trichloroethane; and a combination thereof. Herein, the composition for forming a separator for a rechargeable lithium battery may include about 1 wt % to about 40 wt % of the polyamic acid or the polyimide, about 10 wt % to about 95 wt % of the organic solvent, and about 4 wt % to about 70 wt % of the auxiliary agent based on the total amount of the composition for forming a separator for a rechargeable lithium battery including the auxiliary agent.

The composition for forming a separator for a rechargeable lithium battery may further include an inorganic particle, and the inorganic particle may include an inorganic particle having a dielectric constant of 3 or more, an inorganic particle having lithium ion transport capability, or a combination thereof. The inorganic particle having a dielectric constant of 3 or more and an inorganic particle having lithium ion transport capability are the same as described above. Herein, the composition for forming a separator for a rechargeable lithium battery may include about 1 wt % to about 40 wt % of the polyamic acid or the polyimide, about 10 wt % to about 95 wt % of the organic solvent, and about 0.1 wt % to about 50 wt % of the inorganic particle based on the total amount of the composition for forming a separator for a rechargeable lithium battery including the inorganic particle.

The composition for forming a separator for a rechargeable lithium battery may have viscosity of about 0.01 Pa·s to about 100 Pa·s.

According to another embodiment, provided is a method of manufacturing a separator for a rechargeable lithium battery that includes electrospinning the composition for forming a separator for a rechargeable lithium battery to form a non-woven fabric; and heat-treating the non-woven fabric to form a porous support including a polymer derived from polyamic acid or a polymer derived from polyimide.

The electrospinning may be performed by applying a voltage of about 1 kV to about 1000 kV.

The non-woven fabric may include a randomly arranged fiber including the composition for forming a separator for a rechargeable lithium battery.

The non-woven fabric may include a unidirectionally arranged fiber including the composition for forming a separator for a rechargeable lithium battery.

The polymer is derived from thermal rearrangement of the polyamic acid or the polyimide, and may have a ratio of thermally rearranged repeating units (thermal rearrangement rate) of about 10 mol % to about 100 mol % based on the total amount of a repeating unit in the polyamic acid or polyimide.

The heat-treating may be performed at a temperature of about 250° C. to about 550° C. for about 10 minutes to about 5 hours. The heat-treating may be performed at a temperature increase rate of about 1° C./min to about 20° C./min.

The method of manufacturing the separator for a rechargeable lithium battery may further include forming an inorganic particle coating layer inside, on a surface, or both thereof of the porous support, after forming the porous support. The inorganic particle may include an inorganic particle having a dielectric constant of 3 or more, an inorganic particle having lithium ion transport capability, or a combination thereof. The inorganic particle having a dielectric constant of 3 or more and the inorganic particle having lithium ion transport capability are the same as described above.

The method of manufacturing the separator for a rechargeable lithium battery may further include forming a coating layer including an inorganic particle and a binder polymer inside, on a surface, or both thereof of the porous support, after forming the porous support. The inorganic particle may include an inorganic particle having a dielectric constant of 3 or more, an inorganic particle having lithium ion transport capability, or a combination thereof. The inorganic particle having a dielectric constant of 3 or more and the inorganic particle having lithium ion transport capability are the same as described above.

The binder polymer may include polyvinylidene fluoride-hexafluoropropylene, polyvinylidene fluoride-trichloroethylene, polymethylmethacrylate, polyacrylonitrile, polyvinylpyrrolidone, polyvinylacetate, polyethylene-vinyl acetate, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, an acrylonitrile-styrenebutadiene copolymer, polyimide, or a combination thereof.

According to another embodiment, provided is a rechargeable lithium battery that includes a positive electrode including a positive active material, a negative electrode including a negative active material, the separator for a rechargeable lithium battery, and a non-aqueous electrolyte.

### Advantageous Effects

The separator for a rechargeable lithium battery has excellent thermal stability and wettability for a non-aqueous electrolyte and may improve the cycle-life characteristic, and particularly, the high temperature cycle-life characteristic of the rechargeable lithium battery.

### DESCRIPTION OF THE DRAWINGS

FIG. 1 is a schematic view showing a rechargeable lithium battery according to one embodiment of the present invention.

FIG. 2 is the SEM photograph of a non-woven fabric according to Example 1.

FIG. 3 is a graph showing discharge capacity of half cells according to Examples 8 and 9 depending on a number of cycles.

FIG. 4 is a graph showing discharge capacity of the half cells according to Examples 8 and 9 depending on a number of cycles.

### MODE FOR INVENTION

Exemplary embodiments of the present invention will hereinafter be described in detail. However, these embodiments are only exemplary, and the present invention is not limited thereto.

Thicknesses in the drawings are enlarged to clarify various layers and regions. The same reference numerals are applied to similar parts throughout the specification with reference to the drawings.

As used herein, when a specific definition is not provided, the term “picopore” refers to a pore having an average diameter of hundreds of picometers, and specifically about 100 pm to about 1000 pm, and the term “micropore” refers to a pore having an average diameter of about 2 nm to about 50 μm, and specifically about 10 nm to about 10 μm.

As used herein, when a specific definition is not provided, the term “substituted” refers to a compound or a functional group where hydrogen is substituted with at least one substituent selected from the group consisting of a C1 to C10 alkyl group, a C1 to C10 alkoxy group, a C1 to C10 haloalkyl group, and a C1 to C10 haloalkoxy group, the term “heterocyclic group” refers to a group including 1 to 5 heteroatoms selected from the group consisting of O, S, N, P, Si, and a combination thereof in the ring, a substituted or unsubstituted C2 to C30 cycloalkyl group, a substituted or unsubstituted C2 to C30 cycloalkenyl group, a substituted or unsubstituted C2 to C30 cycloalkynyl group, a substituted or unsubstituted C2 to C30 heteroaryl group, a substituted or unsubstituted C2 to C30 cycloalkylene group, a substituted or unsubstituted C2 to C30 cycloalkenylene group, a substituted or unsubstituted C2 to C30 cycloalkynylene group, or a substituted or unsubstituted C2 to C30 heteroarylene group.

As used herein, when a specific definition is not provided, the “combination” refers to a mixture or copolymerization. The term “copolymerization” refers to block copolymerization to random copolymerization, and the term “copolymer” refers to a block copolymer to a random copolymer.

According to one embodiment, a separator for a rechargeable lithium battery including a porous support including a polymer derived from polyamic acid or a polymer derived from polyimide is provided. The polyamic acid and the polyimide may include a repeating unit prepared from an aromatic diamine including at least one ortho-positioned functional group relative to an amine group and dianhydride.

The separator for a rechargeable lithium battery includes a polymer derived from the polyamic acid or polyimide, and thus may have improved mechanical strength, heat resistance, and wettability for a non-aqueous electrolyte. Accordingly, the separator for a rechargeable lithium battery may improve the cycle-life characteristic of a rechargeable lithium battery, and specifically, its high temperature cycle-life characteristic. The separator for a rechargeable lithium battery may be widely used for a rechargeable lithium battery for a car as well as a rechargeable lithium battery used as a power source for an electronic device such as a mobile phone, a laptop, and the like.

The ortho-positioned functional group relative to the amine group may be OH, SH, or NH₂.

The polyamic acid and the polyimide may be prepared by generally-used method in this art.

For example, the polyamic acid is obtained from reaction of an aromatic diamine including OH, SH, or NH₂ at the ortho-position relative to an amine group, and tetracarboxylic acid anhydride and the polyimide may be prepared through imidization of the polyamic acid, for example through solution-thermal imidization or chemical imidization.

The solution-thermal imidization may be performed using an azeotropic mixture that further includes benzenes such as benzene, toluene, xylene, cresol, and the like, aliphatic organic solvents such as hexane, alicyclic organic solvents such as cyclohexane, and the like.

The polyamic acid and the polyimide may be thermally rearranged by a predetermined heat-treatment and thermally rearranged into a polymer having excellent mechanical strength and heat resistance and a high fractional free volume such as polybenzoxazole, polybenzothiazole, and polypyrrolone. In addition, the polymer such as polybenzoxazole, polybenzothiazole, polypyrrolone may have a picopore.

Specifically, a ratio of thermally rearranged repeating units (thermal rearrangement rate) may range from about 10 mol % to about 100 mol % based on the total amount of repeating units in the polyamic acid or polyimide. The polymer may effectively improve heat resistance and mechanical strength of the porous support and have better wettability for a non-aqueous electrolyte, and thus improve the cycle-life characteristic, and particularly, the high temperature cycle-life characteristic of a rechargeable lithium battery. Specifically, a ratio of thermally rearranged repeating units (thermal rearrangement rate) may range from about 40 mol % to about 100 mol % based on the total amount of a repeating unit in the polyamic acid or polyimide.

The polymer derived from polyamic acid and the polymer derived from polyimide may have a fractional free volume (FFV) of about 0.18 to about 0.40, and an XRD interplanar distance (d-spacing) measured by XRD of about 550 pm to about 800 pm. Accordingly, the polymers derived from the polyamic acid and from the polyimide may easily permeate or separate low molecules.

The polyamic acid used forming for the separator for a rechargeable lithium battery may be selected from a polyamic acid including a repeating unit represented by the following Chemical Formulae 1 to 4, a polyamic acid copolymer including a repeating unit of the following Chemical Formulae 5 to 8, a copolymer thereof, and a blend thereof, but is not limited thereto.

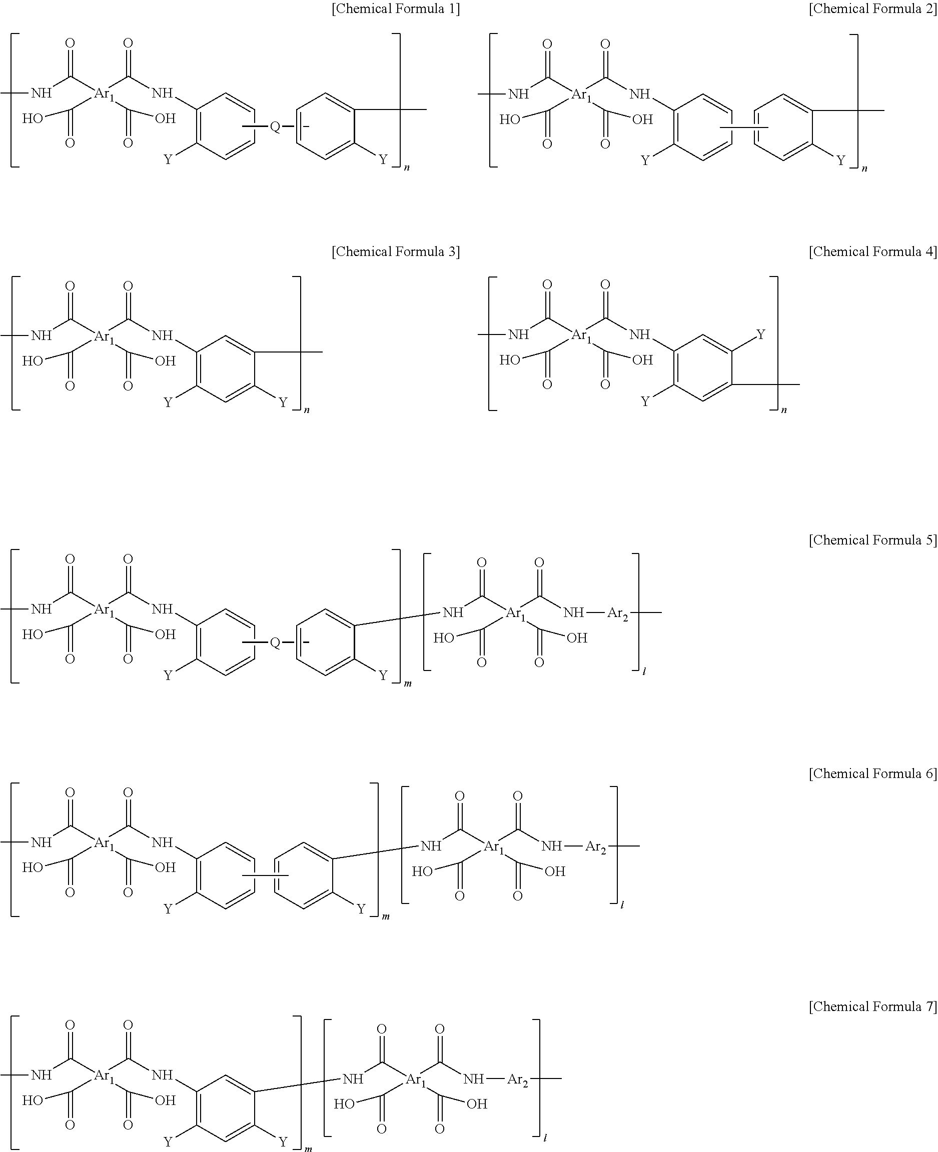

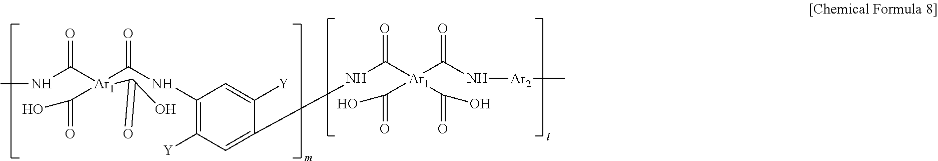

In the above Chemical Formulae 1 to 8,

Ar₁ is an aromatic ring group selected from a substituted or unsubstituted tetravalent C6 to C24 arylene group and a substituted or unsubstituted tetravalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Ar₂ is an aromatic group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,

Y is the same or different from each other in each repeating unit and is independently OH, SH, or NH₂,

n is an integer satisfying 20≦n≦1200,

m is an integer satisfying 10≦m≦400, and

l is an integer satisfying 10≦l≦400.

Examples of a copolymer of polyamic acid including a repeating unit represented by the above Chemical Formulae 1 to 4 may include a polyamic acid copolymer including a repeating unit represented by the following Chemical Formulae 9 to 18.

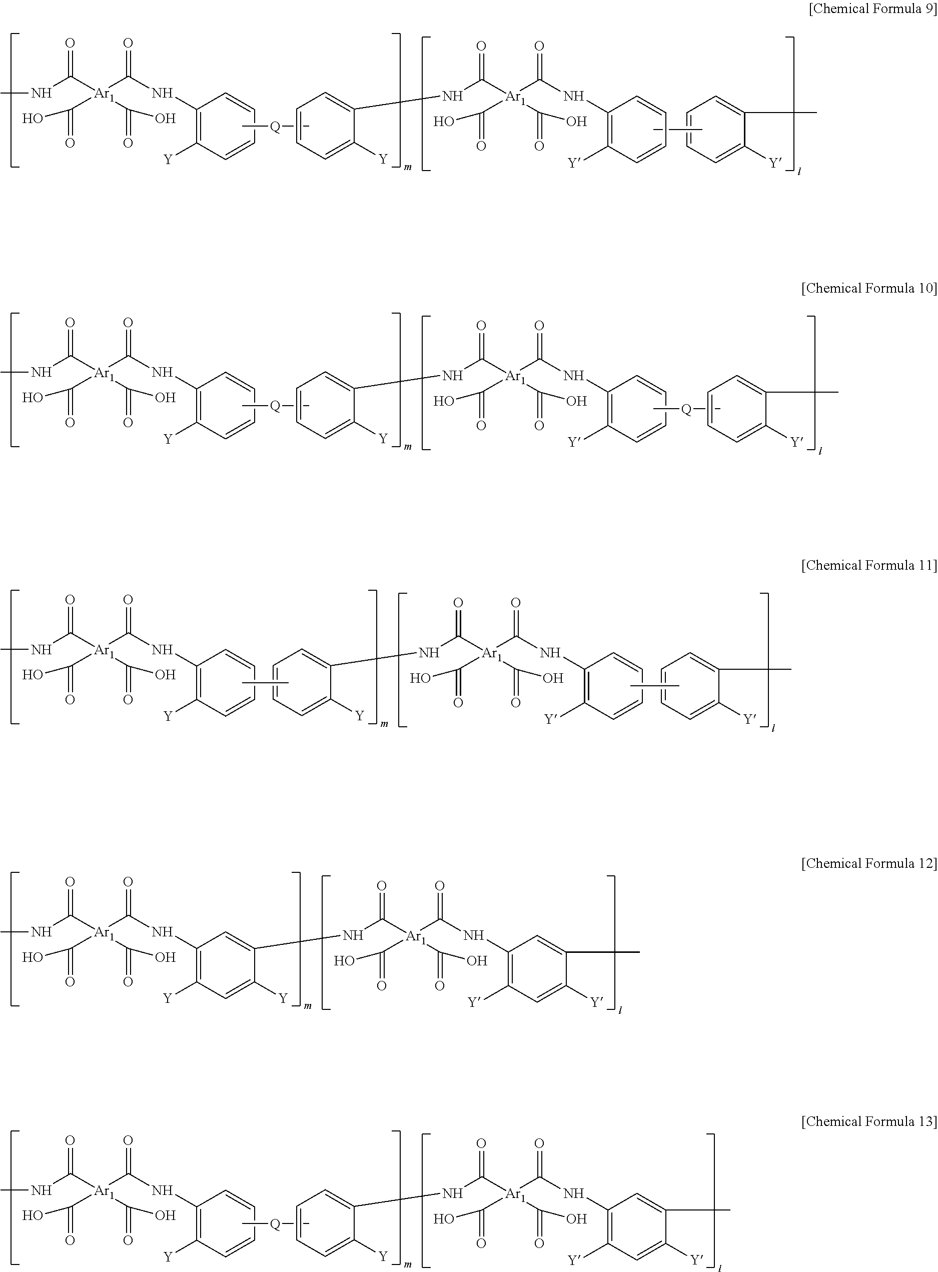

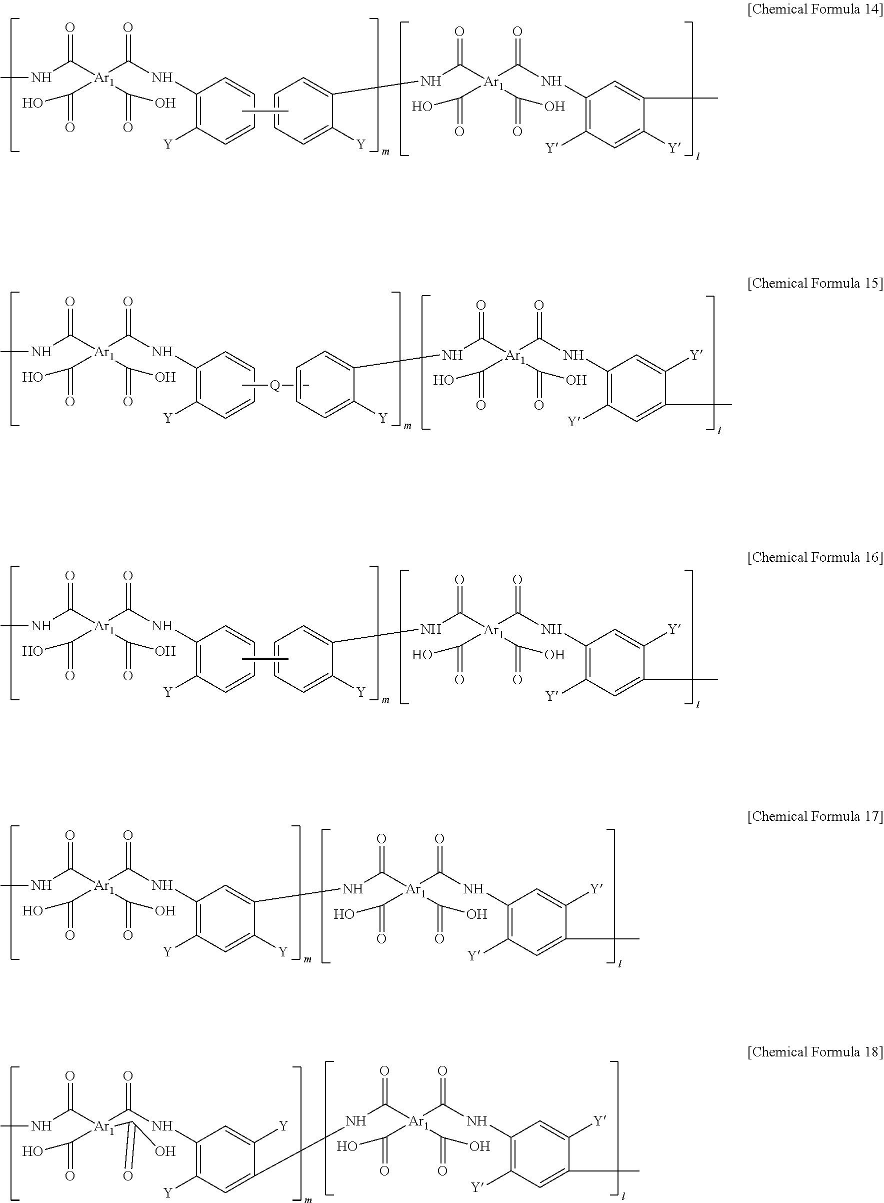

In the above Chemical Formulae 9 to 18,

Ar₁, Q, n, m, and l are the same as defined in the above Chemical Formulae 1 to 8, and

Y and Y′ are the same or different, and are independently OH, SH, or NH₂.

Examples of the polyimide used forming for the separator for a rechargeable lithium battery may be selected from polyimide including a repeating unit represented by the following Chemical Formulae 19 to 22, a polyimide copolymer including a repeating unit the following Chemical Formulae 23 to 26, a copolymer thereof, and a blend thereof, but is not limited thereto.

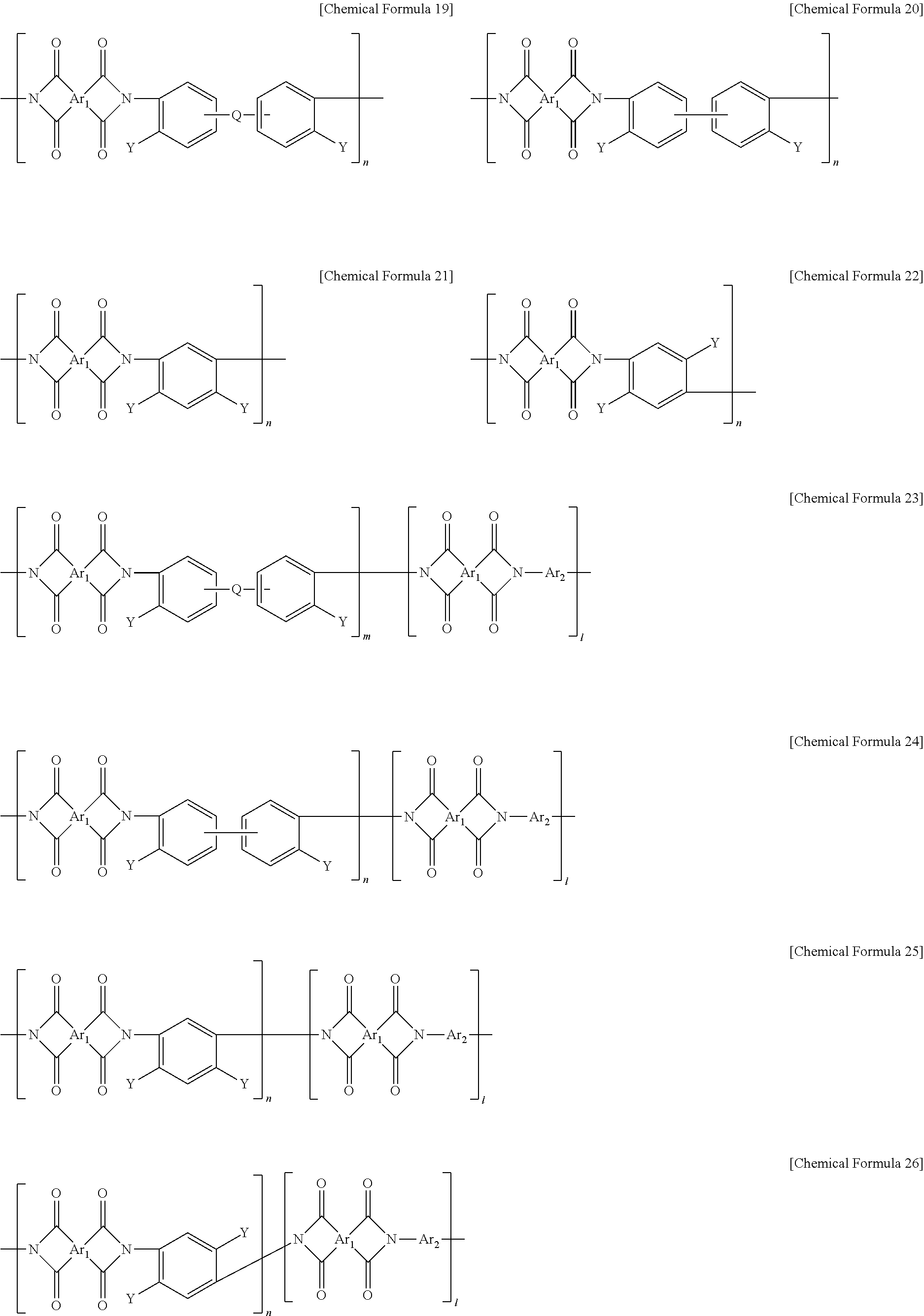

In the above Chemical Formulae 19 to 26,

Ar₁, Ar₂, Q, Y, n, m, and l are the same as defined in Chemical Formulae 1 to 8.

Examples of a copolymer of polyimide including a repeating unit represented by the above Chemical Formulae 19 to 22 may include a polyimide copolymer including a repeating unit represented by the following Chemical Formulae 27 to 36.

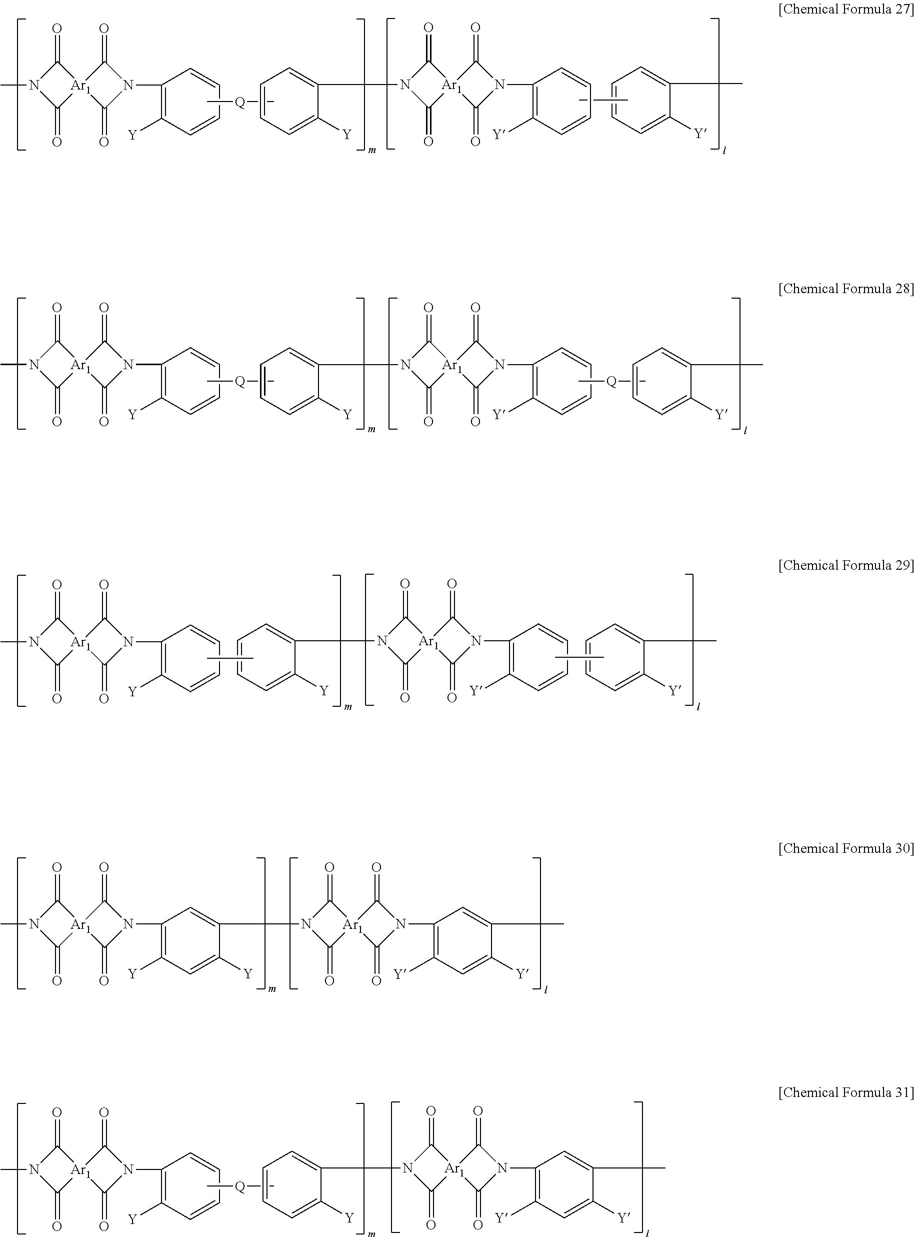

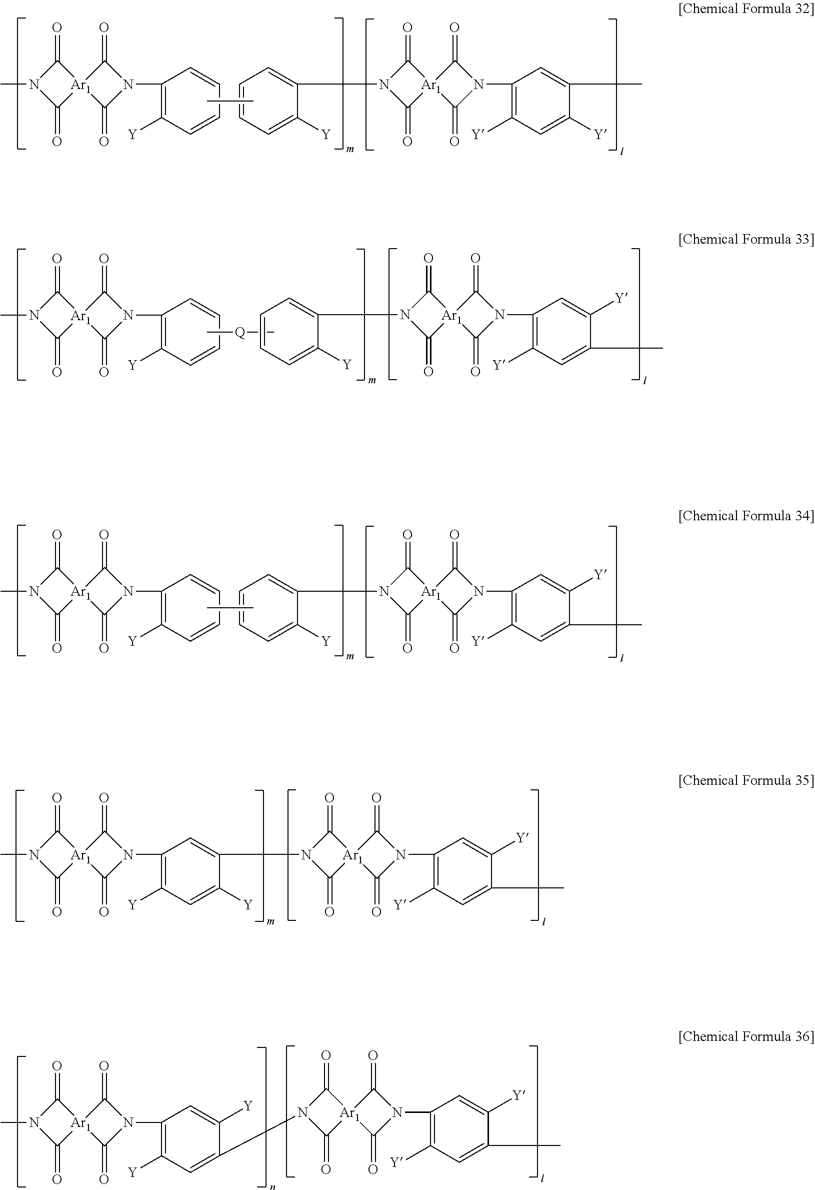

In the above Chemical Formulae 27 to 36,

Ar₁, Q, m, and l are the same as defined in the above Chemical Formulae 1 to 8, and

Y and Y are the same or different from each other in each repeating unit and are independently OH, SH, or NH₂.

In Chemical Formulae 1 to 36, Ar₁ may be selected from the following chemical formulae, but is not limited thereto.

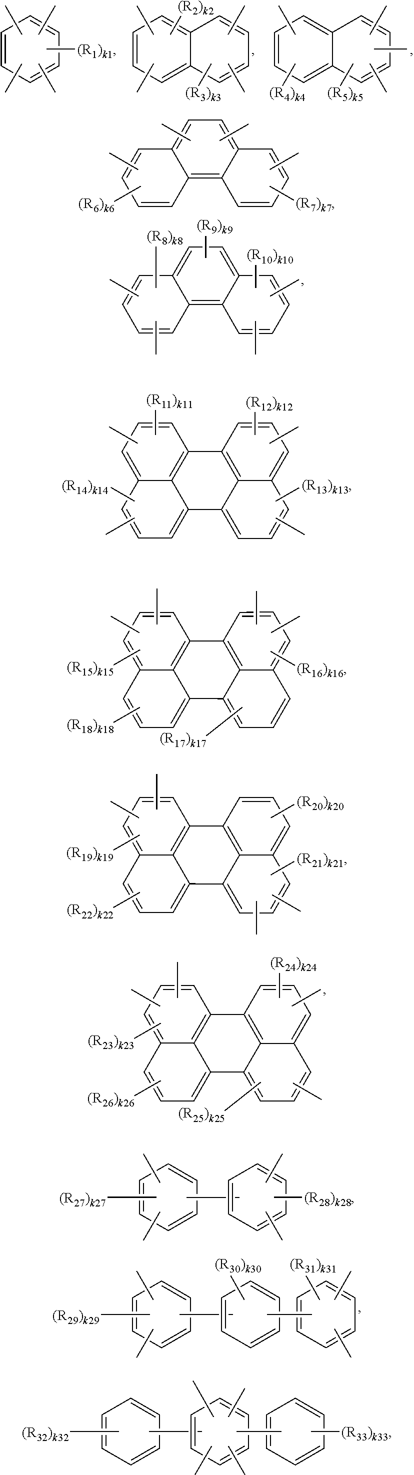

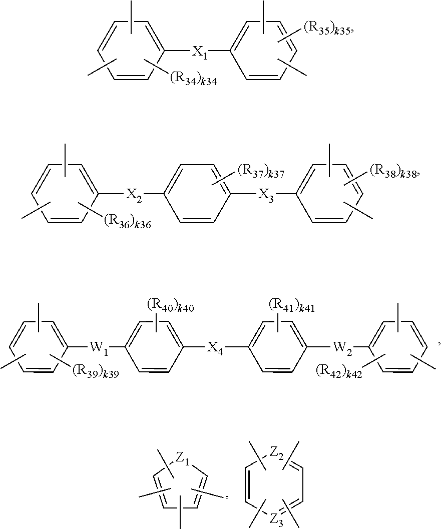

In the above chemical formulae,

X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C (═O),

Z₁ is O, S, CR₁₀₀R₁₀₁, or NR₁₀₂, wherein R₁₀₀, R₁₀₁, and R₁₀₂ are the same or different and are independently hydrogen or C1 to C5 alkyl group,

Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,

R₁ to R₄₂ are the same or different and are independently hydrogen, or a substituted or unsubstituted C1 to C10 aliphatic organic group,

k1 to k3, k8 to k14, k24, and k25 are integers ranging from 0 to 2,

k5, k15, k16, k19, k21, and k23 are integers of 0 or 1,

k4, k6, k7, k17, k18, k20, k22, k26 to k29, k31, k34 to k36, k38, k39, and k42 are integers ranging from 0 to 3,

k30, k37, k40, and k41 are integers ranging from 0 to 4, and

k32 and k33 are integers ranging from 0 to 5.

In the above Chemical Formulae 1 to 36, specific examples of Ar₁ may be selected from the following chemical formulae, but are not limited thereto.

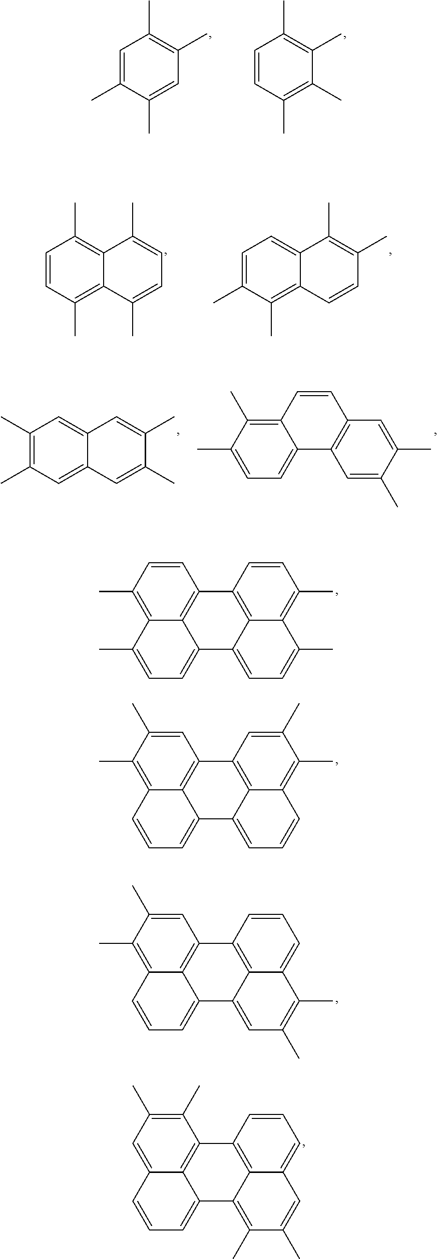

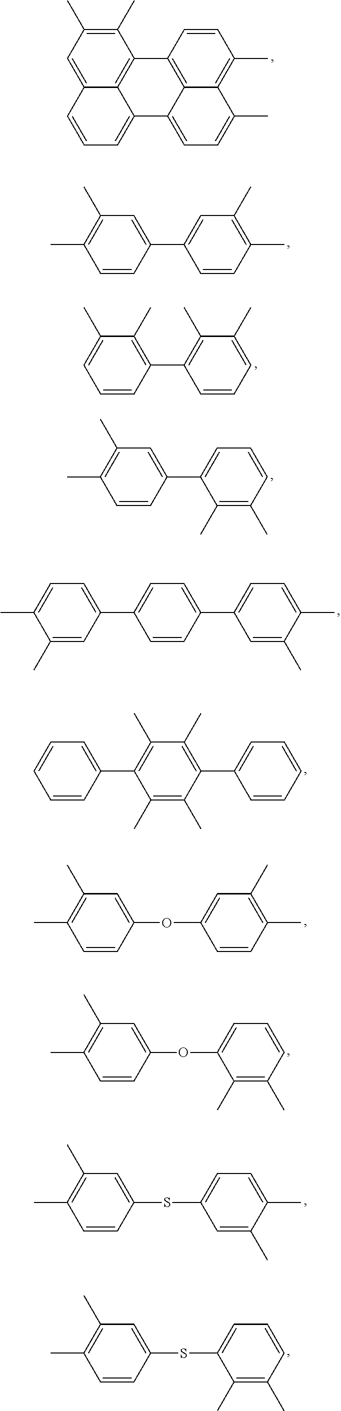

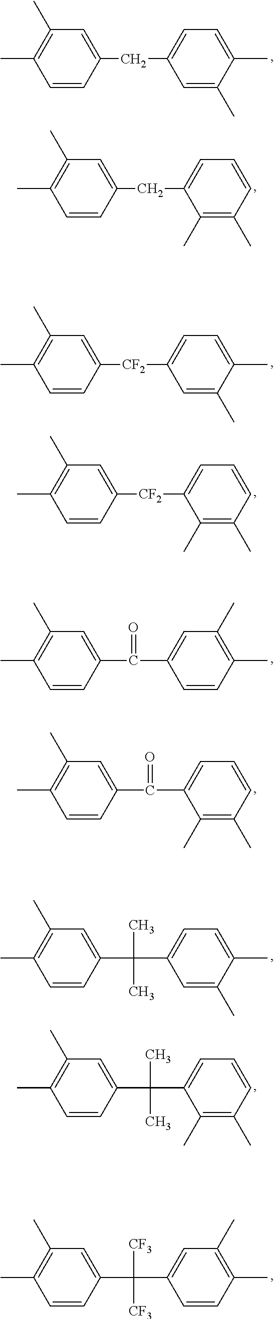

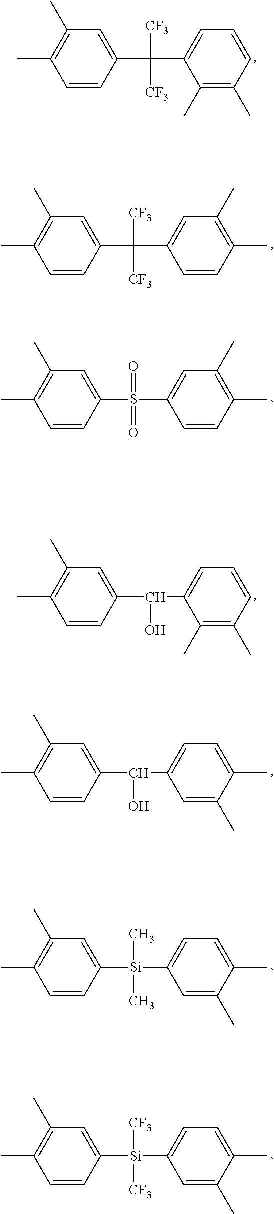

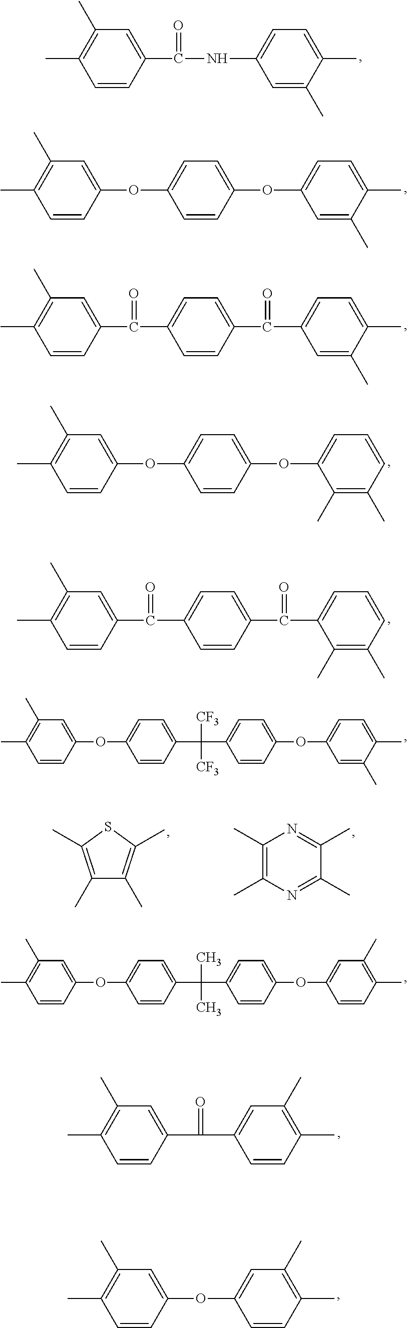

In the above Chemical Formulae 1 to 36, Ar₂ may be selected from the following chemical formulae, but are not limited thereto.

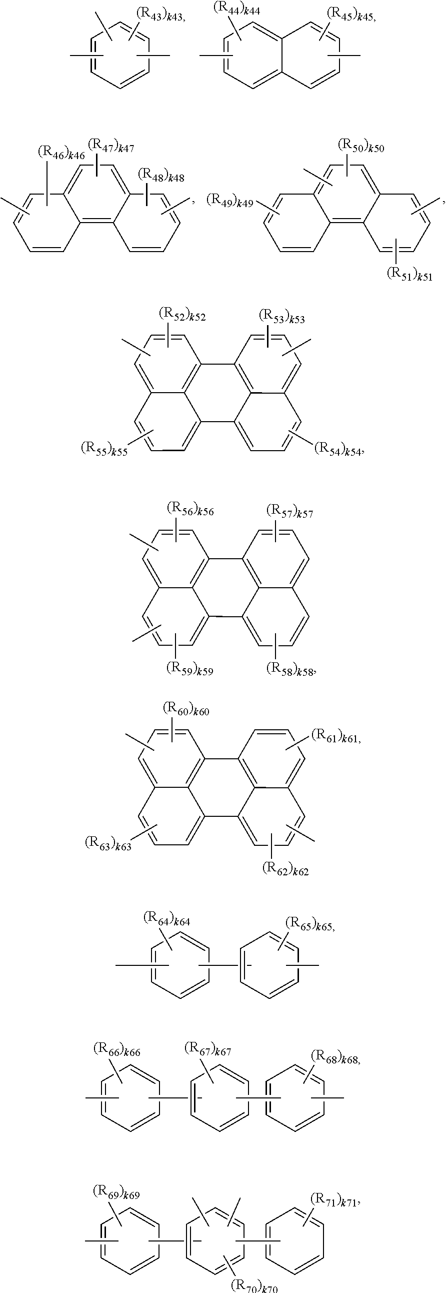

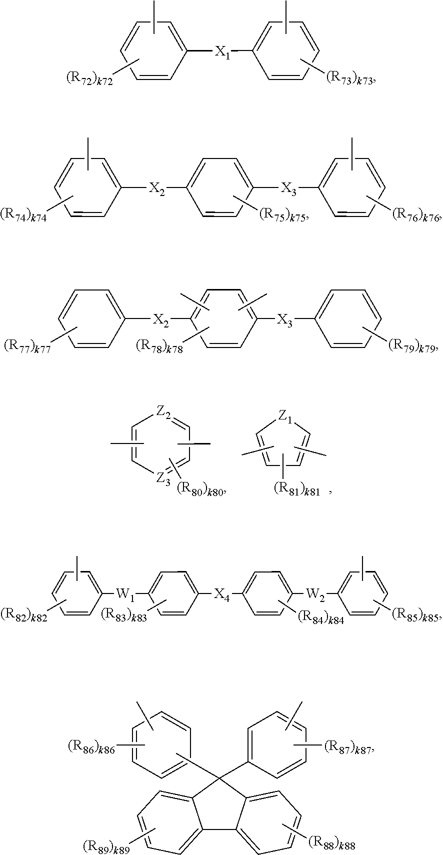

In the above chemical formulae,

X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,

W₁ and W₂ are the same or different and are independently O, S, or C(═O),

Z₁ is O, S, CR₁₀₀R₁₀₁, or NR₁₀₂, wherein R₁₀₀, R₁₀₁, and R₁₀₂ are the same or different and are independently hydrogen or a C1 to C5 alkyl group,

Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,

R₄₃ to R₈₉ are the same or different and are independently hydrogen, a substituted or unsubstituted C1 to C10 aliphatic organic group, or a metal sulfonate group,

k43, k49, k64 to k68, k72 to k76, and k82 to k89 are integers ranging from 0 to 4,

k44 to k46, k48, k51, k54, k55, k57, k58, k61, and k63 are integers ranging from 0 to 3,

k47, k52, k53, k56, k59, k60, k62, k70, k78, k80, and k81 are integers ranging from 0 to 2,

k50 is an integer of 0 or 1, and

k69, k71, k77, and k79 are integers ranging from 0 to 5.

In the above Chemical Formulae 1 to 36, specific examples of Ar₂ may be selected from one of the following chemical formulae, but are not limited thereto.

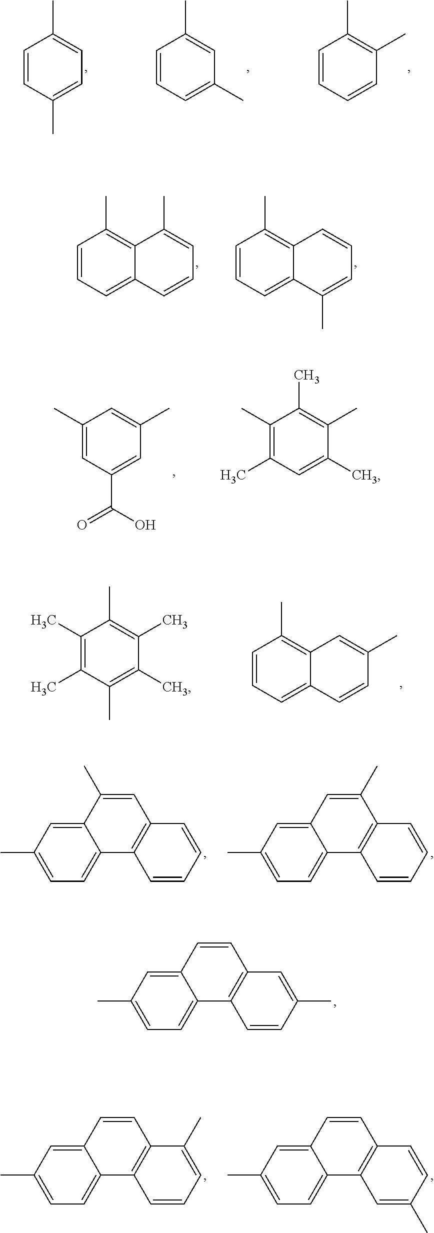

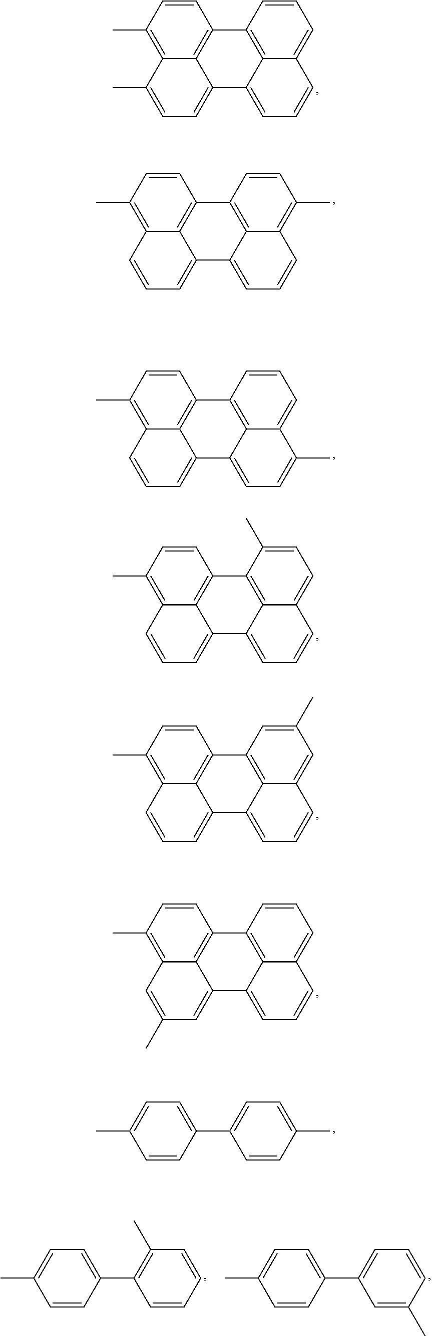

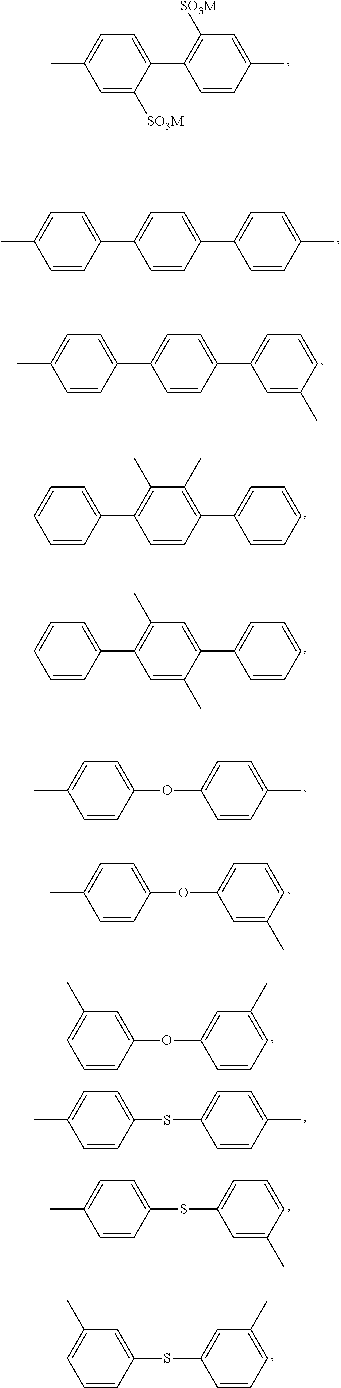

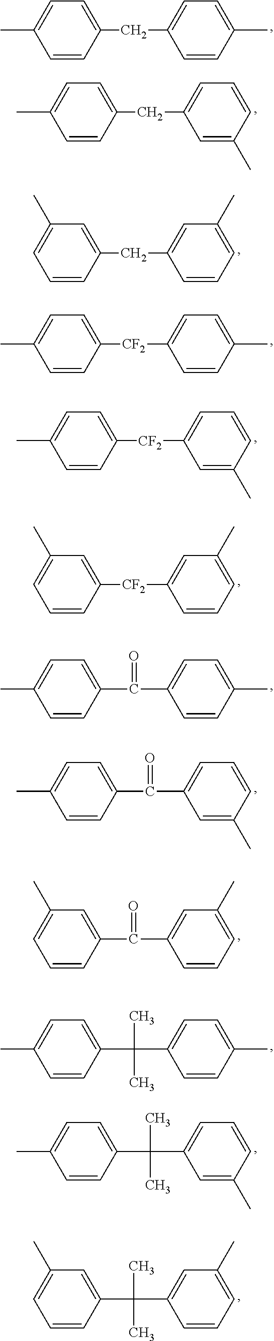

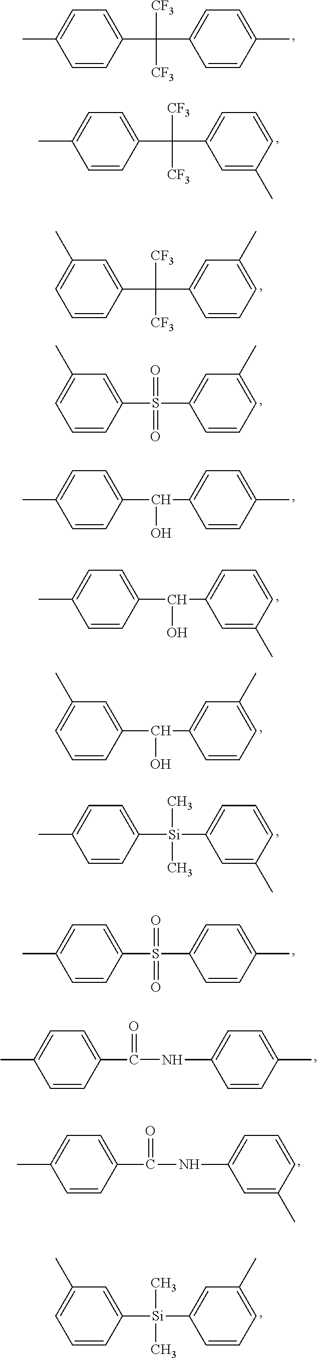

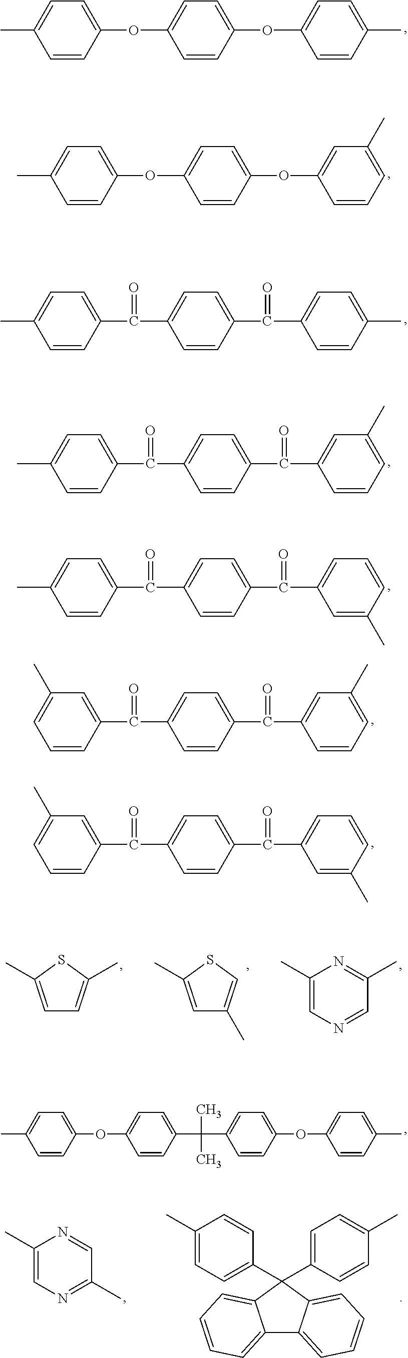

In the above chemical formulae, M is a metal, wherein the metal is sodium, potassium, lithium, an alloy thereof, or a combination thereof.

In the above Chemical Formulae 1 to 36, examples of Q may be selected from C(CH₃)₂, C(CF₃)₂, O, S, S(═O)₂, or C(═O), but are not limited thereto.

In the above Chemical Formulae 1 to 36, Ar₁ may be a functional group represented by one of the following Chemical Formulae A1 to A8, Ar₂ may be a functional group represented by one of the following Chemical Formulae B1 to B11, and Q may be C(CF₃)₂, without limitation.

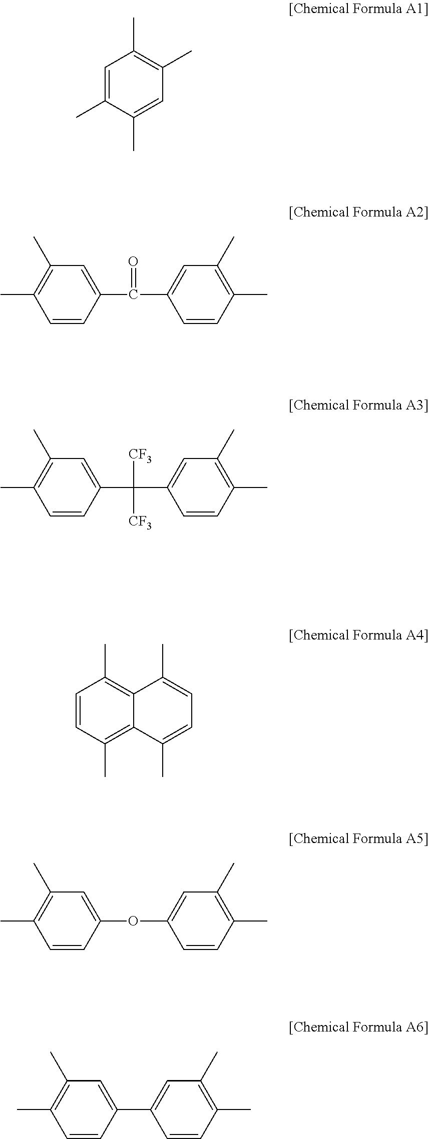

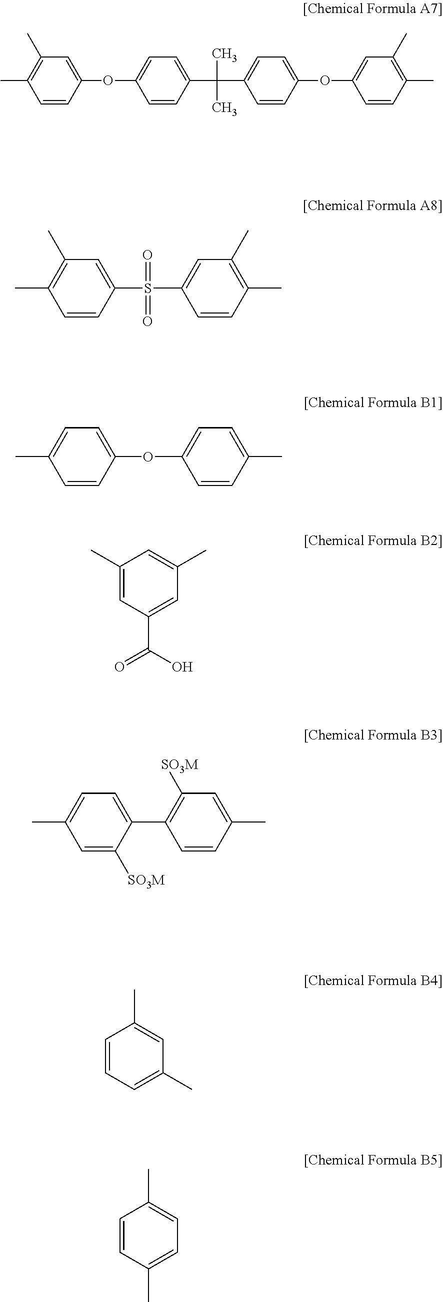

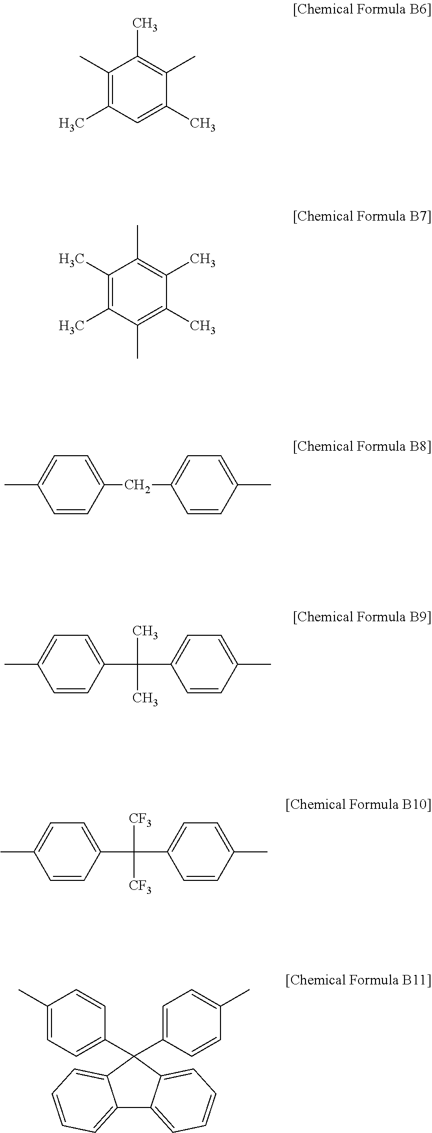

In the above chemical formulae,

M is sodium, potassium, lithium, an alloy thereof, or a combination thereof.

The polyamic acid including the repeating unit represented by the above Chemical Formulae 1 to 4 and the polyimide including the repeating unit represented by the above Chemical Formulae 19 to 22 may be prepared in a generally-used manufacturing method. For example, tetracarboxylic acidanhydride as a monomer is reacted with an aromatic diamine including an OH, SH, or NH₂ group.

The polyamic acid including the repeating unit represented by the above Chemical Formulae 1 to 4 is imidized and thermally rearranged by a predetermined heat-treatment, and the polyimide including the repeating unit represented by the above Chemical Formulae 19 to 22 is also thermally rearranged by a predetermined heat-treatment, being converted into a polymer having excellent mechanical properties and a high fractional free volume such as polybenzoxazole, polybenzothiazole, and polypyrrolone. In addition, these polymers such as polybenzoxazole, polybenzothiazole, and polypyrrolone may have a picopore.

Herein, the polybenzoxazole derived from the polyhydroxyamic acid including OH for Y in the above Chemical Formulae 1 to 4 or polyhydroxyimide including OH for Y in the above Chemical Formulae 19 to 22, the polybenzothiazole derived from polythiolamic acid or polythiolimide including SH for Y, or the polypyrrolone derived from polyaminoamic acid or polyaminoimide including NH₂ for Y is included in a porous support to fabricate a separator for a rechargeable lithium battery.

In addition, the separator for a rechargeable lithium battery may be regulated regarding properties by controlling a mole ratio among repeating units included in a copolymer of polyamic acid including the repeating units represented by the above Chemical Formulae 1 to 4, or a mole ratio among repeating units in a copolymer of polyimide including the repeating units represented by the above Chemical Formulae 19 to 22.

The polyamic acid copolymer including the repeating units represented by the above Chemical Formulae 5 to 8 may be imidized and thermally rearranged by a predetermined heat-treatment. In addition, the polyimide copolymer including the repeating units represented by the above Chemical Formulae 23 to 26 may be thermally rearranged by a predetermined heat-treatment. Accordingly, the polyamic acid copolymer including the repeating unit represented by the above Chemical Formulae 5 to 8 and the polyimide copolymer including the repeating units represented by the above Chemical Formulae 23 to 26 are converted into a poly(benzoxazole-imide) copolymer, a poly(benzothiazole-imide) copolymer, or a poly(pyrrolelone-imide) copolymer having excellent mechanical properties and heat resistance and a high fractional free volume. In addition, the thermally rearranged polymer may have a picopore. The thermally rearranged polymer may be used to fabricate a separator for a rechargeable lithium battery including a porous support including the copolymer. Herein, the separator for a rechargeable lithium battery may be regulated regarding properties by regulating a copolymerization ratio (a mole ratio) between a block thermally rearranged into polybenzoxazole, polybenzothiazole, or polypyrrolone and another block thermally rearranged into polyimide due to internal molecular and intermolecular rearrangement. Accordingly, the separator for a rechargeable lithium battery may effectively improve mechanical properties and the cycle-life characteristic of a rechargeable lithium battery.

The polyamic acid copolymer including repeating units represented by the above Chemical Formulae 9 to 18 may be imidized and thermally rearranged by a predetermined heat-treatment. In addition, the polyimide copolymer including repeating units represented by the above Chemical Formulae 27 to 36 may be imidized and thermally rearranged by a predetermined heat-treatment.

Accordingly, the polyamic acid copolymer including repeating units represented by the above Chemical Formulae 9 to 18 or the polyimide copolymer including repeating units represented by the above Chemical Formulae 27 to 36 is converted into polybenzoxazole, polybenzothiazole, and polypyrrolone copolymers having excellent mechanical properties and heat resistance and a high fractional free volume. In addition, the thermally rearranged copolymers may have a picopore. The copolymers may be used to prepare a porous support included in a separator for a rechargeable lithium battery. Herein, the copolymerization ratio (a mole ratio) among blocks thermally rearranged into polybenzoxazole, polybenzothiazole, and polypyrrolone may be regulated to control properties of the separator for a rechargeable lithium battery. Accordingly, the separator for a rechargeable lithium battery may effectively improve mechanical properties and the cycle-life characteristic of a rechargeable lithium battery.

Herein, a mole ratio of m:l among the repeating units in the polyamic acid copolymer including the repeating units represented by the above Chemical Formulae 1 to 4, or a copolymerization ratio (a mole ratio) among blocks in the polyamic acid copolymer including the repeating units represented by above Chemical Formulae 5 to 8, may be in a range of about 0.1:9.9 to about 9.9:0.1, specifically, about 2:8 to about 8:2, and more specifically about 5:5.

In addition, a mole ratio of m:l among the repeating units in the polyimide copolymer including the repeating units represented by the above Chemical Formulae 19 to 22, or a copolymerization ratio (a mole ratio) among blocks in the polyimide copolymer including the repeating units represented by above Chemical Formulae 23 to 26, may be in a range of about 0.1:9.9 to about 9.9:0.1, specifically about 2:8 to about 8:2, and more specifically about 5:5.

The mole ratio or the copolymerization ratio may have an influence on morphology of the separator for a rechargeable lithium battery, which is related to pore characteristics, heat resistance, surface hardness, and the like. When the mole ratio or the copolymerization ratio is within the range, the separator for a rechargeable lithium battery may have excellent mechanical properties, heat resistance, and dimensional stability, and excellent porosity. In addition, the separator has excellent workability and may decrease manufacturing time and cost.

In the separator for a rechargeable lithium battery, the polymers derived from polyamic acid and from polyimide may be polymers including a repeating unit represented by one of the following Chemical Formulae 37 to 50 or a copolymer thereof, but is not limited thereto.

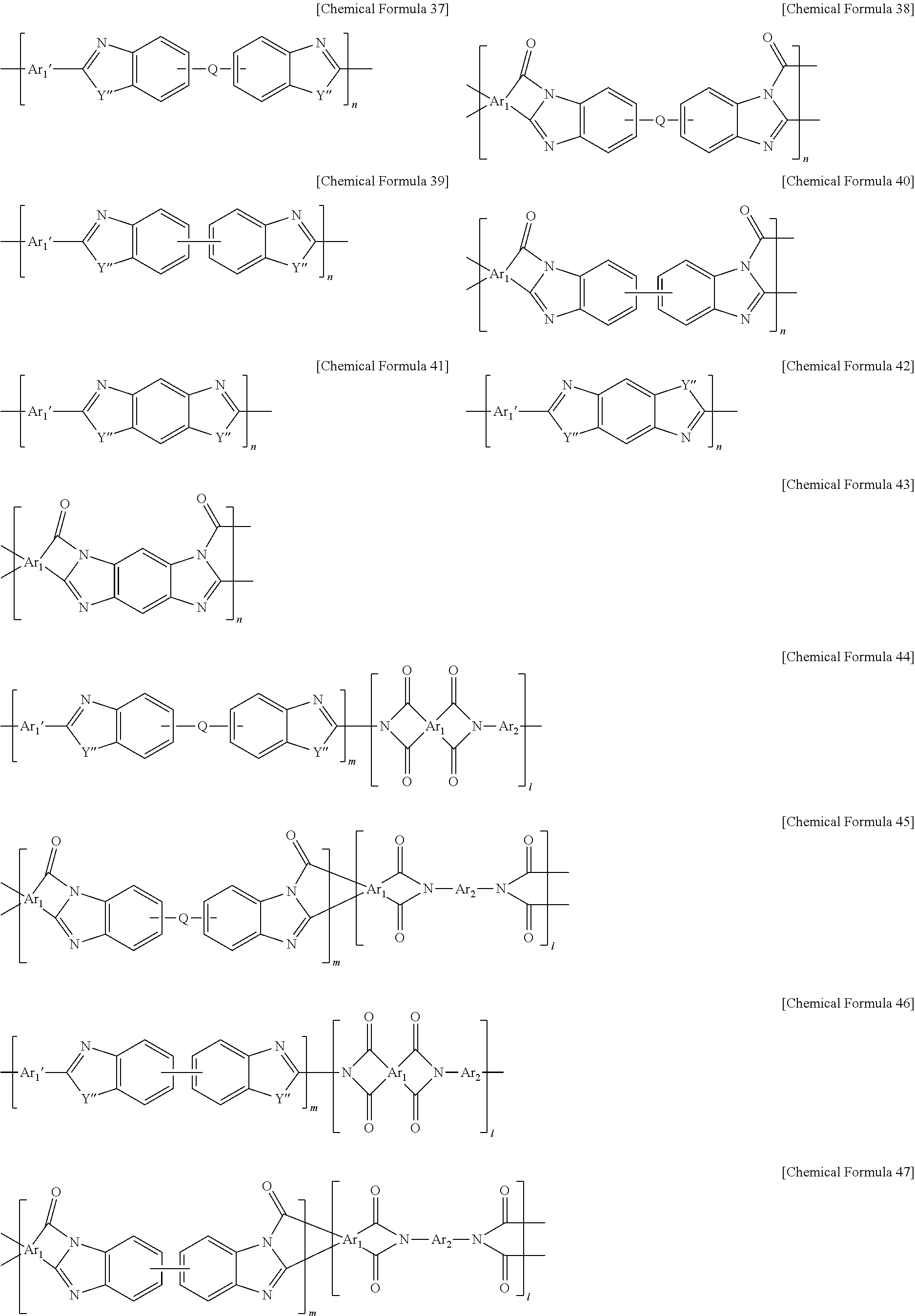

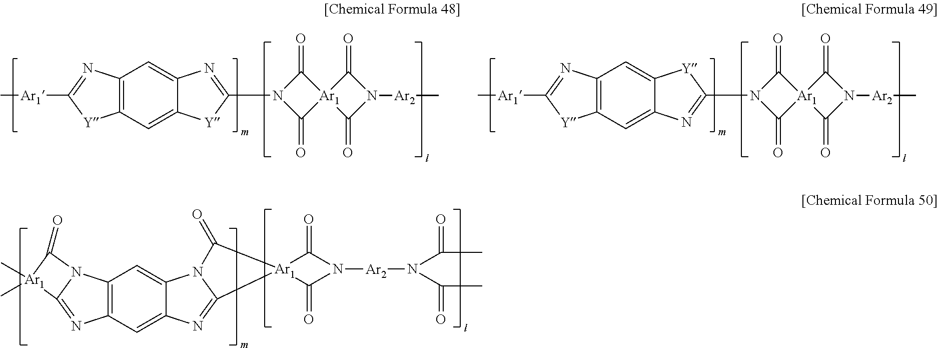

In the above Chemical Formulae 37 to 50,

Ar₁, Ar₂, Q, n, m, and l are the same as defined in the above Chemical Formulae 1 to 8,

Ar₁′ is an aromatic group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH, and

Y″ is O or S.

In the above Chemical Formulae 37 to 50, specific examples of Ar₁, Ar₂, and Q are the same as specific examples of Ar₁, Ar₂, and Q in the above Chemical Formulae 1 to 36.

In addition, in the above Chemical Formulae 37 to 50, an example of Ar₁′ is the same as the example of Ar₂ in the above Chemical Formulae 1 to 36.

In the above Chemical Formulae 37 to 50, the Ar₁ may be a functional group represented by one of the above Chemical Formulae A1 to A8, the Ar₁′ may be a functional group represented by one of the following Chemical Formulae C1 to C8, the Ar₂ may be a functional group represented by one of the above Chemical Formulae B1 to B11, and the Q may be C(CF3)₂ but is not limited thereto.

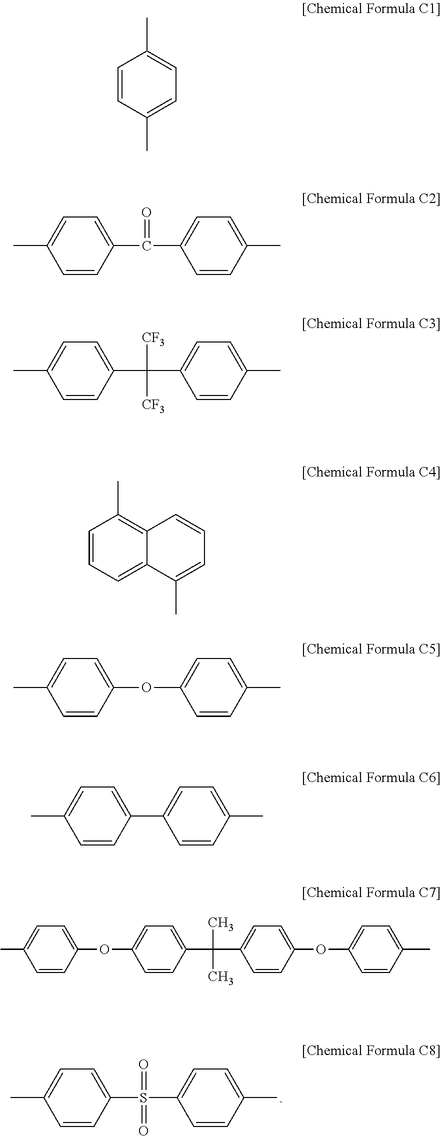

The separator for a rechargeable lithium battery has a contraction rate of less than about 10% after the heat treatment, and thus has excellent heat resistance and dimensional stability. Accordingly, the separator for a rechargeable lithium battery may be variously applied to a rechargeable lithium battery and the like requiring high temperature stability.

The porous support included in the separator for a rechargeable lithium battery may include a micropore, and a picopore present in a polymer derived from the polyamic acid or a picopore present in a polymer derived from the polyimide. The micropore or the micropore and the picopore may enlarge the specific surface area of the separator for a rechargeable lithium battery and may be filled with a non-aqueous electrolyte, and thus may improve wettability of the separator for a non-aqueous electrolyte. Since the non-aqueous electrolyte may, for example, play a role of transporting lithium ions, and the separator having the micropore and the picopore filled with the non-aqueous electrolyte may have excellent ion conductivity.

The micropore may have a diameter of about 0.01 μm to about 50 μm, and the picopore may have a diameter of about 100 pm to about 1000 pm. When the micropore and the picopore in the separator for a rechargeable lithium battery have a diameter within the range, the separator for a rechargeable lithium battery may have improved ion conductivity and thus effectively improve efficiency of the rechargeable lithium battery. Specifically, the micropore may have a diameter ranging from about 0.01 μm to about 10 μm, and the picopore may have a diameter ranging from about 100 pm to about 800 pm.

At least two picopores may be connected to each other to form an hourglass-shaped structure. Accordingly, the polymer has increased porosity and thus may efficiently transmit or selectively separate low molecules.

The picopore may have a full width at half maximum (FWHM) ranging from about 10 pm to about 40 pm measured by positron annihilation lifetime spectroscopy (PALS). The picopore may be very uniformly formed. The PALS data may be obtained using time differences τ₁, τ₂, τ₃, and the like between γ₀ of 1.27 MeV generated by radiating positrons from a ²²Na isotope and γ₁ and γ₂ of 0.511 MeV generated during extinction of the positrons.

The porous support may be formed through electrospinning. The electrospinning method and its process conditions may be regulated to randomly arrange a fiber including the polymer including a picopore therein.

On the other hand, the electrospinning method and its process conditions for forming the porous support may be regulated to unidirectionally arrange a fiber including the fiber having a picopore in the porous support. Herein, strength in a direction of arranging the fiber may be effectively improved.

The separator for a rechargeable lithium battery overall uniformly includes a micropore and a picopore, and may have porosity of about 10 volume % to about 95 volume % based on its total volume. When the separator for a rechargeable lithium battery has porosity within the range, the separator may have a larger contact surface area with a non-aqueous electrolyte and improved wettability for the non-aqueous electrolyte and improved ion conductivity, effectively improving efficiency of a rechargeable lithium battery. Specifically, the separator for a rechargeable lithium battery may have porosity ranging from about 60 volume % to about 95 volume % based on its total volume.

The separator for a rechargeable lithium battery may have a thickness of about 10 μm to about 200 μm, and specifically about 10 μm to about 120 μm. When the separator for a rechargeable lithium battery has a thickness within the range, mechanical properties, heat resistance, chemical resistance, and dimensional stability of the separator may be improved. However, the thickness of the separator for a rechargeable lithium battery is not limited thereto and may be regulated by desired performance of a battery.

The separator for a rechargeable lithium battery includes a polymer derived from the polyamic acid or from the polyimide, and may have excellent heat resistance.

The separator for a rechargeable lithium battery has a thermal decomposition temperature of greater than or equal to about 350° C., specifically, from about 350° C. to about 1,000° C. Herein, the thermal decomposition temperature indicates a temperature at which the separator is decomposed. When the separator for a rechargeable lithium battery has a thermal decomposition temperature within the range, heat resistance of the separator may be effectively improved. Accordingly, a rechargeable lithium battery including the separator for a rechargeable lithium battery may be variously applied to a mobile phone, a laptop, an automobile, and the like. Specifically, the separator for a rechargeable lithium battery may have a thermal decomposition temperature ranging from about 400° C. to about 600° C.

The separator for a rechargeable lithium battery may further include inorganic particles.

The inorganic particles may have an empty space among themselves, that is, micropores. In addition, the inorganic particles may play a role of a kind of a spacer for maintaining a physical shape. Furthermore, the inorganic particles have no mechanical characteristic change at a high temperature, and specifically at a temperature of greater than or equal to about 350° C., and thus may improve heat resistance of the separator for a rechargeable lithium battery.

The inorganic particles have no particular limit if electrochemically stable. In other words, the inorganic particles have no oxidation and/or reduction reaction in an operation voltage range, for example, in a range of about 0 V to about 5 V referring to Li/Li⁺ without particular limitation.

When the inorganic particles have ion transport capability, and specifically, high ion conductivity, the inorganic particles may increase ion conductivity in a rechargeable lithium battery and improve battery performance. When the inorganic particles have high density, the inorganic particles may increase weight of a rechargeable lithium battery and make dispersion difficult during the electrospinning or coating. Accordingly, the inorganic particles should have low density. In addition, when the inorganic particles have high permittivity, an electrolytic salt, for example, a lithium salt, in a liquid electrolyte may be more dissociated and improve ion conductivity of the electrolyte.

With all the considerations, the inorganic particles may have a dielectric constant of greater than or equal to 3, specifically, greater than or equal to 5, and more specifically, greater than or equal to 10 and ion transport capability, or include a combination thereof.

Specifically, the inorganic particle having a dielectric constant of 3 or more may include BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof, but is not limited thereto.

The inorganic particles include lithium having lithium ion transport capability, and may be able to transport lithium ions rather than store them unless explained otherwise. The inorganic particles having lithium ion transport capability transport and move the lithium ions due to a kind of a defect inside the particle structure, and may improve lithium ion conductivity inside a battery. Accordingly, performance of the rechargeable lithium battery including the inorganic particles may be improved.

Specifically, the inorganic particle having lithium ion transport capability may include lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ based glass (LiₓSi_{y}S_{z}, 0<x<3, 0<y<2, 0<z<4), P₂₅₅ based glass (LiₓP_{y}S_{z}, 0<x<3, 0<y<3, 0<z<7), Li₂O, LiF, LiOH, Li₂CO₃, LiAlO₂, or a combination thereof, but is not limited thereto.

Among the inorganic particles, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), and HfO₂ have a dielectric constant of greater than or equal to about 100, and thus have a high permittivity characteristic. In addition, when these inorganic particles are elongated or compressed due to a predetermined pressure, charges are generated and piezoelectricity of having a potential difference on both sides is caused, which may prevent an internal short circuit inside a positive electrode due to an external impact and improves stability of a rechargeable lithium battery.

The inorganic particles may be controlled regarding size, the amount, and the composition with a polymer by regulating pores and its structure included in the separator for a rechargeable lithium battery. The pores are filled with a liquid electrolyte injected later, which may remarkably decrease interface resistance among the inorganic particles.

The inorganic particles may have a diameter of about 0.001 μm to about 10 μm. When the inorganic particles have an average particle diameter within the range, the composition may be better dispersed in a solvent and uniformly electrospun or coated. In addition, pore size and porosity of the separator for a rechargeable lithium battery may be appropriately maintained, which may effectively prevent a rechargeable lithium battery from having an internal short circuit during the charge and discharge. Specifically, the inorganic particles may have an average particle diameter of about 0.001 μm to about 1 μm.

The inorganic particles may be included in an amount of about 0.1 parts by weight to about 50 parts by weight based on 100 parts by weight of a polymer derived from the polyamic acid or a polymer derived from the polyimide. When the inorganic particles are included within the range, pore size and porosity of the separator for a rechargeable lithium battery may be appropriately maintained, which may effectively prevent a rechargeable lithium battery from having an internal short circuit during charge and discharge. In addition, mechanical strength, heat resistance, and dimensional stability of the separator for a rechargeable lithium battery may be effectively improved. Specifically, the inorganic particle may be included in an amount of about 0.1 parts by weight to about 10 parts by weight based on 100 parts by weight of a polymer derived from the polyamic acid or a polymer derived from the polyimide.

According to another embodiment, provided is a composition for forming a separator for a rechargeable lithium battery that includes polyamic acid or polyimide including a repeating unit prepared from an aromatic diamine including at least one ortho-positioned functional group relative to an amine group and dianhydride, and an organic solvent.

The organic solvent may be selected from the group consisting of dimethylsulfoxide, N-methyl-2-pyrrolidone, N-methylpyrrolidone, N,N-dimethyl formamide, N,N-dimethyl acetamide, a ketone selected from the group consisting of γ-butyrolactone, cyclohexanone, 3-hexanone, 3-heptanone, and 3-octanone, and a combination thereof, but is not limited thereto. The organic solvent may easily dissolve a polymer such as the polyimide. In addition, the organic solvent is well mixed with a previously-described auxiliary agent, preparing a meta-stable composition for forming the separator for a rechargeable lithium battery and easily forming the separator for a rechargeable lithium battery.

In the composition for forming a separator for a rechargeable lithium battery, the polyamic acid and the polyimide may have a weight average molecular weight (Mw) of about 10,000 g/mol to about 500,000 g/mol, respectively. When the polyamic acid and the polyimide have a weight average molecular weight within the range, the composition may be easily synthesized and appropriately maintain viscosity, and thus accomplish excellent workability. In addition, the polymer derived from polyamic acid or from polyimide may maintain excellent mechanical strength, heat resistance, and dimensional stability.

The composition for forming a separator for a rechargeable lithium battery may include about 1 wt % to about 40 wt % of the polyamic acid or the polyimide and about 60 wt % to about 99 wt % of the organic solvent based on the total amount of the composition for forming a separator for a rechargeable lithium battery. When the composition for forming the separator for a rechargeable lithium battery includes each component within the range, the composition for forming the separator for a rechargeable lithium battery may appropriately maintain viscosity and appropriately control a pore size inside and on the surface of the separator for a rechargeable lithium battery, easily fabricating the separator for rechargeable lithium battery. In addition, the composition may excellently maintain strength of the separator for a rechargeable lithium battery and easily fabricate the separator for a rechargeable lithium battery having excellent mechanical strength and dimensional stability.

The composition for forming a separator for a rechargeable lithium battery may further include an auxiliary agent selected from the group consisting of water; an alcohol selected from the group consisting of methanol, ethanol, 2-methyl-1-butanol, 2-methyl-2-butanol, glycerol, ethylene glycol, diethylene glycol, and propylene glycol; a ketone selected from the group consisting of acetone and methylethyl ketone; a polymer compound selected from the group consisting of polyvinyl alcohol, polyacrylic acid, polyacrylamide, polyethylene glycol, polypropylene glycol, chitosan, chitin, dextran, and polyvinylpyrrolidone; tetrahydrofuran; trichloroethane; and a combination thereof.

The auxiliary agent has no excellent solubility with the polyamic acid polymer or the polyimide polymer, and thus may not be used alone. However, the auxiliary agent is appropriately mixed with the organic solvent and prepared into a meta-stable composition for forming the separator for a rechargeable lithium battery. The composition for forming the separator for a rechargeable lithium battery is electrospun and effectively formed into a non-woven fabric having an appropriate pore diameter, pore distribution, and porosity.

The auxiliary agent may be removed through diffusion, evaporation, and the like during formation of the separator for a rechargeable lithium battery and form a micropore inside the separator for a rechargeable lithium battery, and thus increase porosity of the separator for a rechargeable lithium battery. Specifically, the polymer compound may be used as a pore controlling agent. In addition, the auxiliary agent may be used to control a phase separation temperature or viscosity of the composition for forming the separator for a rechargeable lithium battery.

The composition for forming a separator for a rechargeable lithium battery may include about 1 wt % to about 40 wt % of the polyamic acid or the polyimide, about 10 wt % to about 95 wt % of the organic solvent, and about 4 wt % to about 70 wt % of the auxiliary agent based on the total amount of the composition for forming a separator for a rechargeable lithium battery including the auxiliary agent. When the composition for forming a separator for a rechargeable lithium battery includes each component within the range, the composition for forming the separator for a rechargeable lithium battery may appropriately maintain viscosity and be easily fabricated into the separator for a rechargeable lithium battery, and thus appropriately control a pore size inside and on the surface of the separator for a rechargeable lithium battery. In addition, the composition maintains excellent strength of the separator, and thus accomplishes excellent mechanical strength and dimensional stability of the separator for a rechargeable lithium battery and may be easily fabricated into a rechargeable lithium battery including the separator.

The composition for forming the separator for a rechargeable lithium battery may further include inorganic particles. Hereinafter, the inorganic particles may be the same as aforementioned unless other illustrations are given.

The composition for forming a separator for a rechargeable lithium battery may include about 1 wt % to about 40 wt % of the polyamic acid or the polyimide, about 10 wt % to about 95 wt % of the organic solvent, and about 0.1 wt % to about 50 wt % of the inorganic particles based on the total amount of the composition for forming a separator for a rechargeable lithium battery including the inorganic particles. When the composition for forming the separator for a rechargeable lithium battery includes each component within the range, the inorganic particles therein may be well dispersed. Accordingly, the inorganic particles may be uniformly dispersed in the separator for a rechargeable lithium battery, and pores inside and on the surface of the separator for a rechargeable lithium battery may have an appropriate size. Accordingly, the separator for a rechargeable lithium battery may maintain excellent strength and thus may be easily formed into a rechargeable lithium battery having excellent mechanical strength and dimensional stability.

The composition for forming the separator for a rechargeable lithium battery may further include a conventional additive that is well-known in a related art other than the auxiliary agent and the inorganic particles.

The composition for forming a separator for a rechargeable lithium battery may have viscosity of about 0.01 Pa·s to about 100 Pa·s. When the composition for forming the separator for a rechargeable lithium battery has viscosity within the range, the composition for forming the separator for a rechargeable lithium battery may be easily electrospun and then solidified through a phase transition phenomenon.

In the composition for forming the separator for a rechargeable lithium battery, the polyamic acid may be selected from the group consisting of the polyamic acid including the repeating unit represented by the above Chemical Formulae 1 to 4, the polyamic acid copolymer including the repeating unit represented by the above Chemical Formulae 5 to 8, a copolymer thereof, and a blend thereof, and the polyimide may be selected from the polyimide including the repeating unit represented by the above Chemical Formulae 19 to 22, the polyimide copolymer including the repeating unit represented by the above Chemical Formulae 23 to 26, a copolymer thereof, and a blend thereof, but the present invention is not limited thereto.

According to another embodiment, provided is a method of manufacturing a separator for a rechargeable lithium battery that includes electrospinning the composition for forming a separator for a rechargeable lithium battery to form a non-woven fabric, and heat-treating the non-woven fabric to form a porous support including a polymer derived from polyamic acid or a polymer derived from polyimide.

The composition for forming the separator for a rechargeable lithium battery may be electrospun to form a non-woven fabric including a fiber with a diameter of several nanometers to tens of micrometers.

The non-woven fabric has excellent flexibility and thus may improve workability when used to fabricate a rechargeable lithium battery. In addition, the non-woven fabric may improve porosity and heat resistance of the separator for a rechargeable lithium battery.

Furthermore, the non-woven fabric including a fiber may have a large specific surface area and considerable surface roughness. Herein, the non-woven fabric may include micropores.

The non-woven fabric may be formed by regulating the electrospinning method and its process conditions to randomly arrange fibers including the composition for forming the separator for a rechargeable lithium battery.

On the other hand, the non-woven fabric may be formed by regulating the electrospinning method and its process condition to unidirectionally arrange fibers including the composition for forming the separator for a rechargeable lithium battery. The non-woven fabric has the aforementioned advantages.

The electrospinning may be performed by applying a high voltage of about 1 kV to about 1000 kV. The electrospinning may be performed in a conventional method, and will not be illustrated in detail.

Then, the non-woven fabric may be heat-treated. The heat-treatment may thermally rearrange polyamic acid or polyimide included in the non-woven fabric into a polymer having excellent mechanical strength, heat resistance, and dimensional stability and a high fractional free volume, for example, polybenzoxazole, polybenzothiazole, and polypyrrolone. In addition, the thermally rearranged polymer may have picopores. Accordingly, the polymer may form a separator for a rechargeable lithium battery having excellent mechanical strength, heat resistance, dimensional stability, and the like.

Specifically, the polymer may have a thermal rearrangement rate of repeating units of about 10 mol % to about 100 mol %, and specifically about 40 mol % to about 100 mol % based on the total amount of a repeating unit in the polyamic acid or polyimide. When the thermal rearrangement rate is within the range, the polymer may have the aforementioned advantages.

The heat-treating may be performed at a temperature of about 250° C. to about 550° C. for about 10 minutes to about 5 hours, and the heat-treating may be performed at a temperature increase rate of about 1° C./min to about 20° C./min. When the heat-treatment is performed under the condition, the polyamic acid and the polyimide may be effectively thermally rearranged. In other words, the heat-treatment may apply excellent mechanical properties, heat resistance, and a high fractional free volume to the polyamic acid and the polyimide and thermally rearrange the polyamic acid and the polyimide into a polymer having picopores such as polybenzoxazole, polybenzothiazole, and polypyrrolone, fabricating a separator for a rechargeable lithium battery having excellent mechanical properties, dimensional stability, chemical resistance, and heat resistance. Specifically, the heat-treatment may be performed at a temperature ranging from about 350° C. to about 450° C. for about 1 hour to about 3 hours at a temperature increase rate of about 5° C./min to about 10° C./min.

The method of manufacturing the separator for a rechargeable lithium battery may further include forming an inorganic particle coating layer inside, on the surface, or both thereof of the porous support, after forming the porous support.

The method of forming the inorganic particle coating layer on the surface of the porous support may be performed in a conventional method, for example, chemical vapor deposition (CVD), atomic layer deposition (ALD), sputtering, nanoparticle coating, or a combination thereof, but is not limited thereto. Hereinafter, the inorganic particles may be the same as aforementioned unless specifically mentioned.

The method of manufacturing the separator for a rechargeable lithium battery may further include coating a coating layer including inorganic particles and a binder polymer inside, on the surface, or both thereof of the porous support, after forming the porous support.

The method of coating the mixture of the inorganic particle and the binder polymer inside, on the surface, or inside and on the surface of the porous support may be performed in a conventional method, for example, dip coating, die coating, roll coating, comma coating, or a combination thereof, but is not limited thereto. Hereinafter, the inorganic particles are the same as aforementioned unless otherwise mentioned.

The binder polymer may stably fix the inorganic particles and improve their structural safety. In addition, the binder polymer improves ion conductivity and increases wettability of an electrolyte, and thus may not be dissolved in the electrolyte but becomes a gel due to swelling of the electrolyte.

The binder polymer may include polyvinylidene fluoride-hexafluoropropylene, polyvinylidene fluoride-trichloroethylene, polymethylmethacrylate, polyacrylonitrile, polyvinylpyrrolidone, polyvinylacetate, polyethylene-vinyl acetate, polyethylene oxide, cellulose acetate, cellulose acetate butyrate, cellulose acetate propinonate, cyanoethyl pullulan, cyanoethyl polyvinyl alcohol, cyanoethyl cellulose, cyanoethyl sucrose, pullulan, carboxyl methyl cellulose, an acrylonitrile-styrenebutadiene copolymer, polyimide, or a combination thereof, but is not limited thereto.

According to another embodiment, provided is a rechargeable lithium battery that includes a positive electrode including a positive active material, a negative electrode including a negative active material, the separator for a rechargeable lithium battery, and a non-aqueous electrolyte.

The rechargeable lithium battery may be classified into a lithium ion battery, a lithium ion polymer battery, and a lithium polymer battery according to the presence of a separator and the kind of electrolyte used in the battery, may also be classified into a cylindrical, prismatic, coin-type, and pouch battery according to its shape, and further classified into a bulk type and thin film type according to its size. Structures and fabrication methods of lithium ion batteries are well known in the art.

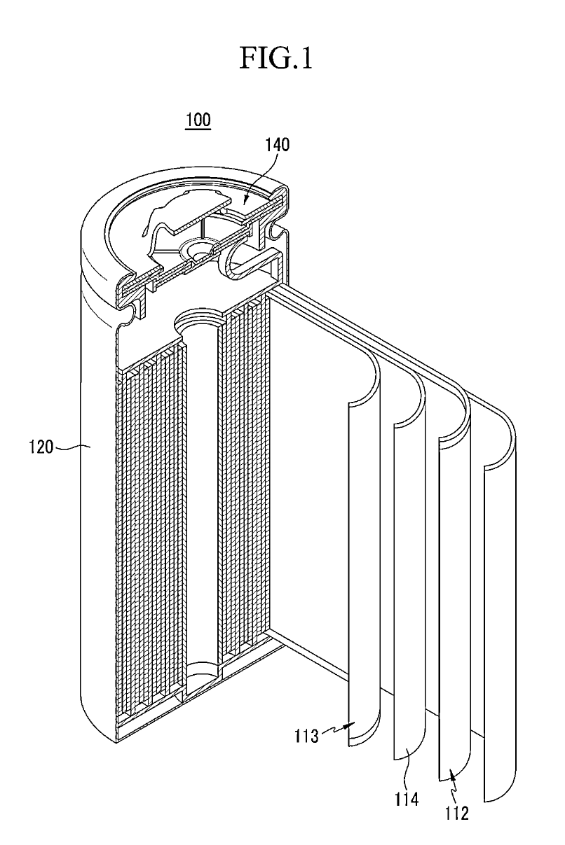

FIG. 1 shows schematic structure of a rechargeable lithium battery according to one embodiment.

Referring to FIG. 1, the rechargeable lithium battery 100 includes a positive electrode 112, a negative electrode 113, and a separator 114 disposed between the negative electrode 112 and negative electrode 113, an electrolyte (not shown) impregnating the negative electrode 112, positive electrode 114, and separator 113, a battery case 120, and a sealing member 140 sealing the battery case 120. The rechargeable lithium battery 100 is fabricated by sequentially stacking a negative electrode 112, a positive electrode 114, and a separator 113, and spiral-winding them and housing the wound product in the battery case 120.

The positive electrode includes a current collector and a positive active material layer disposed on the current collector, and the positive active material layer includes a positive active material.

The current collector may be aluminum (Al), but is not limited thereto.

The positive active material includes lithiated intercalation compounds that reversibly intercalate and deintercalate lithium ions. The positive active material may include a composite oxide including at least one selected from cobalt, manganese, and nickel, as well as lithium, but is not limited thereto.

The positive active material layer includes a binder and a conductive material.

The binder improves binding properties of the positive active material particles to each other and to a current collector. Specifically, the binder may be polyvinyl alcohol, carboxymethyl cellulose, hydroxypropyl cellulose, diacetyl cellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material is used in order to provide an electrode with conductivity. Any electrically conductive material may be used as a conductive material unless it causes a chemical change. Specifically, the conductive material may be natural graphite, artificial graphite, carbon black, acetylene black, ketjen black, a carbon fiber, a metal powder and metal fiber of copper, nickel, aluminum, silver, and the like, but is not limited thereto.

The negative electrode includes a current collector and a negative active material layer formed on the current collector. The negative active material layer includes a negative active material.

The current collector may include a copper foil, a nickel foil, a stainless steel foil, a titanium foil, a nickel foam, a copper foam, a polymer substrate coated with a conductive metal, and a combination thereof, but is not limited thereto.

The negative active material may include a material that reversibly intercalates/deintercalates lithium ions, lithium metal, a lithium metal alloy, a material being capable of doping/dedoping lithium, a transition metal oxide, or a combination thereof.

The material that reversibly intercalates/deintercalates lithium ions may be a carbon material. The carbon material may be any generally-used carbon-based negative active material in a lithium ion rechargeable battery. Specifically, crystalline carbon, amorphous carbon, or mixtures thereof may be used. The crystalline carbon may be non-shaped, or sheet, flake, spherical, or fiber shaped natural graphite or artificial graphite, and the amorphous carbon may be soft carbon (low temperature fired carbon) or hard carbon, a mesophase pitch carbonized product, a mesocarbon microbead (MCMB), fired coke, and the like.

The lithium metal alloy may include lithium (Li) and a metal selected from Na, K, Rb, Cs, Fr, Be, Mg, Ca, Sr, Si, Sb, Pb, In, Zn, Ba, Ra, Ge, Al, and Sn.

The material being capable of doping/dedoping lithium may include Si, SiOₓ (0<x<2), a Si—Y alloy (wherein Y is an element selected from the group consisting of an alkali metal, an alkaline-earth metal, a Group 13 element, a Group 14 element, a transition element, a rare earth element, and a combination thereof, but not Si), Sn, SnO₂, Sn—Y (wherein Y is an element selected from the group consisting of an alkali metal, an alkaline-earth metal, a Group 13 element, a Group 14 element, a transition element, a rare earth element, and a combination thereof, but not Sn), and the like, and at least one of the foregoing materials may be mixed with SiO₂. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition metal oxide may include vanadium oxide, lithium vanadium oxide, and the like.

The negative active material layer includes a binder, and optionally a conductive material.

The binder improves binding properties of negative active material particles with one another and with a current collector. Specifically, the binder may include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material is included to improve electrode conductivity. Any electrically conductive material may be used as a conductive material unless it causes a chemical change. Specifically, the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as polyphenylene derivatives; or a mixture thereof, but is not limited thereto.

The negative electrode and positive electrode may be fabricated in a method of mixing the active material, a conductive material, and a binder to prepare an active material composition, and coating the composition on a current collector, respectively. The electrode fabrication method is well known and thus is not described in detail in the present specification. The solvent includes N-methylpyrrolidone and the like, but is not limited thereto.

The non-aqueous electrolyte includes a non-aqueous organic solvent and a lithium salt.

The non-aqueous organic solvent serves as a medium for transmitting ions taking part in the electrochemical reaction of a battery. Specifically, the non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone and the like. The alcohol-based solvent include ethyl alcohol, isopropyl alcohol, or the like, and the aprotic solvent may include nitriles such as R—CN (wherein R is a C2 to C20 linear, branched, or cyclic hydrocarbon, and may include one or more double bonds, one or more aromatic rings, or one or more ether bonds), amides such as dimethylformamide and dimethylacetamide, dioxolanes such as 1,3-dioxolane, sulfolanes, and the like.

The non-aqueous organic solvent may be used singularly or in a mixture. When the organic solvent is used in a mixture, its mixture ratio can be controlled in accordance with desirable performance of a battery.

The lithium salt is dissolved in the non-aqueous solvent and supplies lithium ions in a rechargeable lithium battery, and basically operates the rechargeable lithium battery and improves lithium ion transfer between positive and negative electrodes. Specifically, the lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄) LiN(CₓF₂ₓ₊₁SO₂)(C_{y}F_{2y+1}SO₂) (wherein x and y are natural numbers), LiCl, LiI, and LiB(C₂O₄)₂ (lithium bis(oxalato) borate, LiBOB), and a combination thereof. The lithium salt may be used in a concentration of about 0.1 to about 2.0 M. When the lithium salt is included within the above concentration range, it may improve electrolyte performance and lithium ion mobility due to optimal electrolyte conductivity and viscosity.

The following examples illustrate the present invention in more detail. These examples, however, should not in any sense be interpreted as limiting the scope of the present invention.

### Example 1

### Fabrication of Separator for Rechargeable Lithium Battery Cell

A separator for a rechargeable lithium battery cell was fabricated to include a polymer including polybenzoxazole including a repeating unit represented by the following Chemical Formula 51 from polyhydroxyimide as shown in the following Reaction Scheme 1.

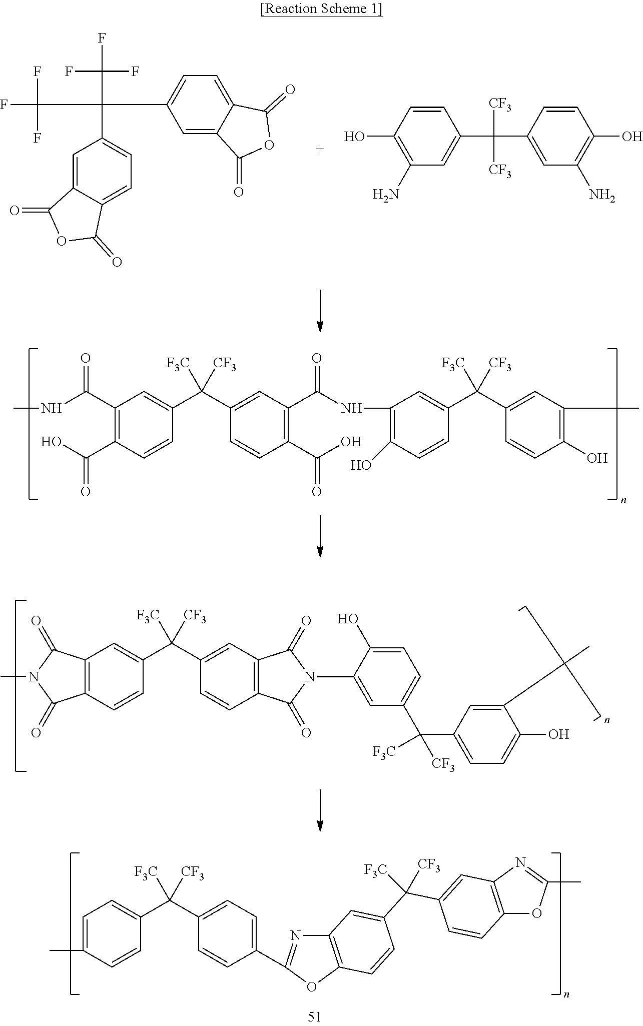

(1) Preparation of Polyhydroxyimide

3.66 g (10 mmol) of 2,2-bis(3-amino-4-hydroxyphenyl)hexafluoropropane and 4.44 g (10 mmol) of 4,4′-(hexafluoroisopropylidene)diphthalic anhydride were added to 32.4 g of N-methylpyrrolidone (NMP), and the mixture was fervently agitated for 4 hours. Next, 32 ml of xylene as an azeotropic mixture was added to the agitated mixture, and the resulting mixture was solution-thermally imidized at 180° C. for 12 hours to remove water and the xylene therein, preparing polyhydroxyimide.

(2) Fabrication of Separator for Rechargeable Lithium Battery Cell

A composition for forming a separator for a rechargeable lithium battery cell was prepared to include 25 wt % of the polyhydroxyimide by adding dimethyl formamide (DMF) to a solution including the polyhydroxyimide.

The composition for forming a separator for a rechargeable lithium battery was electrospun to fabricate a non-woven fabric including a fiber under a condition such as a spinning gap of 15 cm, a flow rate of 0.1 μl/min, and a drum speed of 50 rpm by using drum type electrospinning equipment ESR200RD (NanoNC Inc.) to apply electricity of −4 kV to a cylinder part and electricity of +10 kV to a drum part.

Then, the non-woven fabric was heat-treated at 300° C. for 1 hour and at 450° C. for 1 hour again but then slowly cooled down to room temperature, fabricating a separator for a rechargeable lithium battery including a porous support including polybenzoxazole. The heat-treatment was performed at an increasing rate of 5° C./min.

The separator for a rechargeable lithium battery cell was measured regarding porosity using capillary flow porometer equipment CFP-1500-AE (Porous Materials Inc.). The result was 90 volume %. In addition, the separator for a rechargeable lithium battery was 60 μm thick. The separator has a thermal rearrangement rate of 95 mol %.

As a result of FT-IR analysis, the separator turned out to have [symbol] polybenzoxazole characteristic bands of 1553 cm⁻¹, 1480 cm⁻¹ (C═N), and 1058 cm⁻¹ (C—O), which were not found in the polyhydroxyimide. In addition, the prepared polymer had a fractional free volume of 0.217 and interplanar spacing of 578 pm.

The density of the polymer is related to the fractional free volume.

First of all, the density of a film was measured in a buoyancy method using a Sartorius LA 310S analytical balance according to the following Equation 1.

$${ρ}_{P} = \frac{{w}_{o}}{{w}_{o} - {w}_{w}} \times {ρ}_{w} \qquad [ Equation 1 ]$$

In Equation 1,

ρₚ is density of the polymer,

ρ_{w} is density of deionized water,

ωₐ is weight of the polymer measured in the air, and

ω_{w} is weight of the polymer measured in the deionized water.

The fractional free volume (FFV, V_{f}) was calculated from the data according to the following Equation 2.

$$F F V = \frac{V - 1.3 {V}_{w}}{V} \qquad [ Equation 2 ]$$

In Equation 2,

V is specific volume of the polymer and

V_{w} is a specific Van der Waals volume.

The interplanar spacing was calculated from an X-ray diffraction pattern result according to Bragg's equation.

In addition, the separator for a rechargeable lithium battery including polybenzoxazole has a full width at half maximum (FWHM) of 26.9 pm as a result of positron annihilation lifetime spectroscopy (PALS).

The PALS was performed using an automated EG&G Ortec fast-fast coincidence spectrometer about nitrogen at an air temperature. The system has temporal resolution of 240 ps.

The polymer was formed into a 1 mm-thick layer on both sides of a ²²Na—Ti foil source. Sources of the Ti foil having a thickness of 2.5 μm were not calibrated. Each spectrum includes about 10,000,000 integrated counts and was formed of the sum of three decaying exponentials or a continuous distribution. The PALS data may be obtained by using time differences τ₁, τ₂, τ₃, and the like between γ₀ of 1.27 MeV generated by radiating positrons generated from a ²²Na isotope and γ₁ and γ₂ of 0.511 MeV generated when the positrons are extinct.

The size of a pore is calculated according to the following Equation 3 using extinction time of two γ signals of 0.511 MeV.

$${τ}_{o \text{-} Ps} = {\frac{1}{2} [ 1 - \frac{R}{R + Δ R} + \frac{1}{2 π} sin ( \frac{2 π R}{R + Δ R} ) ]}^{- 1} \qquad [ Equation 3 ]$$

In Equation 3,

τ_{o-Ps} is extinction time of positrons,

R is a pore size, and

ΔR is an empirical parameter provided that the pore has a spherical shape.

### Example 2

### Fabrication of Separator for Rechargeable Lithium Battery Cell

A separator for a rechargeable lithium battery cell including polybenzoxazole including a repeating unit represented by the above Chemical Formula 51 was fabricated according to the same method as Example 1, except for heat-treating a non-woven fabric at 450° C. for 3 hours.

The separator for a rechargeable lithium battery cell had porosity of 89 volume %. In addition, the separator for a rechargeable lithium battery had a thickness of 105 μm. Furthermore, the separator had a thermal rearrangement rate of 100 mol %.

As a result of FT-IR analysis, the separator had polybenzoxazole characteristic bands of 1553 cm⁻¹, 1480 cm⁻¹ (C═N), and 1058 cm⁻¹ (C—O), which were not found in polyhydroxyimide. In addition, the prepared polymer had a fractional free volume of 0.218 and interplanar spacing of 578.7 pm.

Furthermore, the separator had a full width at half maximum (FWHM) of 27.1 pm measured by using positron annihilation lifetime spectroscopy (PALS).

### Example 3

### Fabrication of Separator for Rechargeable Lithium Battery Cell

A separator for a rechargeable lithium battery cell including polybenzoxazole including a repeating unit represented by the above Chemical Formula 51 was fabricated according to the same method as Example 1, except for heat-treating a non-woven fabric at 400° C. for 3 hours.

The separator for a rechargeable lithium battery cell had porosity of 85 volume %, a thickness of 30 μm, and a thermal rearrangement rate of 69 mol %.

As a result of FT-IR analysis, the separator had polybenzoxazole characteristic bands of 1553 cm⁻¹, 1480 cm⁻¹ (C═N), and 1058 cm⁻¹ (C—O), which were not found in polyhydroxyimide. In addition, the prepared polymer had a fractional free volume of 0.204 and interplanar spacing of 567.6 pm.

Furthermore, the separator had a full width at half maximum (FWHM) of 21.1 pm measured using positron annihilation lifetime spectroscopy (PALS).

### Example 4

### Fabrication of Separator for Rechargeable Lithium Battery Cell

A separator for a rechargeable lithium battery cell including polybenzoxazole including a repeating unit represented by the above Chemical Formula 51 was fabricated according to the same method as Example 1, except for heat-treating a non-woven fabric at 425° C. for 1 hour.

The separator for a rechargeable lithium battery cell had porosity of 85 volume %, a thickness of 30 μm, and a thermal rearrangement rate of 80 mol %.

As a result of FT-IR analysis, the separator had polybenzoxazole characteristic bands of 1553 cm⁻¹, 1480 cm⁻¹ (C═N), and 1058 cm⁻¹ (C—O) which were not found in polyhydroxyimide. In addition, the prepared polymer had a fractional free volume of 0.210 and interplanar spacing of 572 pm.

Furthermore, the separator had a full width at half maximum (FWHM) of 23.6 pm measured by using positron annihilation lifetime spectroscopy (PALS).

### Example 5

### Fabrication of Separator for Rechargeable Lithium Battery Cell

A separator for a rechargeable lithium battery including polybenzoxazole including a repeating unit represented by the above Chemical Formula 51 was fabricated according to the same method as Example 1, except for heat-treating a non-woven fabric at 425° C. for 2 hours.

The separator for a rechargeable lithium battery had porosity of 85 volume %, a thickness of 30 μm, and a thermal rearrangement rate of 88 mol %.

As a result of FT-IR analysis, the separator had polybenzoxazole characteristic bands of 1553 cm⁻¹, 1480 cm⁻¹ (C═N), and 1058 cm⁻¹ (C—O) which were not found in polyhydroxyimide. In addition, the prepared polymer had a fractional free volume of 0.214 and interplanar spacing of 575.2 pm.

Furthermore, the separator had a full width at half maximum (FWHM) of 25.3 pm measured by using positron annihilation lifetime spectroscopy (PALS).

### Example 6

### Fabrication of Separator for Rechargeable Lithium Battery Cell

A separator for a rechargeable lithium battery cell including polybenzoxazole including a repeating unit represented by the above Chemical Formula 51 was fabricated according to the same method as Example 1, except for heat-treating a non-woven fabric at 425° C. for 3 hours.

The separator for a rechargeable lithium battery had porosity of 85 volume %, a thickness of 30 μm, and a thermal rearrangement rate of 91 mol %.

As a result of FT-IR analysis, the separator had polybenzoxazole characteristic bands of 1553 cm⁻¹, 1480 cm⁻¹ (C═N), and 1058 cm⁻¹ (C—O) which were not found in polyhydroxyimide. In addition, the prepared polymer had a fractional fee volume of 0.215 and interplanar spacing of 576.4 pm.

Furthermore, the separator had a full width at half maximum (FWHM) of 26.2 pm measured by positron annihilation lifetime spectroscopy (PALS).

### Example 7

### Fabrication of Separator for Rechargeable Lithium Battery Cell

A polymer solution including 25 wt % of the polyhydroxyimide was prepared by adding dimethyl formamide (DMF) to the polyhydroxyimide solution according to Example 1. Next, 1 part by weight of Aerosil 200 (Degussa Co.) as silica and 3 parts by weight of Pluronic L64 (BASF Co.) as a surfactant helping effective dispersion of the silica were added to the polymer solution based on 100 parts by weight of the polyhydroxyimide. The mixture was fervently agitated at room temperature for 24 hours. In this way, a composition for forming a separator for a rechargeable lithium battery was prepared.

Then, the composition for forming a separator for a rechargeable lithium battery was used to fabricate a separator for a rechargeable lithium battery cell according to the same method as Example 4.

The separator for a rechargeable lithium battery had porosity of 85 volume %, a thickness of 30 μm, and a thermal rearrangement rate of 80 mol %.

### Example 8

### Fabrication of Half Cell

A negative active material slurry was prepared by mixing mesocarbon microbeads (MCMB), super P carbon black, and a poly(vinylidene fluoride) binder in a weight ratio of 80:10:10 in an N-methylpyrrolidone solvent. The negative active material slurry was coated on a 50 μm-thick copper foil, dried in a 150° C. oven for 20 minutes, and roll-pressed, fabricating a negative electrode.

The negative electrode was used with a lithium counter electrode, the separator for a rechargeable lithium battery according to Example 1, and an electrolyte to fabricate a coin-type half cell (a 2016 R-type half cell) in a globe box filled with helium. The electrolyte was prepared by mixing ethylene carbonate and diethyl carbonate in a volume ratio of 50:50 and dissolving 1 M of LiPF₆ therein.

### Examples 9 to 14

### Fabrication of Half Cell

A coin-type half cell (a 2016 R-type half cell) was fabricated according to the same method as Example 8, except for respectively using each separator for a rechargeable lithium battery according to Examples 1 to 7. Each coin-type half cell was sequentially fabricated according to Examples 9 to 14.

### Experimental Example 1

### SEM Photograph

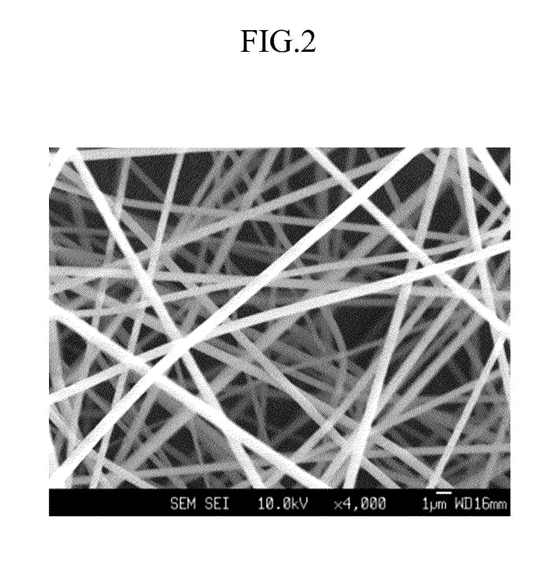

The non-woven fabrics according to Examples 1 to 7 were photographed with a scanning electron microscope (SEM) using JSM-6330F (JEOL Ltd.) equipment. FIG. 2 provides a SEM photograph of the non-woven fabric according to Example 1.

As shown in FIG. 2, the non-woven fabric according to Example 1 was formed as a porous support including micropores.

### Experimental Example 2

### Measurement of Mechanical Strength

The separators for a rechargeable lithium battery according to Examples 1 to 7 were each cut into 10 samples having a width of 5 mm and a length of 40 mm.

The samples were fixed on a holder mounted on UTM (universal test machine) equipment and pulled at a speed of 1 mm/min, obtaining a stress-transformation curve.

Based on the stress-transformation curve, tensile strength and elongation rate of each sample were obtained, and ten tensile strengths and elongation rates of each sample were averaged. The results of Examples 4 and 7 are provided in the following Table 1.

Herein, the UTM equipment was AGS-J500N (Shimadzu Co.).

TABLE 1

| | Tensile strength | Elongation rate |
|---|---|---|
| | (Mpa) | (%) |
| Example 4 | 8.29 | 4.30 |
| Example 7 | 11.67 | 4.51 |

As shown in Table 1, the separators for a rechargeable lithium battery according to Examples 4 and 7 had excellent mechanical strength. In particular, the separator for a rechargeable lithium battery including silica as an inorganic particle according to Example 7 had excellent mechanical strength.

### Experimental Example 3

### Measurement of Initial Charge Capacity, Initial Discharge Capacity, and Initial Coulombic Efficiency

The half cells according to Examples 8 to 14 were charged and discharged once at 3.0 V to 4.1 V and 30° C. with a 0.1 C-rate and measured regarding initial discharge capacity, initial charge capacity, and coulombic efficiency. The results according to Examples 8 and 9 are provided in the following Table 2.

On the other hand, the half cells according to Examples 8 to 14 were charged and discharged once at 3.0 V to 4.2 V and 55° C. with a 0.1 C-rate and measured regarding initial discharge capacity, initial charge capacity, and coulombic efficiency. The results according to Examples 8 and 9 are provided in the following Table 2.

TABLE 2

| | 3.0 V to 4.1 V, 30° C., 0.1 C-rate | | | 3.0 V to 4.2 V, 55° C., 0.1 C-rate | | |
|---|---|---|---|---|---|---|
| | Charge | Discharge | Coulombic | Charge | Discharge | Coulombic |
| | capacity | capacity | efficiency | capacity | capacity | efficiency |
| | (mAh/g) | (mAh/g) | (%) | (mAh/g) | (mAh/g) | (%) |
| Example 8 | 152.1 | 118.9 | 78.2 | 152.6 | 137.5 | 90.1 |
| Example 9 | 150.8 | 123.7 | 82.0 | 153.7 | 142.1 | 92.5 |

As shown in Table 2, the rechargeable lithium battery cells according to Examples 8 and 9 had excellent initial charge capacity and discharge capacity as well as coulombic efficiency.

### Experimental Example 4

### Cycle-Life Characteristic

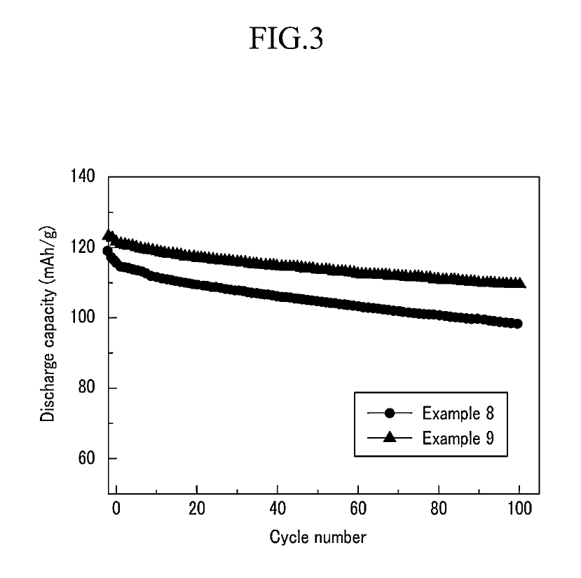

The half cells according to Examples 8 to 14 were charged and discharged 100 times at 3.0 V to 4.1 V and 30° C. with a 0.5 C-rate and measured regarding discharge capacity change. The results according to Examples 8 and 9 are provided in FIG. 3.

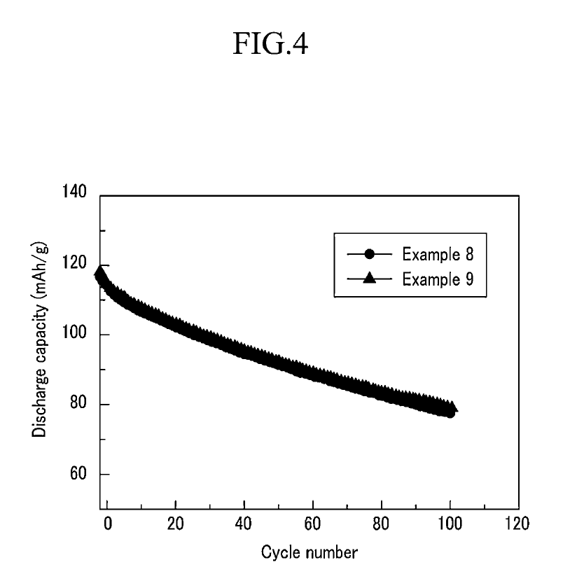

On the other hand, the half cells according to Examples 8 to 14 were charged and discharged 100 times at 3.0 V to 4.2 V and 55° C. with a 0.5 C-rate and measured regarding discharge capacity change. The results according to Examples 8 and 9 are provided in FIG. 4.

The data in FIGS. 3 and 4 are provided in the following Table 3.

TABLE 3

| | 3.0 V to 4.1 V, 30° C., 0.5 C-rate, | | | 3.0 V to 4.2 V, 55° C., 0.5 C-rate, | | |
|---|---|---|---|---|---|---|
| | 100th charge and discharge | | | 100th charge and discharge | | |
| | | 100th | | | 100th | |
| | 1st discharge | discharge | Capacity | 1st discharge | discharge | Capacity |
| | capacity | capacity | retention | capacity | capacity | retention |
| | (mAh/g) | (mAh/g) | (%) | (mAh/g) | (mAh/g) | (%) |
| Example 8 | 114.7 | 98.2 | 85.6 | 114.3 | 77.4 | 67.7 |
| Example 9 | 121.1 | 109.7 | 90.6 | 114.7 | 79.2 | 69.0 |

As shown in Table 3 and FIGS. 3 and 4, the rechargeable lithium battery cells according to Examples 8 and 9 had an excellent cycle-life characteristic.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A separator for a rechargeable lithium battery comprising
a separator for a rechargeable lithium battery including a porous support including a polymer derived from polyamic acid or a polymer derived from polyimide,
wherein the polyamic acid and polyimide may include a repeating unit prepared from aromatic diamine including at least one ortho-positioned functional group relative to an amine group, and dianhydride.

2. The separator for a rechargeable lithium battery of claim 1, wherein the functional group comprises OH, SH, or NH₂.

3. The separator for a rechargeable lithium battery of claim 1, wherein the polymer is derived from thermal rearrangement of the polyamic acid or the polyimide, and has a ratio of thermally rearranged repeating units (thermal rearrangement rate) of about 10 mol % to about 100 mol %, based on the total amount of a repeating unit in the polyamic acid or polyimide.

4. The separator for a rechargeable lithium battery of claim 1, wherein the polymer derived from polyamic acid and polymer derived from polyimide has a fractional free volume (FFV) of about 0.18 to about 0.40.

5. The separator for a rechargeable lithium battery of claim 1, wherein the polymer derived from polyamic acid and polymer derived from polyimide has an interplanar distance of about 550 pm to about 800 pm measured by X-ray diffraction (XRD).

6. The separator for a rechargeable lithium battery of claim 1, wherein the polyamic acid is selected from polyamic acid including a repeating unit represented by the following Chemical Formulae 1 to 4, a polyamic acid copolymer including a repeating unit the following Chemical Formulae 5 to 8, a copolymer thereof, and a blend thereof, and
the polyimide is selected from the group consisting of polyimide including a repeating unit represented by the following Chemical Formulae 19 to 22, a polyimide copolymer including a repeating unit the following Chemical Formulae 23 to 26, a copolymer thereof, and a blend thereof: 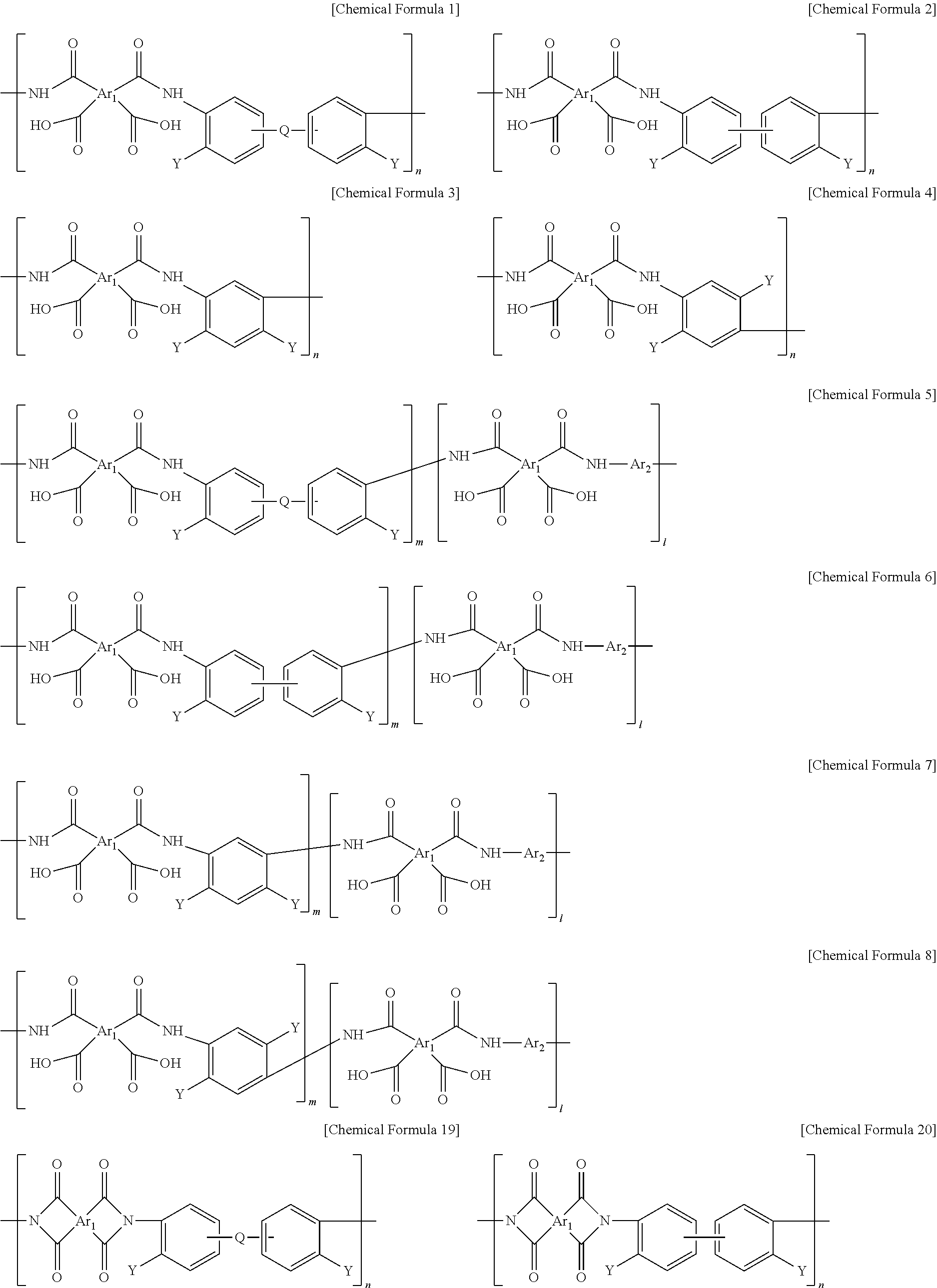 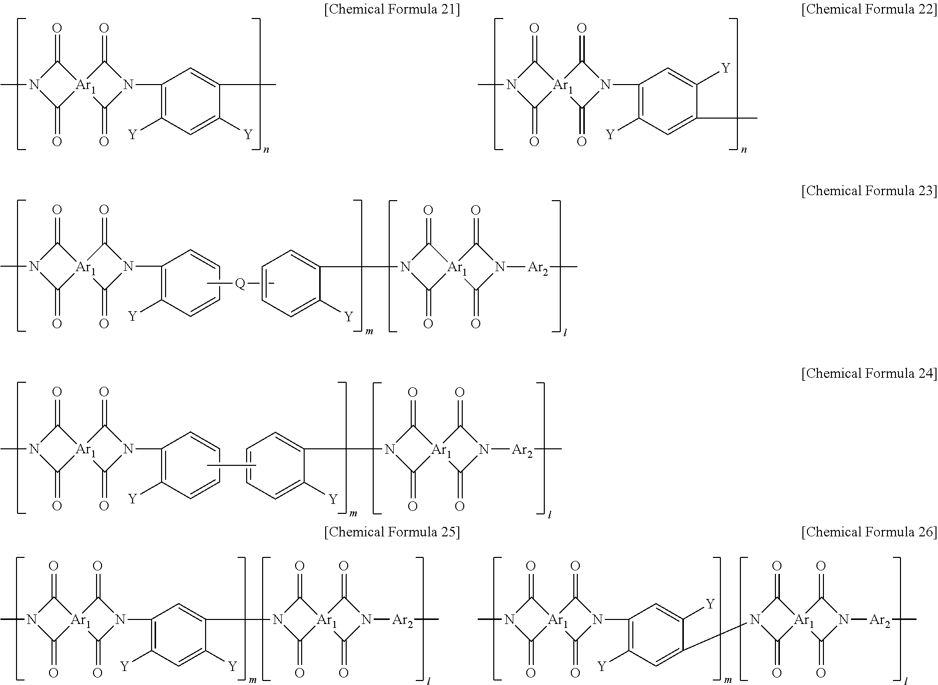
wherein in the above Chemical Formulae 1 to 8 and Chemical Formulae 19 to 26,
Ar₁ is an aromatic ring group selected from a substituted or unsubstituted tetravalent C6 to C24 arylene group and a substituted or unsubstituted tetravalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Ar₂ is an aromatic group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y is the same or different in each repeating unit and is independently OH, SH, or NH₂,
n is an integer satisfying 20≦n≦1200,
m is an integer satisfying 10≦m≦1400, and
l is an integer satisfying 10≦l≦400.

7. The separator for a rechargeable lithium battery of claim 6, wherein the Ar₁ is selected from the following chemical formulae: 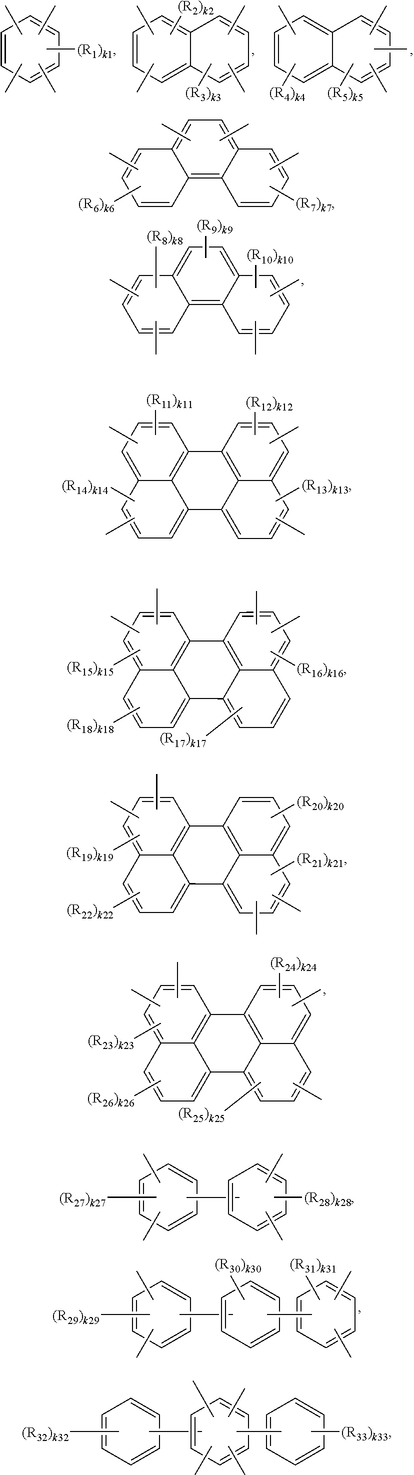 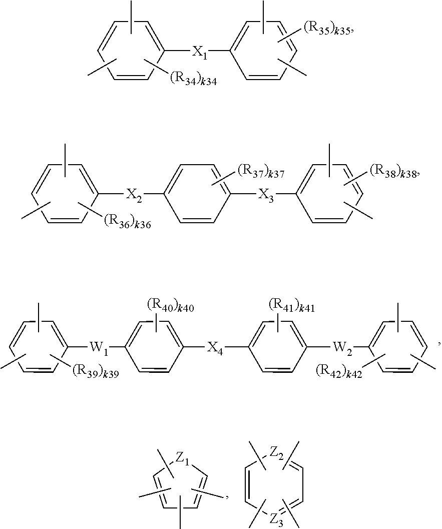
wherein, in the above chemical formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁₀₀R₁₀₁, or NR₁₀₂, where R₁₀₀, R₁₀₁, and R₁₀₂ are the same or different from each other and are independently hydrogen or a C1 to C5 alkyl group,
Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,
R₁ to R₄₂ are the same or different and are independently hydrogen, or a substituted or unsubstituted C1 to C10 aliphatic organic group,
k1 to k3, k8 to k14, k24, and k25 are integers ranging from 0 to 2,
k5, k15, k16, k19, k21, and k23 are integers of 0 or 1,
k4, k6, k7, k17, k18, k20, k22, k26 to k29, k31, k34 to k36, k38, k39, and k42 are integers ranging from 0 to 3,
k30, k37, k40, and k41 are integers ranging from 0 to 4, and
k32 and k33 are integers ranging from 0 to 5.

8. The separator for a rechargeable lithium battery of claim 7, wherein the Ar₁ is selected from the following chemical formulae:

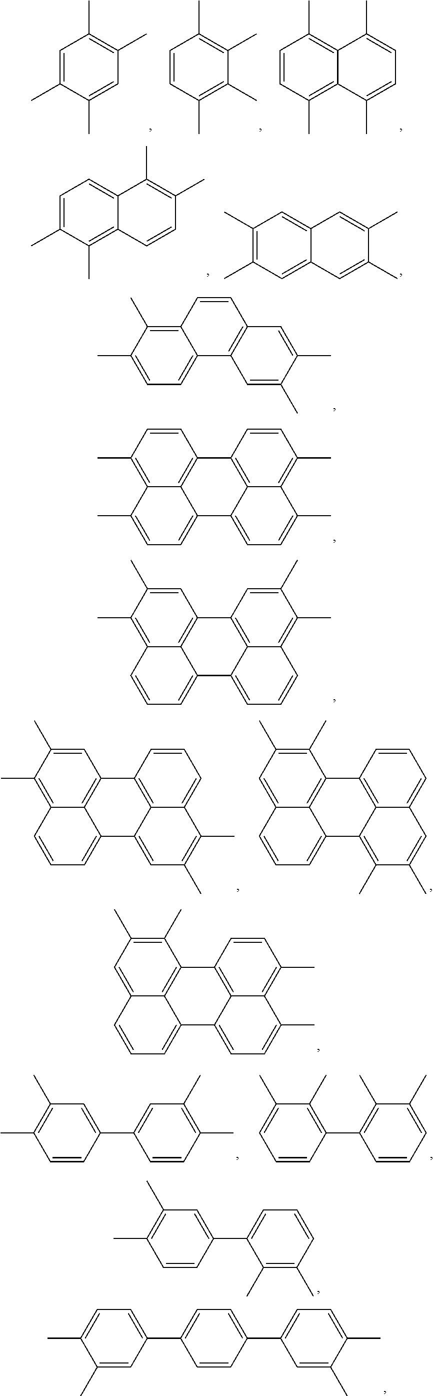

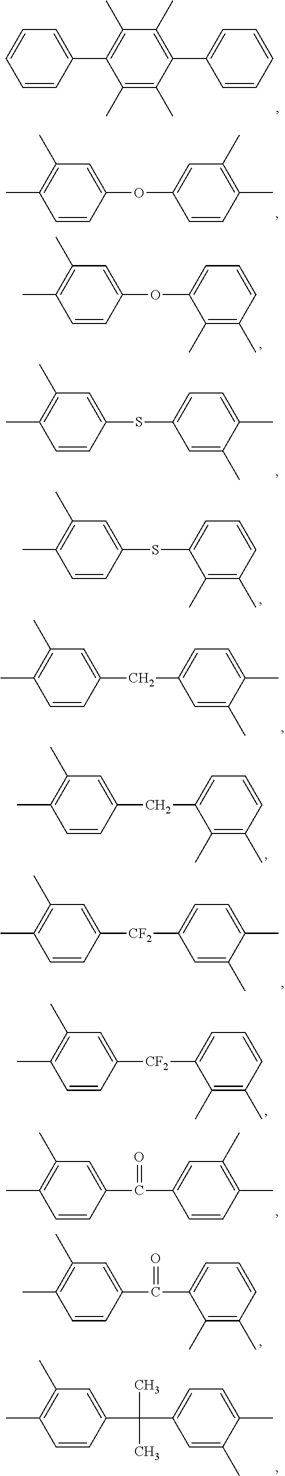

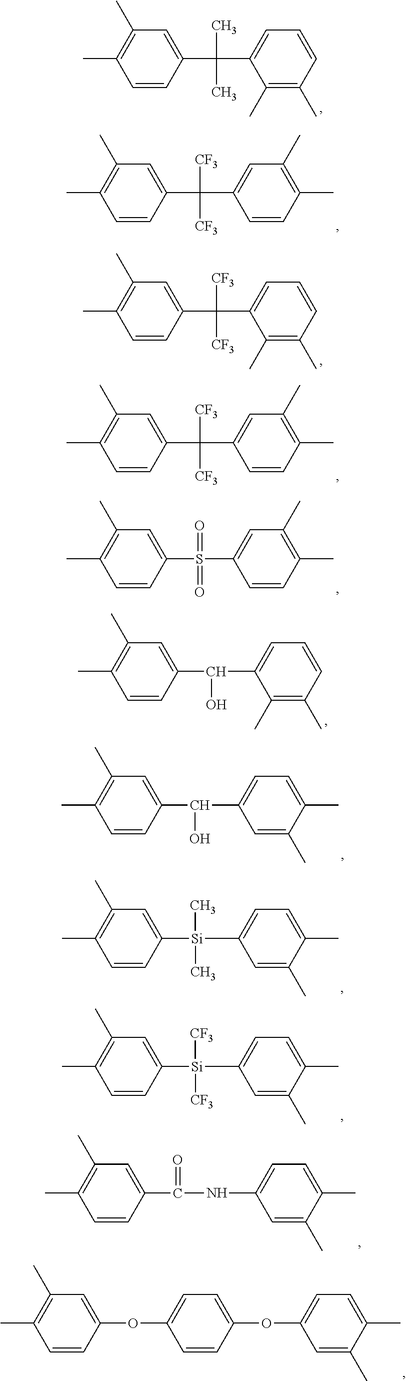

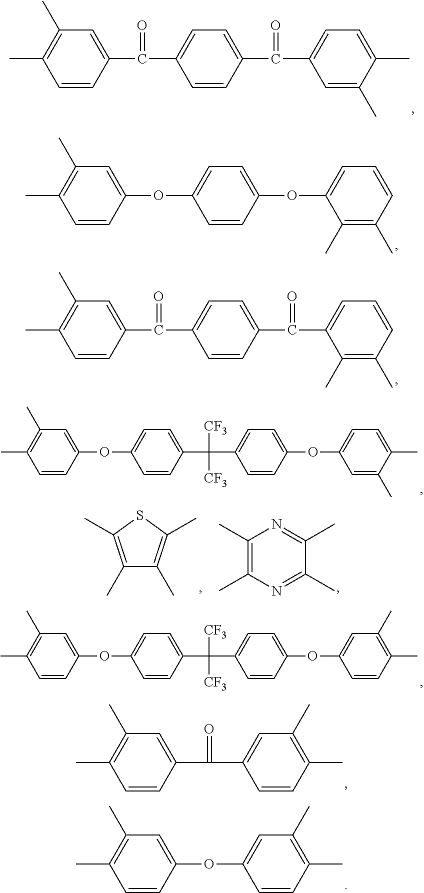

9. The separator for a rechargeable lithium battery of claim 6, wherein the Ar₂ is selected from the following chemical formulae: 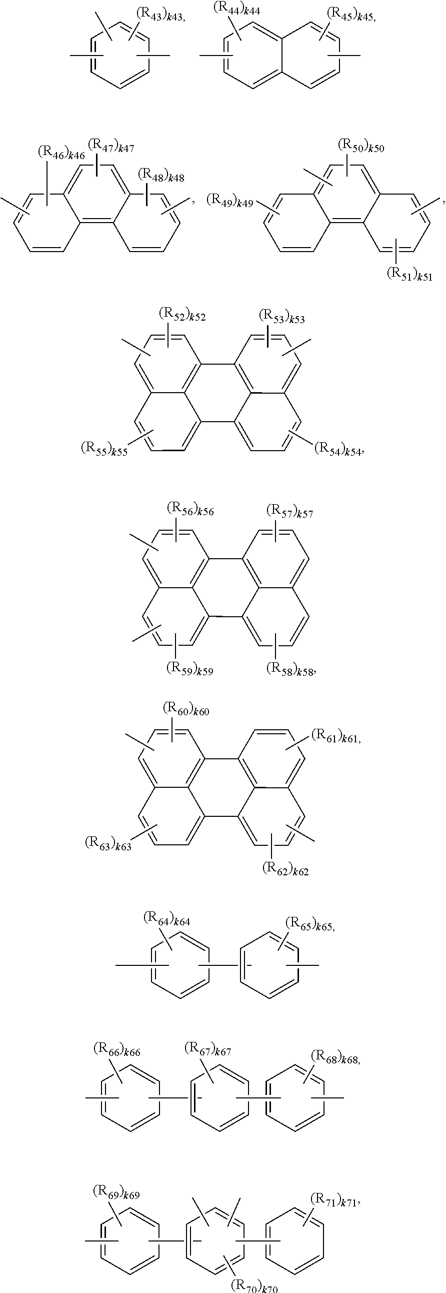 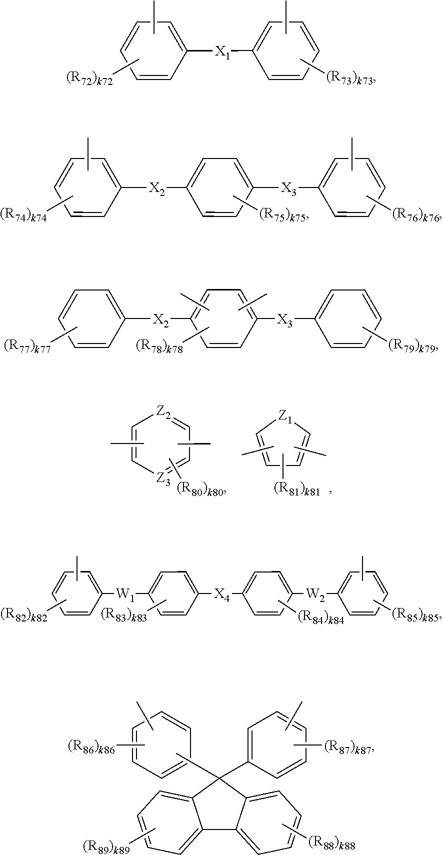
wherein, in the above chemical formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁₀₀R₁₀₁, or NR₁₀₂, where R₁₀₀, R₁₀₁, and R₁₀₂ are the same or different from each other and are independently hydrogen or a C1 to C5 alkyl group,
Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,
R₄₃ to R₈₉ are the same or different and are independently hydrogen, a substituted or unsubstituted C1 to C10 aliphatic organic group, or a metal sulfonate group,
k43, k49, k64 to k68, k72 to k76, and k82 to k89 are integers ranging from 0 to 4,
k44 to k46, k48, k51, k54, k55, k57, k58, k61, and k63 are integers ranging from 0 to 3,
k47, k52, k53, k56, k59, k60, k62, k70, k78, k80, and k81 are integers ranging from 0 to 2,
k50 is an integer of 0 or 1, and
k69, k71, k77, and k79 are integers ranging from 0 to 5.

10. The separator for a rechargeable lithium battery of claim 9, wherein the Ar₂ is selected from the following chemical formulae: 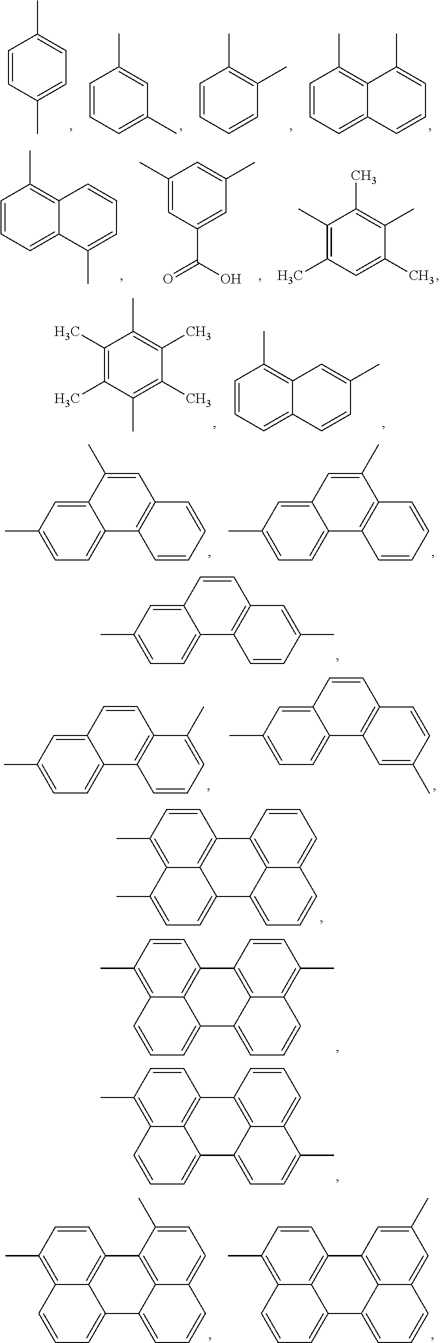 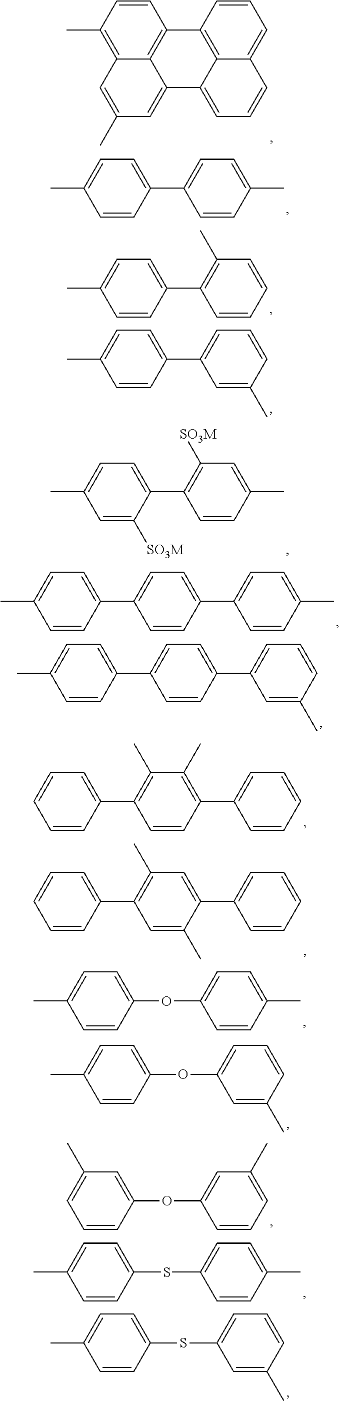 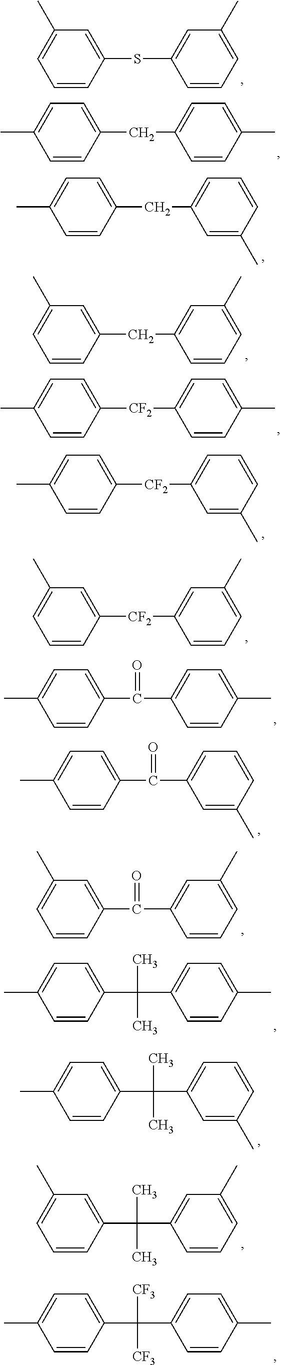 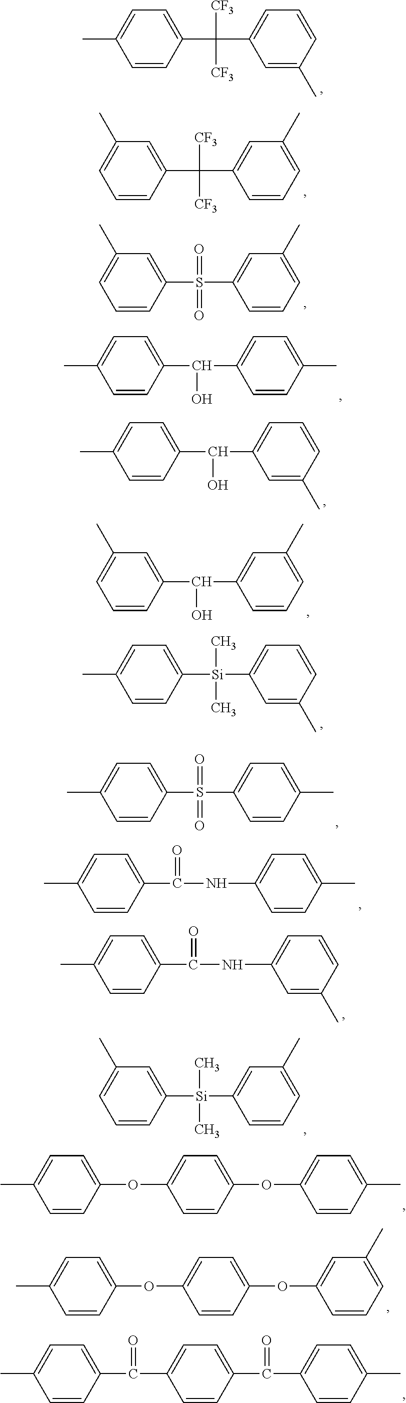 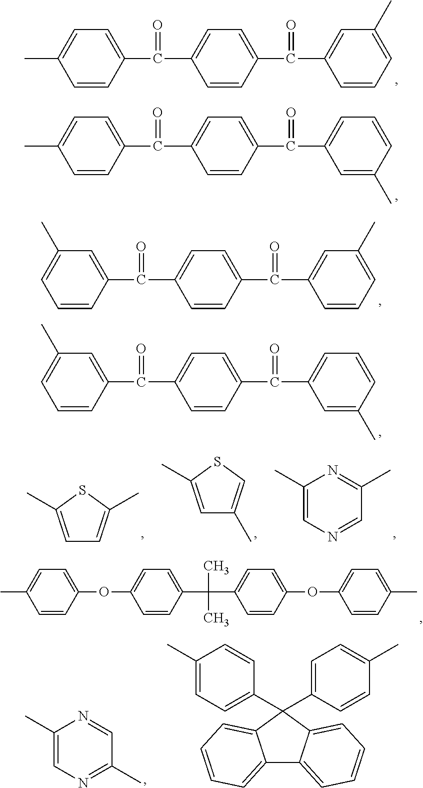
wherein, in the above chemical formulae, M is a metal, wherein the metal is sodium, potassium, lithium, an alloy thereof, or a combination thereof.

11. The separator for a rechargeable lithium battery of claim 6, wherein the Q is selected from C(CH₃)₂, C(CF₃)₂, O, S, S(═O)₂, or C(═O).

12. The separator for a rechargeable lithium battery of claim 6, wherein the Ar₁ is a functional group represented by the following Chemical Formulae A1 to A8, the Ar₂ is a functional group represented by the following Chemical Formulae B1 to B11, and the Q is C(CF₃)₂: 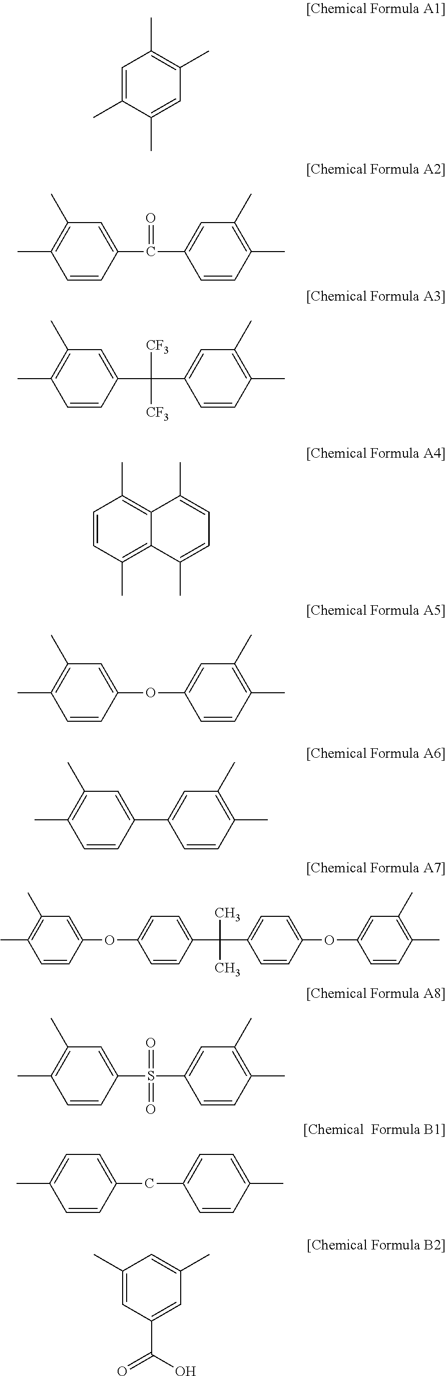 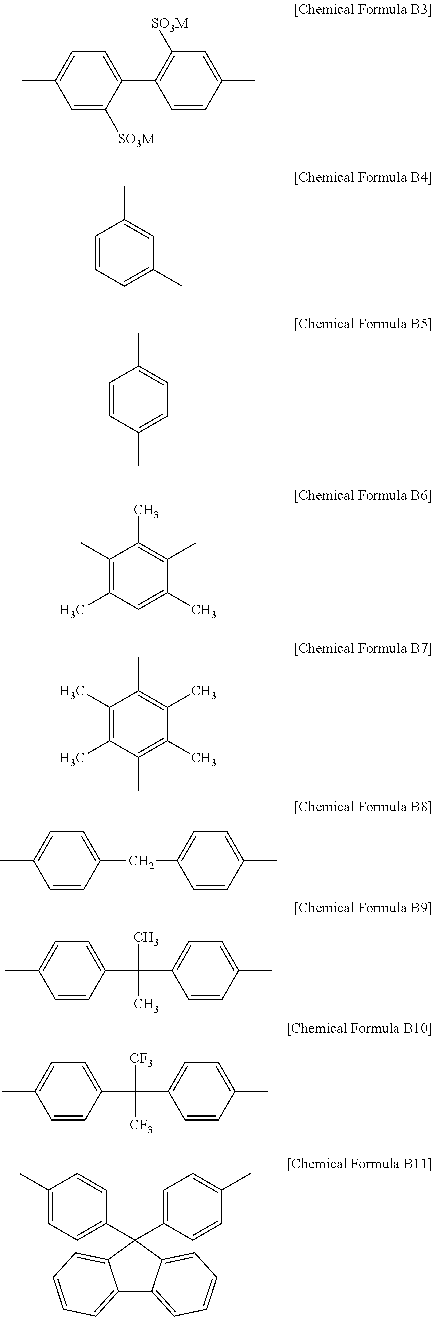
wherein, in the above chemical formulae,
M is sodium, potassium, lithium, an alloy thereof, or a combination thereof.

13. The separator for a rechargeable lithium battery of claim 6, wherein a mole ratio between each repeating unit in a copolymer of polyamic acid including the repeating unit represented by the above Chemical Formulae 1 to 4, a mole ratio m:l of in the above Chemical Formulae 5 to 8, a mole ratio between each repeating unit in a copolymer of polyimide including the repeating unit represented by the above Chemical Formulae 19 to 22, or a mole ratio m:l of in the above Chemical Formula 23 to 26 ranges from 0.1:9.9 to 9.9:0.1.

14. The separator for a rechargeable lithium battery of claim 1, wherein the polymer derived from polyamic acid and polymer derived from polyimide is a polymer including a repeating unit represented by one of the following Chemical Formulae 37 to 50, or a copolymer thereof: 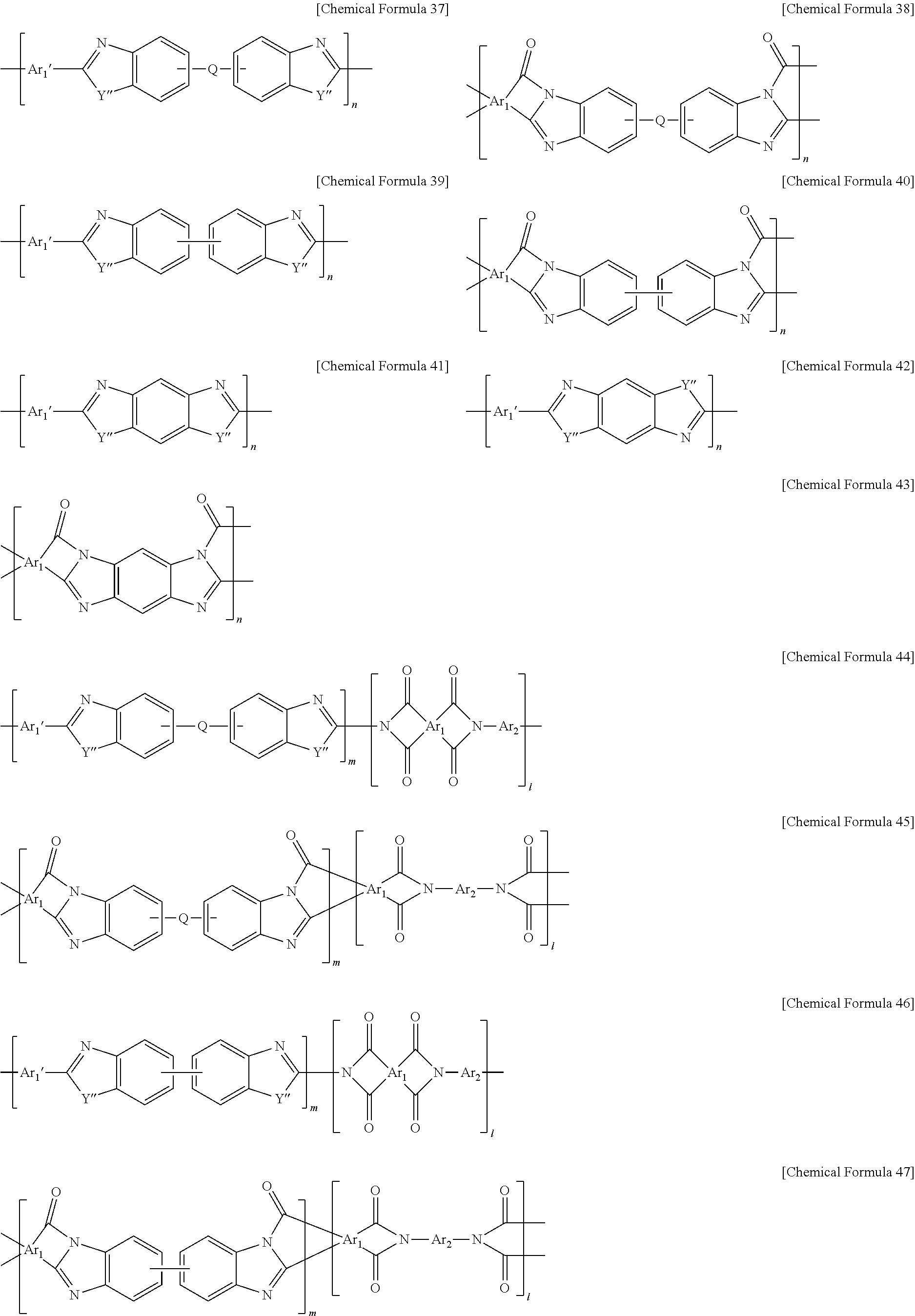 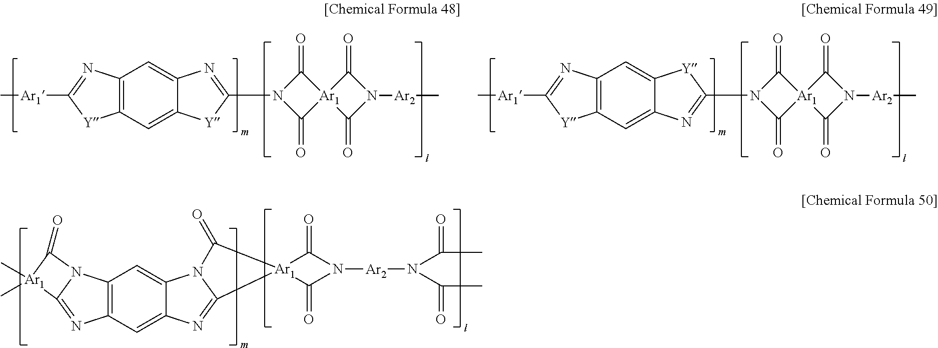
wherein, in the above Chemical Formulae 37 to 50,
Ar₁ is an aromatic ring group selected from a substituted or unsubstituted tetravalent C6 to C24 arylene group and a substituted or unsubstituted tetravalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Ar₁′ and Ar₂ are the same or different and are independently an aromatic ring group selected from a substituted or unsubstituted divalent C6 to C24 arylene group and a substituted or unsubstituted divalent C4 to C24 heterocyclic group, wherein the aromatic ring group is present singularly; two or more aromatic ring groups are fused to each other to form a condensed ring; or at least two aromatic ring groups are linked by a single bond or a functional group selected from O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
Q is O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, C(═O)NH, C(CH₃)(CF₃), or a substituted or unsubstituted phenylene group (where the substituted phenylene group is a phenylene group substituted with a C1 to C6 alkyl group or a C1 to C6 haloalkyl group), where the Q is linked with aromatic groups with m-m, m-p, p-m, or p-p positions,
Y″ is O or S,
n is an integer satisfying 20≦n≦1200,
m is an integer satisfying 10≦m≦1400, and
l is an integer satisfying 10≦l≦400.

15. The separator for a rechargeable lithium battery of claim 14, wherein the Ar₁ is selected from the following chemical formulae: 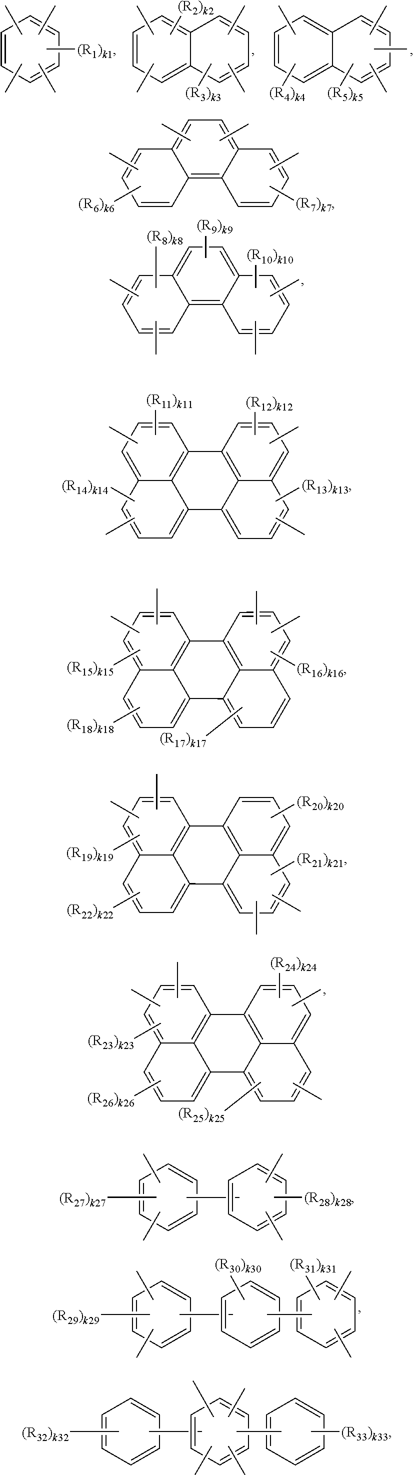 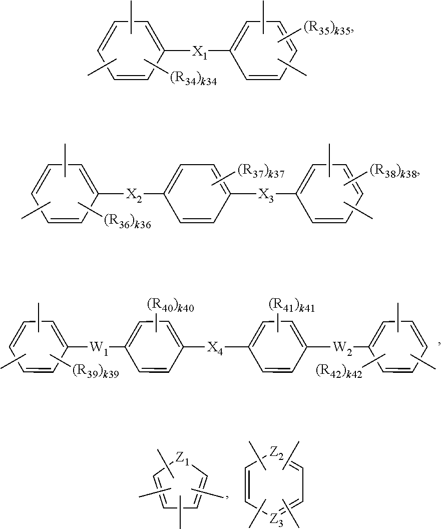
wherein, in the above chemical formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁₀₀R₁₀₁, or NR₁₀₂, wherein R₁₀₀, R₁₀₁, and R₁₀₂ are the same or different and are independently hydrogen or a C1 to C5 alkyl group,
Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,
R₁ to R₄₂ are the same or different and are independently hydrogen, or a substituted or unsubstituted C1 to C10 aliphatic organic group,
k1 to k3, k8 to k14, k24, and k25 are integers ranging from 0 to 2,
k5, k15, k16, k19, k21, and k23 are integers of 0 or 1,
k4, k6, k7, k17, k18, k20, k22, k26 to k29, k31, k34 to k36, k38, k39, and k42 are integers ranging from 0 to 3,
k30, k37, k40, and k41 are integers ranging from 0 to 4, and
k32 and k33 are integers ranging from 0 to 5.

16. The separator for a rechargeable lithium battery of claim 15, wherein the Ar₁ is selected from the following chemical formulae:

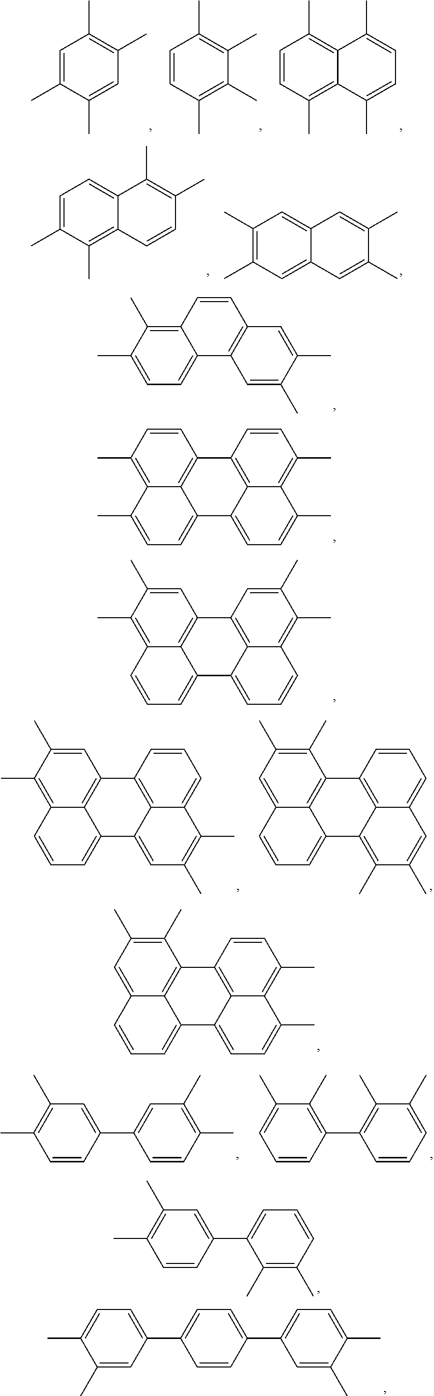

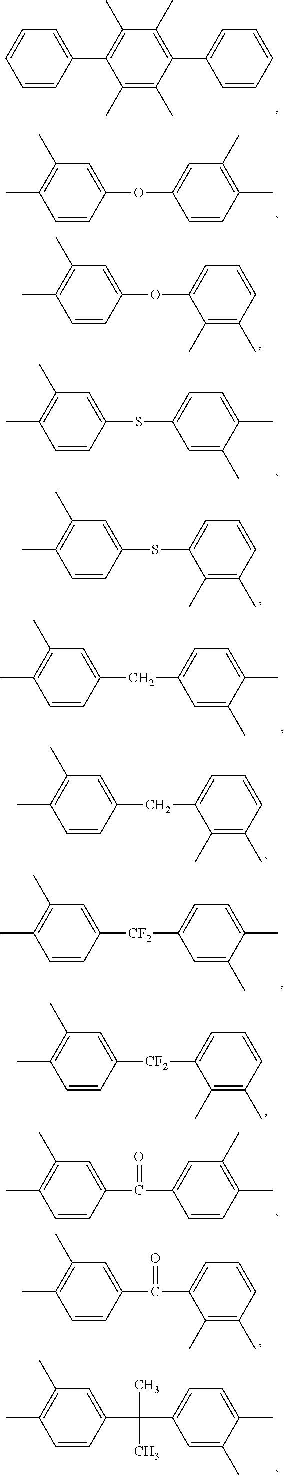

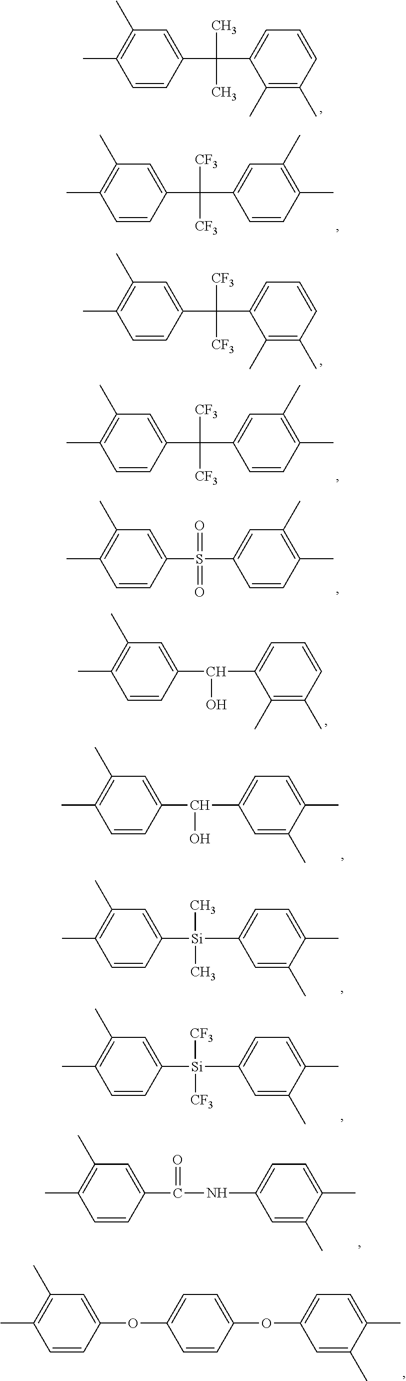

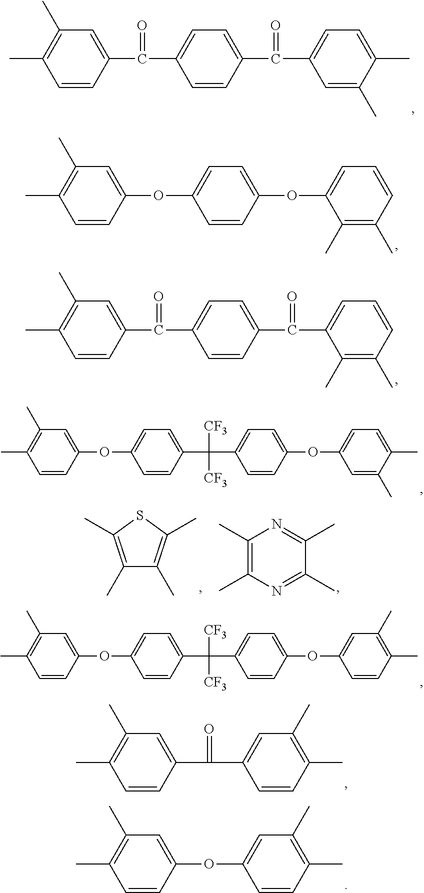

17. The separator for a rechargeable lithium battery of claim 14, wherein the Ar₁′ and Ar₂ are selected from the following chemical formulae: 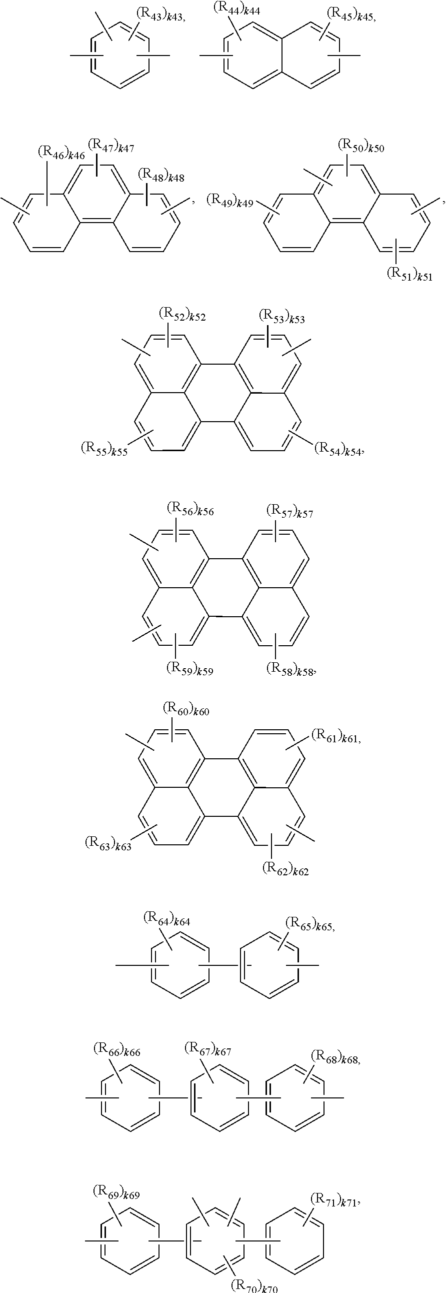 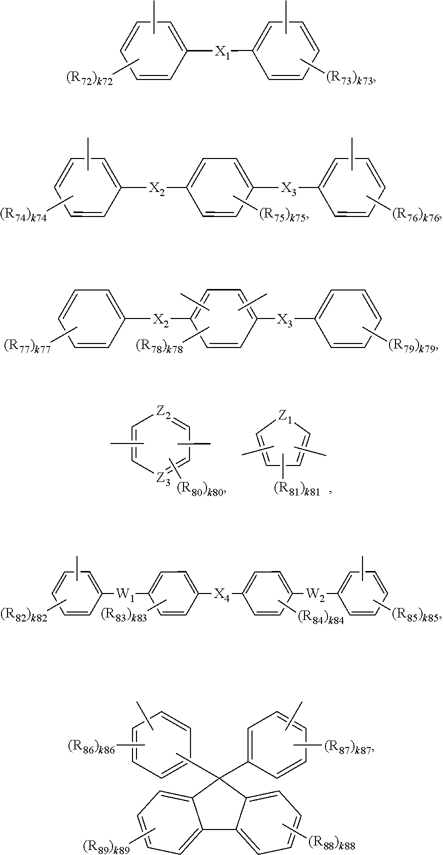
wherein, in the above chemical formulae,
X₁, X₂, X₃, and X₄ are the same or different and are independently O, S, C(═O), CH(OH), S(═O)₂, Si(CH₃)₂, (CH₂)ₚ (where 1≦p≦10), (CF₂)_{q} (where 1≦q≦10), C(CH₃)₂, C(CF₃)₂, or C(═O)NH,
W₁ and W₂ are the same or different and are independently O, S, or C(═O),
Z₁ is O, S, CR₁₀₀R₁₀₁, or NR₁₀₂, wherein R₁₀₀, R₁₀₁, and R₁₀₂ are the same or different and are independently hydrogen or C1 to C5 alkyl group,
Z₂ and Z₃ are the same or different and are independently N or CR₁₀₃ (wherein R₁₀₃ is hydrogen or a C1 to C5 alkyl group) provided that both Z₂ and Z₃ are not CR₁₀₃,
R₄₃ to R₈₉ are the same or different and are independently hydrogen, a substituted or unsubstituted C1 to C10 aliphatic organic group, or a metal sulfonate group,
k43, k49, k64 to k68, k72 to k76, and k82 to k89 are integers ranging from 0 to 4,
k44 to k46, k48, k51, k54, k55, k57, k58, k61, and k63 are integers ranging from 0 to 3,
k47, k52, k53, k56, k59, k60, k62, k70, k78, k80, and k81 are integers ranging from 0 to 2,
k50 is an integer of 0 or 1, and
k69, k71, k77, and k79 are integers ranging from 0 to 5.

18. The separator for a rechargeable lithium battery of claim 17, wherein the Ar₁′ and Ar₂ are selected from one of the following chemical formulae: 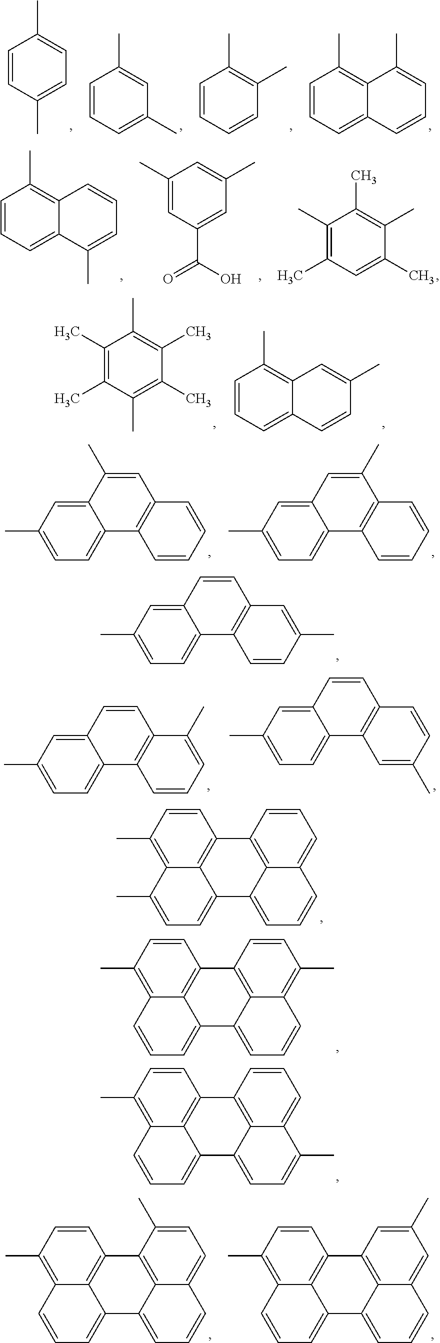 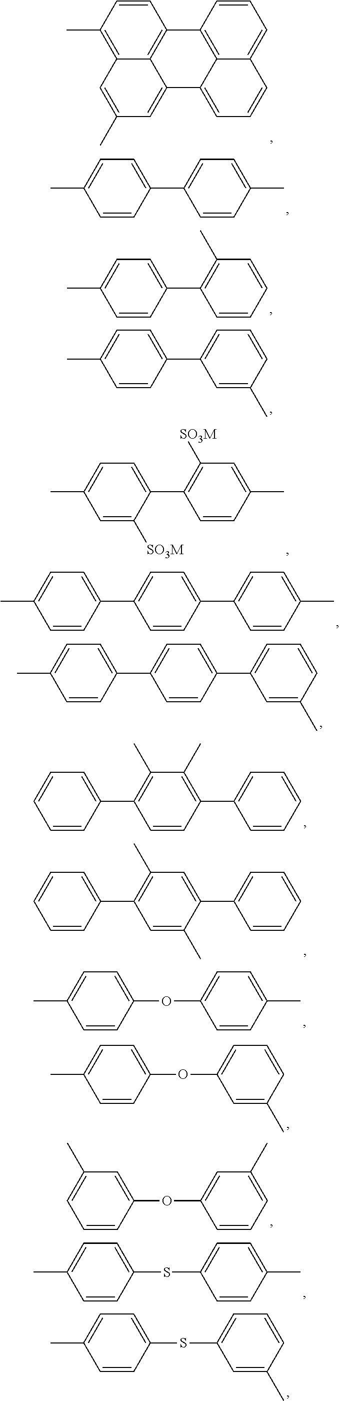 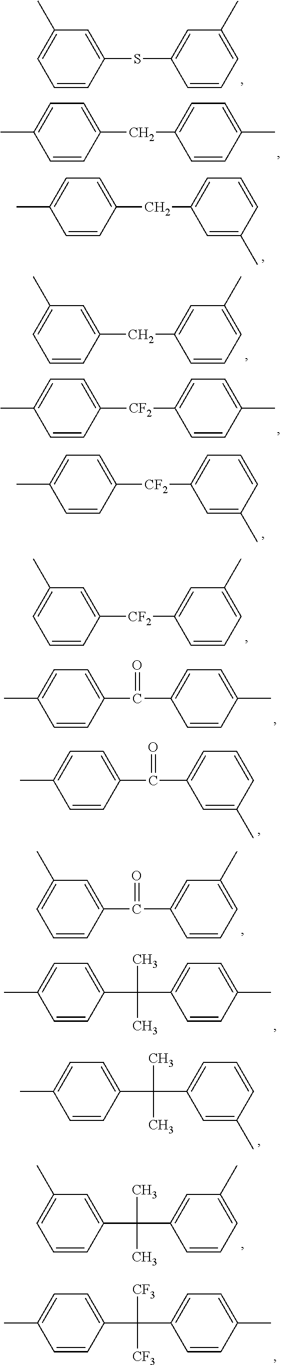 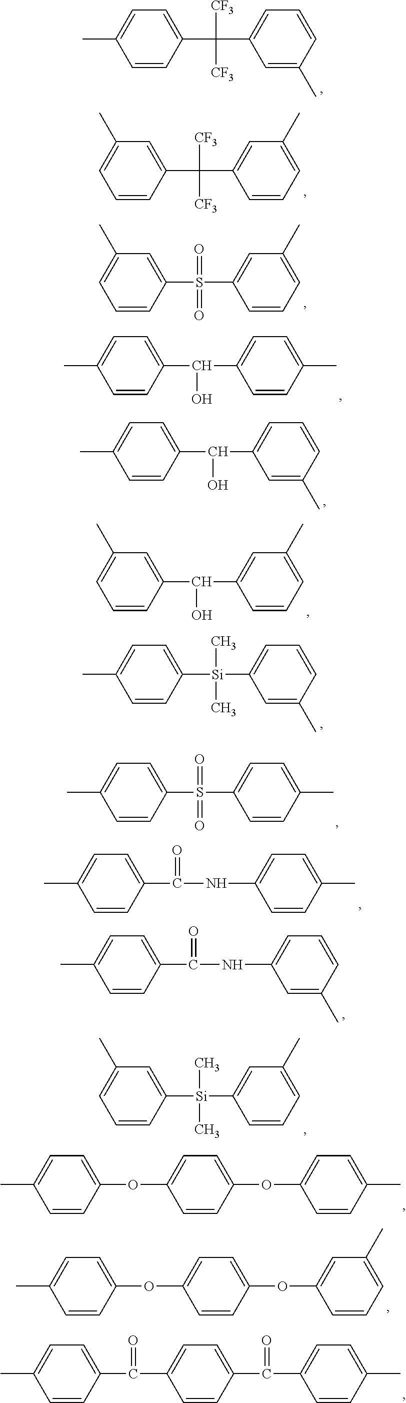 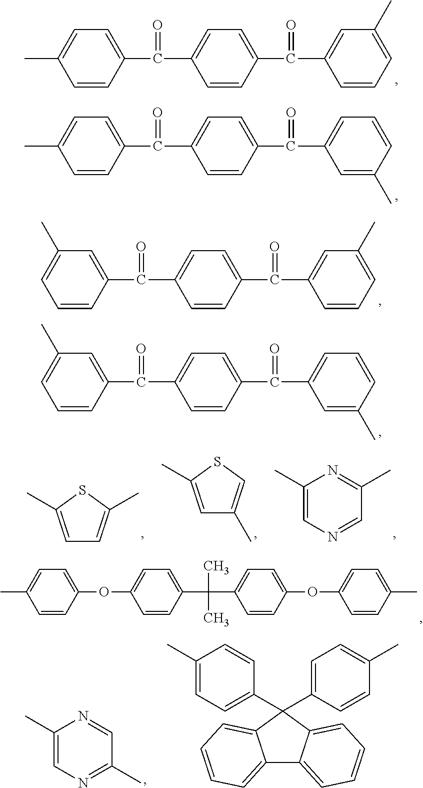
wherein, in the above chemical formulae, M is a metal, wherein the metal is sodium, potassium, lithium, an alloy thereof, or combination thereof.

19. The separator for a rechargeable lithium battery of claim 14, wherein the Q is selected from C(CH₃)₂, C(CF₃)₂, O, S, S(═O)₂, or C(═O).

20. The separator for a rechargeable lithium battery of claim 14, wherein the Ar₁ is a functional group represented by the following Chemical Formulae A1 to A8, the Ar₁′ is a functional group represented by the following Chemical Formulae C1 to C8, the Ar₂ is a functional group represented by the following Chemical Formulae B1 to B11, and the Q is C(CF₃)₂: 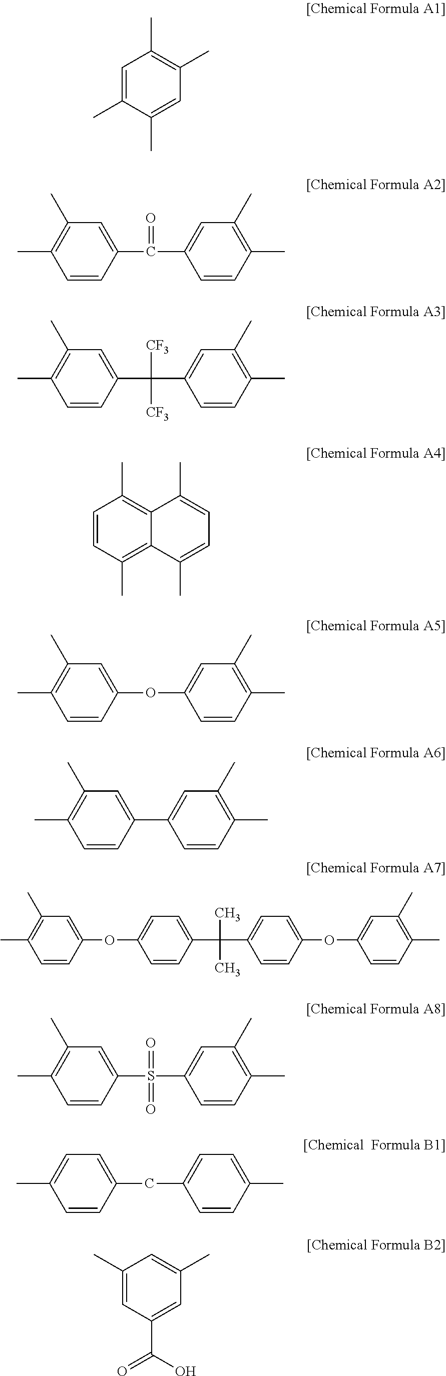 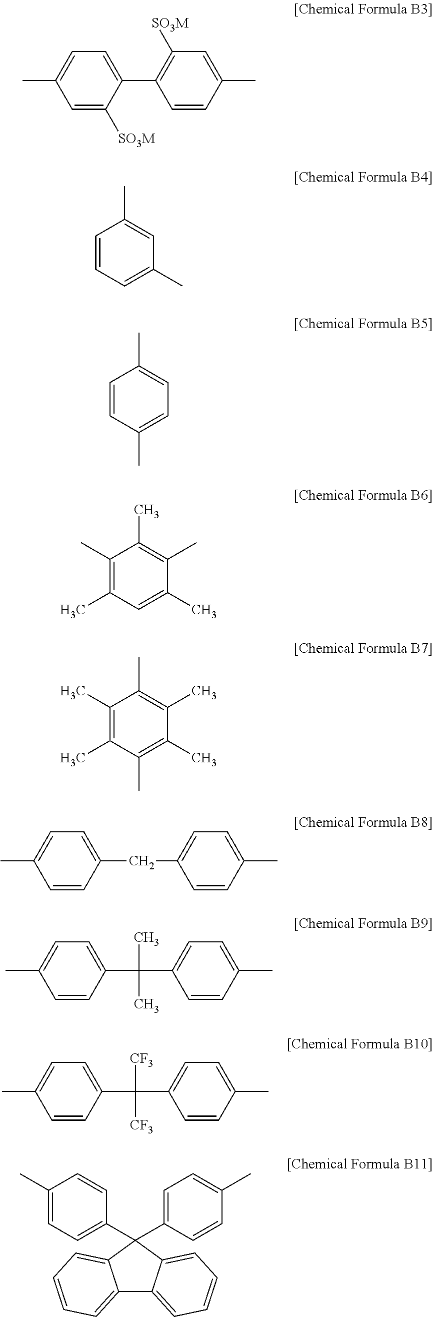 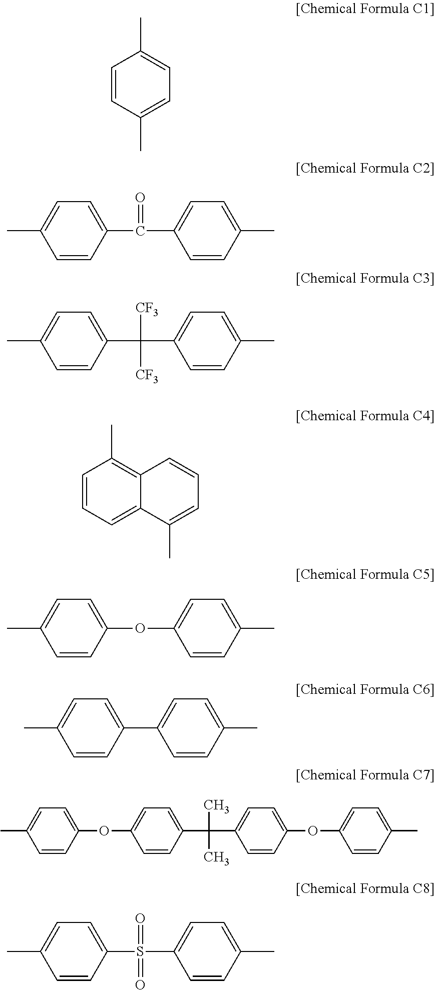
wherein, in the above chemical formulae,
M is sodium, potassium, lithium, an alloy thereof, or a combination thereof.

21. The separator for a rechargeable lithium battery of claim 1, wherein the porous support comprises a micropore, and a picopore present in a polymer derived from the polyamic acid or a picopore present in a polymer derived from the polyimide.

22. The separator for a rechargeable lithium battery of claim 21, wherein the micropore has a diameter of 0.01 μm to 50 μm, and the picopore has a diameter of 100 pm to 1000 pm.

23. The separator for a rechargeable lithium battery of claim 21, wherein at least two of the picopores are connected to each other to form an hourglass-shaped structure.

24. The separator for a rechargeable lithium battery of claim 21, wherein the picopore has a full width at half maximum (FWHM) ranging from 10 pm to 40 pm measured by positron annihilation lifetime spectroscopy (PALS).

25. The separator for a rechargeable lithium battery of claim 1, wherein the porous support comprises a fiber including the polymer, and the fiber is arranged randomly.

26. The separator for a rechargeable lithium battery of claim 1, wherein the porous support comprises a fiber including the polymer, and the fiber is arranged unidirectionally.

27. The separator for a rechargeable lithium battery of claim 1, wherein the separator for a rechargeable lithium battery has porosity of 10 volume % to 95 volume % based on the total volume of a separator for a rechargeable lithium battery.

28. The separator for a rechargeable lithium battery of claim 1, wherein the separator for a rechargeable lithium battery has a thickness of 10 μm to 200 μm.

29. The separator for a rechargeable lithium battery of claim 1, wherein the separator for a rechargeable lithium battery has a thermal decomposition temperature of 350° C. to 1000° C.

30. The separator for a rechargeable lithium battery of claim 1, wherein the separator for a rechargeable lithium battery further comprises an inorganic particle, and
the inorganic particle comprises an inorganic particle having a dielectric constant of 3 or more, an inorganic particle having a lithium ion transport capability, or a combination thereof.

31. The separator for a rechargeable lithium battery of claim 30, wherein the inorganic particle having a dielectric constant of 3 or more comprises BaTiO₃, Pb(Zr,Ti)O₃ (PZT), Pb₁₋ₓLaₓZr_{1-y}Ti_{y}O₃(PLZT), PB(Mg₃Nb₂₁₃)O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof, and
the inorganic particle having lithium ion transport capability comprises lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ based glass (LiₓSi_{y}S_{z}, 0<x<3, 0<y<2, 0<z<4), P₂S₅ based glass (LiₓP_{y}S_{z}, 0<x<3, 0<y<3, 0<z<7), Li₂O, LiF, LiOH, Li₂CO₃, LiAlO₂, or a combination thereof.

32. The separator for a rechargeable lithium battery of claim 30, wherein the inorganic particle has a diameter of 0.001 μm to 10 μm.

33. The separator for a rechargeable lithium battery of claim 30, wherein the inorganic particle is included in an amount of 0.1 parts by weight to 50 parts by weight based on 100 parts by weight of a polymer derived from the polyamic acid or a polymer derived from the polyimide.

34. A composition for forming a separator for a rechargeable lithium battery, comprising:
polyamic acid or polyimide including a repeating unit prepared from aromatic diamine including at least one ortho-positioned functional group relative to an amine group and dianhydride; and
an organic solvent,
wherein the organic solvent is selected from the group consisting of dimethylsulfoxide; N-methyl-2-pyrrolidone; N-methylpyrrolidone; N,N-dimethyl formamide; N,N-dimethyl acetamide; a ketone selected from the group consisting of γ-butyrolactone, cyclohexanone, 3-hexanone, 3-heptanone and 3-octanone; and a combination thereof.

35. The composition for forming a separator for a rechargeable lithium battery of claim 34, wherein polyamic acid and the polyimide have a weight average molecular weight (Mw) of 10,000 g/mol to 500,000 g/mol, respectively.

36. The composition for forming a separator for a rechargeable lithium battery of claim 34, which comprises 1 wt % to 40 wt % of the polyamic acid or the polyimide and 60 wt % to 99 wt % of the organic solvent based on the total amount of the composition for forming a separator for a rechargeable lithium battery.

37. The composition for forming a separator for a rechargeable lithium battery of claim 34, wherein the composition for forming a separator for a rechargeable lithium battery further comprises an auxiliary agent selected from the group consisting of water; an alcohol selected from the group consisting of methanol, ethanol, 2-methyl-1-butanol, 2-methyl-2-butanol, glycerol, ethylene glycol, diethylene glycol, and propylene glycol; a ketone selected from the group consisting of acetone and methylethyl ketone; a polymer compound selected from the group consisting of polyvinyl alcohol, polyacrylic acid, polyacrylamide, polyethylene glycol, polypropylene glycol, chitosan, chitin, dextran, and polyvinylpyrrolidone; tetrahydrofuran; trichloroethane; and a combination thereof.

38. The composition for forming a separator for a rechargeable lithium battery of claim 37, which comprises 1 wt % to 40 wt % of the polyamic acid or the polyimide, 10 wt % to 95 wt % of the organic solvent, and 4 wt % to 70 wt % of the auxiliary agent based on the total amount of the composition for forming a separator for a rechargeable lithium battery including the auxiliary agent.

39. The composition for forming a separator for a rechargeable lithium battery of claim 34, wherein the composition for forming a separator for a rechargeable lithium battery further comprises an inorganic particle, and
the inorganic particle comprise an inorganic particle having a dielectric constant of 3 or more, an inorganic particle having lithium ion transport capability, or a combination thereof.

40. The composition for forming a separator for a rechargeable lithium battery of claim 39, wherein the inorganic particle having a dielectric constant of 3 or more comprises BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof, and
the inorganic particle having lithium ion transport capability comprises lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ based glass (LiₓSi_{y}S_{z}, 0<x<3, 0<y<2, 0<z<4), P₂S₅ based glass (LiₓP_{y}S_{z}, 0<x<3, 0<y<3, 0<z<7), Li₂O, LiF, LiOH, Li₂CO₃, LiAlO₂, or a combination thereof.

41. The composition for forming a separator for a rechargeable lithium battery of claim 39, which comprises 1 wt % to 40 wt % of the polyamic acid or the polyimide and 60 wt % to 99 wt % of the organic solvent based on the total amount of the composition for forming a separator for a rechargeable lithium battery.

42. The composition for forming a separator for a rechargeable lithium battery of claim 34, wherein the composition for forming a separator for a rechargeable lithium battery has viscosity of 0.01 Pa·s to 100 Pa·s.

43. A method of manufacturing a separator for a rechargeable lithium battery, comprising:
electrospinning the composition for forming a separator for a rechargeable lithium battery of any one of claim 34 to claim 42 to form a non-woven fabric; and
heat-treating the non-woven fabric to form a porous support including a polymer derived from polyamic acid or a polymer derived from polyimide.

44. The method of manufacturing a separator for a rechargeable lithium battery of claim 43, wherein the electrospinning is performed by applying a voltage of about 1 kV to about 1000 kV.

45. The method of manufacturing a separator for a rechargeable lithium battery of claim 43, wherein the non-woven fabric comprises a randomly arranged fiber including the composition for forming a separator for a rechargeable lithium battery.

46. The method of manufacturing a separator for a rechargeable lithium battery of claim 43, wherein the non-woven fabric comprises a unidirectionally arranged fiber including the composition for forming a separator for a rechargeable lithium battery.

47. The method of manufacturing a separator for a rechargeable lithium battery of claim 43, wherein the polymer is derived from thermal rearrangement of the polyamic acid or the polyimide, and has a ratio of thermally rearranged repeating units (thermal rearrangement rate) of 10 mol % to 100 mol % based on the total amount of a repeating unit in the polyamic acid or polyimide.

48. The method of manufacturing a separator for a rechargeable lithium battery of claim 43, wherein the heat-treating is performed at a temperature of 250° C. to 550° C.

49. The method of manufacturing a separator for a rechargeable lithium battery of claim 43, wherein the heat-treating is performed for 10 minutes to 5 hours.

50. The method of manufacturing a separator for a rechargeable lithium battery of claim 43, wherein the heat-treating is performed at a temperature increase rate of 1° C./min to 20° C./min.

51. The method of manufacturing a separator for a rechargeable lithium battery of claim 43, wherein the method further comprises forming an inorganic particle coating layer inside, on a surface, or both thereof of the porous support, after forming the porous support, and
the inorganic particle comprises an inorganic particle having a dielectric constant of 3 or more, an inorganic particle having lithium ion transport capability, or a combination thereof.

52. The method of manufacturing a separator for a rechargeable lithium battery of claim 43, wherein the method further comprises a coating layer including an inorganic particle and a binder polymer inside, on a surface, or both thereof of the porous support, after forming the porous support, and
the inorganic particle comprises an inorganic particle having a dielectric constant of 3 or more, an inorganic particle having lithium ion transport capability, or a combination thereof.

53. The method of manufacturing a separator for a rechargeable lithium battery of claim 51, wherein the inorganic particle having a dielectric constant of 3 or more comprises BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof, and
the inorganic particle having lithium ion transport capability comprises lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ based glass (LiₓSi_{y}S_{z}, 0<x<3, 0<y<2, 0<z<4), P₂S₅ based glass (LiₓP_{y}S_{z}, 0<x<3, 0<y<3, 0<z<7), Li₂O, LiF, LiOH, Li₂CO₃, LiAlO₂, or a combination thereof.

54. The method of manufacturing a separator for a rechargeable lithium battery of claim 52, wherein the binder polymer comprises polyvinylidene fluoride-hexafluoropropylene, polyvinylidene fluoride-trichloroethylene, polymethylmethacrylate, polyacrylonitrile, polyvinylpyrrolidone, polyvinylacetate, polyethylene-vinyl acetate, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxylmethyl cellulose, an acrylonitrile-styrenebutadiene copolymer, polyimide, or a combination thereof.

55. A rechargeable lithium battery, comprising:
a positive electrode including a positive active material;
a negative electrode including a negative active material;
the separator for a rechargeable lithium battery of claim 1; and
a non-aqueous electrolyte.

56. The method of manufacturing a separator for a rechargeable lithium battery of claim 52, wherein the inorganic particle having a dielectric constant of 3 or more comprises BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, or a combination thereof, and
the inorganic particle having lithium ion transport capability comprises lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} based glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ based glass (LiₓSi_{y}S_{z}, 0<x<3, 0<y<2, 0<z<4), P₂S₅ based glass (LiₓP_{y}S_{z}, 0<x<3, 0<y<3, 0<z<7), Li₂O, LiF, LiOH, Li₂CO₃, LiAlO₂, or a combination thereof.
